(19) United States
(12) Patent Application Publication
(10) Pub. No.: US 2025/0200814 A1
(43) Pub. Date: Jun. 19, 2025

(54) POINT CLOUD DATA TRANSMISSION DEVICE, POINT CLOUD DATA TRANSMISSION METHOD, POINT CLOUD DATA RECEIVING DEVICE, AND POINT CLOUD DATA RECEIVING METHOD

(71) Applicant: LG Electronics Inc., Seoul (KR)

(72) Inventors: Daehyun KIM, Seoul (KR); Hansol CHOI, Seoul (KR); Donggyu SIM, Seoul (KR); Hanje PARK, Seoul (KR)

(21) Appl. No.: 18/846,072

(22) PCT Filed: Mar. 10, 2023
(86) PCT No.: PCT/KR2023/003290

§ 371 Date: Sep. 11, 2024

(30) Foreign Application Priority Data
Mar. 11, 2022 (KR) 10-2022-0030562
Sep. 14, 2022 (KR) 10-2022-0115405

(51) Int. Cl. G06T 9/00; H04N 19/70

(52) U.S. Cl. CPC G06T 9/001; H04N 19/70

(57) ABSTRACT

A point cloud data transmission method according to embodiments may comprise the steps of: encoding point cloud data; and transmitting a bitstream including the point cloud data. A point cloud data receiving method according to embodiments may comprise the steps of: receiving a bitstream including point cloud data; and decoding the point cloud data.

### TECHNICAL FIELD

Embodiments provide a method for providing point cloud content to provide a user with various services such as virtual reality (VR), augmented reality (AR), mixed reality (MR), and self-driving services.

### BACKGROUND ART

A point cloud is a set of points in a three-dimensional (3D) space. It is difficult to generate point cloud data because the number of points in the 3D space is large.

A large throughput is required to transmit and receive data of a point cloud.

### DISCLOSURE

### Technical Problem

An object of the present disclosure is to provide a point cloud data transmission device, a point cloud data transmission method, a point cloud data reception device, and a point cloud data reception method for efficiently transmitting and receiving a point cloud.

Another object of the present disclosure is to provide a point cloud data transmission device, a point cloud data transmission method, a point cloud data reception device, and a point cloud data reception method for addressing latency and encoding/decoding complexity.

Embodiments are not limited to the above-described objects, and the scope of the embodiments may be extended to other objects that can be inferred by those skilled in the art based on the entire contents of the present disclosure.

### Technical Solution

A point cloud data transmission method according to embodiments may include encoding point cloud data, and transmitting the point cloud data.

A point cloud data reception method according to embodiments may include receiving point cloud data, and decoding the point cloud data.

### Advantageous Effects

The point cloud data transmission method, the point cloud data transmission apparatus, the point cloud data reception method, and the point cloud data reception apparatus according to the embodiments may provide a good-quality point cloud service.

The point cloud data transmission method, the point cloud data transmission apparatus, the point cloud data reception method, and the point cloud data reception apparatus according to the embodiments may achieve various video codec methods.

The point cloud data transmission method, the point cloud data transmission apparatus, the point cloud data reception method, and the point cloud data reception apparatus according to the embodiments may provide universal point cloud content such as a self-driving service.

### DESCRIPTION OF DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 illustrates an exemplary structure of a transmission/reception system for providing point cloud content according to embodiments;

FIG. 2 illustrates capture of point cloud data according to embodiments;

FIG. 3 illustrates an exemplary point cloud, geometry, and texture image according to embodiments;

FIG. 4 illustrates an exemplary V-PCC encoding process according to embodiments;

FIG. 5 illustrates an example of a tangent plane and a normal vector of a surface according to embodiments;

FIG. 6 illustrates an exemplary bounding box of a point cloud according to embodiments;

FIG. 7 illustrates an example of determination of individual patch positions on an occupancy map according to embodiments;

FIG. 8 shows an exemplary relationship among normal, tangent, and bitangent axes according to embodiments;

FIG. 9 shows an exemplary configuration of the minimum mode and maximum mode of a projection mode according to embodiments;

FIG. 10 illustrates an exemplary EDD code according to embodiments;

FIG. 11 illustrates an example of recoloring based on color values of neighboring points according to embodiments;

FIG. 12 illustrates an example of push-pull background filling according to embodiments;

FIG. 13 shows an exemplary possible traversal order for a 4*4 block according to embodiments;

FIG. 14 illustrates an exemplary best traversal order according to embodiments;

FIG. 15 illustrates an exemplary 2D video/image encoder according to embodiments;

FIG. 16 illustrates an exemplary V-PCC decoding process according to embodiments;

FIG. 17 shows an exemplary 2D video/image decoder according to embodiments;

FIG. 18 is a flowchart illustrating operation of a transmission device according to embodiments of the present disclosure;

FIG. 19 is a flowchart illustrating operation of a reception device according to embodiments;

FIG. 20 illustrates an exemplary structure operable in connection with point cloud data transmission/reception methods/devices according to embodiments;

FIG. 21 illustrates a transmission device/method according to embodiments;

FIG. 22 illustrates a reception device/method according to embodiments;

FIG. 23 illustrates a transmission device (or encoder) according to embodiments;

FIG. 24 illustrates an exemplary mesh simplification process according to embodiments;

FIG. 25 illustrates initial positions and offsets of added vertices when a submesh is a triangle according to embodiments;

FIG. 26 illustrates an exemplary reception device according to embodiments;

FIG. 27 illustrates an exemplary mesh splitter according to embodiments;

FIG. 28 illustrates an example of an object and a 3D vertex patch in a mesh reconstructed in a base layer according to embodiments;

FIG. 29 illustrates a method of splitting triangle fan vertices according to embodiments;

FIG. 30 illustrates an example of a method of splitting triangle fan vertices according to embodiments;

FIG. 31 illustrates an example of a method of splitting triangle fan vertices according to embodiments;

FIG. 32 illustrates an example of axes of a vertex included in groups 1 and 2 according to embodiments;

FIG. 33 illustrates the operations of deriving initial geometry information about added vertices and deriving final geometry information about added vertices in FIG. 29;

FIG. 34 illustrates operations of the “group 2 axis initial geometry derivation module” of FIG. 33;

FIG. 35 illustrates a visualization of the operations of FIG. 34;

FIG. 36 illustrates an example of traversing multiple triangle fans in a reconstructed mesh and splitting each triangle fan with a “triangle fan vertex splitting method” according to embodiments;

FIG. 37 illustrates the operations in a triangle fan edge splitting method according to embodiments;

FIG. 38 illustrates an example of splitting using a triangle fan edge splitting method according to embodiments;

FIG. 39 illustrates an example of traversing multiple triangle fans in a reconstructed mesh and splitting each triangle fan with a triangle fan edge splitting method according to embodiments;

FIG. 40 illustrates a triangle splitting operation according to embodiments;

FIG. 41 illustrates triangle splitting method 1 according to embodiments;

FIG. 42 illustrates triangle splitting method 2 according to embodiments;

FIG. 43 illustrates triangle splitting method 3 according to embodiments;

FIG. 44 illustrates triangle splitting method 4 according to embodiments;

FIG. 45 illustrates an example of traversing multiple triangles in a reconstructed mesh and splitting each triangle with triangle splitting method 2 according to embodiments;

FIG. 46 illustrates an example of traversing multiple triangles in a reconstructed mesh and splitting each triangle with an edge splitting method according to embodiments;

FIG. 47 illustrates operations of the patch boundary splitting module of FIG. 27;

FIG. 48 illustrates an example of bounding triangle groups according to embodiments;

FIG. 49 illustrates a result of splitting bounding triangle group 2 according to embodiments;

FIG. 50 illustrates a bitstream according to embodiments;

FIG. 51 shows the syntax of v3c_parameter_set according to embodiments;

FIG. 52 shows the syntax of enhancement_layer_tile_data_unit according to embodiments;

FIG. 53 shows the syntax of enhancement_layer_patch_information_data according to embodiments;

FIG. 54 shows the syntax of submesh_split_data according to embodiments;

FIG. 55 illustrates a transmission device/method according to embodiments;

FIG. 56 illustrates a reception device/method according to embodiments;

FIG. 57 illustrates a transmission device/method according to embodiments;

FIG. 58 illustrates elements or operations of the mesh frame splitter of FIG. 57;

FIG. 59 illustrates an example of objects specified as a mesh frame group according to embodiments;

FIG. 60 illustrates elements or operations of the geometry information transformer of FIG. 57;

FIG. 61 illustrates geometry information transformation according to embodiments;

FIG. 62 illustrates elements or operations of the 3D patch generator of FIG. 57;

FIG. 63 illustrates an example of the result of generating a 3D patch of object 1 in a mesh frame according to embodiments;

FIG. 64 illustrates an example of the result of 2D frame packing of object 1 in a mesh frame according to embodiments;

FIG. 65 illustrates elements or operations of the vertex occupancy map encoder, vertex color image encoder, or vertex geometry image encoder of FIG. 57;

FIG. 66 illustrates an exemplary object according to embodiments;

FIG. 67 illustrates a reception device/method according to embodiments;

FIG. 68 illustrates elements or operations of the vertex occupancy map decoder, vertex color image decoder, or vertex geometry image decoder of FIG. 67;

FIG. 69 illustrates elements or operations of the vertex geometry information/color information reconstructor of FIG. 67;

FIG. 70 illustrates elements or operations of the object geometry information inverse transformer of FIG. 67;

FIG. 71 illustrates the result of geometry information inverse transformation according to embodiments;

FIG. 72 illustrates elements or operations of the object mesh frame constructor of FIG. 67;

FIG. 73 illustrates execution of the mesh frame constructor for a POC t mesh frame according to embodiments;

FIG. 74 shows the syntax of Frame_object( ) according to embodiments;

FIG. 75 shows the syntax of Object_header( ) according to embodiments;

FIG. 76 shows the syntax of Atlas_tile_data_unit according to embodiments;

FIG. 77 illustrates a transmission device/method according to embodiments;

FIG. 78 illustrates a reception device/method according to embodiments;

FIG. 79 illustrates a transmission device/method for point cloud data according to embodiments; and

FIG. 80 illustrates a reception device/method for point cloud data according to embodiments.

### BEST MODE

Reference will now be made in detail to the preferred embodiments of the present disclosure, examples of which are illustrated in the accompanying drawings. The detailed description, which will be given below with reference to the accompanying drawings, is intended to explain exemplary embodiments of the present disclosure, rather than to show the only embodiments that can be implemented according to the present disclosure. The following detailed description includes specific details in order to provide a thorough understanding of the present disclosure. However, it will be apparent to those skilled in the art that the present disclosure may be practiced without such specific details.

Although most terms used in the present disclosure have been selected from general ones widely used in the art, some terms have been arbitrarily selected by the applicant and their meanings are explained in detail in the following description as needed. Thus, the present disclosure should be understood based upon the intended meanings of the terms rather than their simple names or meanings.

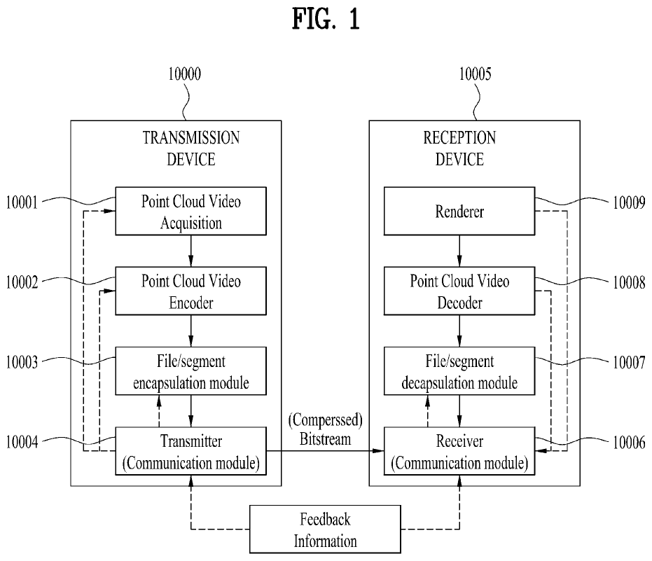

FIG. 1 illustrates an exemplary structure of a transmission/reception system for providing point cloud content according to embodiments.

The present disclosure provides a method of providing point cloud content to provide a user with various services such as virtual reality (VR), augmented reality (AR), mixed reality (MR), and self-driving. The point cloud content according to the embodiments represent data representing objects as points, and may be referred to as a point cloud, point cloud data, point cloud video data, point cloud image data, or the like.

A point cloud data transmission device 10000 according to embodiment may include a point cloud video acquirer 10001, a point cloud video encoder 10002, a file/segment encapsulation module 10003, and/or a transmitter (or communication module) 10004. The transmission device according to the embodiments may secure and process point cloud video (or point cloud content) and transmit the same. According to embodiments, the transmission device may include a fixed station, a base transceiver system (BTS), a network, an artificial intelligence (AI) device and/or system, a robot, and an AR/VR/XR device and/or a server. According to embodiments, the transmission device 10000 may include a device robot, a vehicle, AR/VR/XR devices, a portable device, a home appliance, an Internet of Thing (IoT) device, and an AI device/server which are configured to perform communication with a base station and/or other wireless devices using a radio access technology (e.g., 5G New RAT (NR), Long Term Evolution (LTE)).

The point cloud video acquirer 10001 according to the embodiments acquires a point cloud video through a process of capturing, synthesizing, or generating a point cloud video.

The point cloud video encoder 10002 according to the embodiments encodes the point cloud video data. According to embodiments, the point cloud video encoder 10002 may be referred to as a point cloud encoder, a point cloud data encoder, an encoder, or the like. The point cloud compression coding (encoding) according to the embodiments is not limited to the above-described embodiment. The point cloud video encoder may output a bitstream containing the encoded point cloud video data. The bitstream may not only include encoded point cloud video data, but also include signaling information related to encoding of the point cloud video data.

The encoder according to the embodiments may support both the geometry-based point cloud compression (G-PCC) encoding scheme and/or the video-based point cloud compression (V-PCC) encoding scheme. In addition, the encoder may encode a point cloud (referring to either point cloud data or points) and/or signaling data related to the point cloud. The specific operation of encoding according to embodiments will be described below.

As used herein, the term V-PCC may stand for Video-based Point Cloud Compression (V-PCC). The term V-PCC may be the same as Visual Volumetric Video-based Coding (V3C). These terms may be complementarily used.

The file/segment encapsulation module 10003 according to the embodiments encapsulates the point cloud data in the form of a file and/or segment form. The point cloud data transmission method/device according to the embodiments may transmit the point cloud data in a file and/or segment form.

The transmitter (or communication module) 10004 according to the embodiments transmits the encoded point cloud video data in the form of a bitstream. According to embodiments, the file or segment may be transmitted to a reception device over a network, or stored in a digital storage medium (e.g., USB, SD, CD, DVD, Blu-ray, HDD, SSD, etc.). The transmitter according to the embodiments is capable of wired/wireless communication with the reception device (or the receiver) over a network of 4G, 5G, 6G, etc. In addition, the transmitter may perform necessary data processing operation according to the network system (e.g., a 4G, 5G or 6G communication network system). The transmission device may transmit the encapsulated data in an on-demand manner.

A point cloud data reception device 10005 according to the embodiments may include a receiver 10006, a file/segment decapsulation module 10007, a point cloud video decoder 10008, and/or a renderer 10009. According to embodiments, the reception device may include a device robot, a vehicle, AR/VR/XR devices, a portable device, a home appliance, an Internet of Thing (IoT) device, and an AI device/server which are configured to perform communication with a base station and/or other wireless devices using a radio access technology (e.g., 5G New RAT (NR), Long Term Evolution (LTE)).

The receiver 10006 according to the embodiments receives a bitstream containing point cloud video data. According to embodiments, the receiver 10006 may transmit feedback information to the point cloud data transmission device 10000.

The file/segment decapsulation module 10007 decapsulates a file and/or a segment containing point cloud data. The decapsulation module according to the embodiments may perform a reverse process of the encapsulation process according to the embodiments.

The point cloud video decoder 10007 decodes the received point cloud video data. The decoder according to the embodiments may perform a reverse process of encoding according to the embodiments.

The renderer 10009 renders the decoded point cloud video data. According to embodiments, the renderer 10009 may transmit the feedback information obtained at the reception side to the point cloud video decoder 10008. The point cloud video data according to the embodiments may carry feedback information to the receiver. According to embodiments, the feedback information received by the point cloud transmission device may be provided to the point cloud video encoder.

The arrows indicated by dotted lines in the drawing represent a transmission path of feedback information acquired by the reception device 10005. The feedback information is information for reflecting interactivity with a user who consumes point cloud content, and includes user information (e.g., head orientation information), viewport information, and the like). In particular, when the point cloud content is content for a service (e.g., self-driving service, etc.) that requires interaction with a user, the feedback information may be provided to the content transmitting side (e.g., the transmission device 10000) and/or the service provider. According to embodiments, the feedback information may be used in the reception device 10005 as well as the transmission device 10000, and may not be provided.

The head orientation information according to embodiments is information about a user's head position, orientation, angle, motion, and the like. The reception device 10005 according to the embodiments may calculate viewport information based on the head orientation information. The viewport information may be information about a region of the point cloud video that the user is viewing. A viewpoint is a point where a user is viewing a point cloud video, and may refer to a center point of the viewport region. That is, the viewport is a region centered on the viewpoint, and the size and shape of the region may be determined by a field of view (FOV). Accordingly, the reception device 10005 may extract the viewport information based on a vertical or horizontal FOV supported by the device in addition to the head orientation information. In addition, the reception device 10005 performs gaze analysis to check how the user consumes a point cloud, a region that the user gazes at in the point cloud video, a gaze time, and the like. According to embodiments, the reception device 10005 may transmit feedback information including the result of the gaze analysis to the transmission device 10000. The feedback information according to the embodiments may be acquired in the rendering and/or display process. The feedback information according to the embodiments may be secured by one or more sensors included in the reception device 10005. In addition according to embodiments, the feedback information may be secured by the renderer 10009 or a separate external element (or device, component, etc.). The dotted lines in FIG. 1 represent a process of transmitting the feedback information secured by the renderer 10009. The point cloud content providing system may process (encode/decode) point cloud data based on the feedback information. Accordingly, the point cloud video data decoder 10008 may perform a decoding operation based on the feedback information. The reception device 10005 may transmit the feedback information to the transmission device. The transmission device (or the point cloud video data encoder 10002) may perform an encoding operation based on the feedback information. Accordingly, the point cloud content providing system may efficiently process necessary data (e.g., point cloud data corresponding to the user's head position) based on the feedback information rather than processing (encoding/decoding) all point cloud data, and provide point cloud content to the user.

According to embodiments, the transmission device 10000 may be called an encoder, a transmission device, a transmitter, or the like, and the reception device 10004 may be called a decoder, a reception device, a receiver, or the like.

The point cloud data processed in the point cloud content providing system of FIG. 1 according to embodiments (through a series of processes of acquisition/encoding/transmission/decoding/rendering) may be referred to as point cloud content data or point cloud video data. According to embodiments, the point cloud content data may be used as a concept covering metadata or signaling information related to point cloud data.

The elements of the point cloud content providing system illustrated in FIG. 1 may be implemented by hardware, software, a processor, and/or combinations thereof.

Embodiments may provide a method of providing point cloud content to provide a user with various services such as virtual reality (VR), augmented reality (AR), mixed reality (MR), and self-driving.

In order to provide a point cloud content service, a point cloud video may be acquired first. The acquired point cloud video may be transmitted through a series of processes, and the reception side may process the received data back into the original point cloud video and render the processed point cloud video. Thereby, the point cloud video may be provided to the user. Embodiments provide a method of effectively performing this series of processes.

The entire processes for providing a point cloud content service (the point cloud data transmission method and/or point cloud data reception method) may include an acquisition process, an encoding process, a transmission process, a decoding process, a rendering process, and/or a feedback process.

According to embodiments, the process of providing point cloud content (or point cloud data) may be referred to as a point cloud compression process. According to embodiments, the point cloud compression process may represent a geometry-based point cloud compression process.

Each element of the point cloud data transmission device and the point cloud data reception device according to the embodiments may be hardware, software, a processor, and/or a combination thereof.

In order to provide a point cloud content service, a point cloud video may be acquired. The acquired point cloud video is transmitted through a series of processes, and the reception side may process the received data back into the original point cloud video and render the processed point cloud video. Thereby, the point cloud video may be provided to the user. Embodiments provide a method of effectively performing this series of processes.

The entire processes for providing a point cloud content service may include an acquisition process, an encoding process, a transmission process, a decoding process, a rendering process, and/or a feedback process.

The point cloud compression system may include a transmission device and a reception device. The transmission device may output a bitstream by encoding a point cloud video, and deliver the same to the reception device through a digital storage medium or a network in the form of a file or a stream (streaming segment). The digital storage medium may include various storage media such as a USB, SD, CD, DVD, Blu-ray, HDD, and SSD.

The transmission device may include a point cloud video acquirer, a point cloud video encoder, a file/segment encapsulator, and a transmitter. The reception device may include a receiver, a file/segment decapsulator, a point cloud video decoder, and a renderer. The encoder may be referred to as a point cloud video/picture/picture/frame encoder, and the decoder may be referred to as a point cloud video/picture/picture/frame decoding device. The transmitter may be included in the point cloud video encoder. The receiver may be included in the point cloud video decoder. The renderer may include a display. The renderer and/or the display may be configured as separate devices or external components. The transmission device and the reception device may further include a separate internal or external module/unit/component for the feedback process.

According to embodiments, the operation of the reception device may be the reverse process of the operation of the transmission device.

The point cloud video acquirer may perform the process of acquiring point cloud video through a process of capturing, composing, or generating point cloud video. In the acquisition process, data of 3D positions (x, y, z)/attributes (color, reflectance, transparency, etc.) of multiple points, for example, a polygon file format (PLY) (or the Stanford Triangle format) file may be generated. For a video having multiple frames, one or more files may be acquired. During the capture process, point cloud related metadata (e.g., capture related metadata) may be generated.

A point cloud data transmission device according to embodiments may include an encoder configured to encode point cloud data, and a transmitter configured to transmit the point cloud data. The data may be transmitted in the form of a bitstream containing a point cloud.

A point cloud data reception device according to embodiments may include a receiver configured to receive point cloud data, a decoder configured to decode the point cloud data, and a renderer configured to render the point cloud data.

The method/device according to the embodiments represents the point cloud data transmission device and/or the point cloud data reception device.

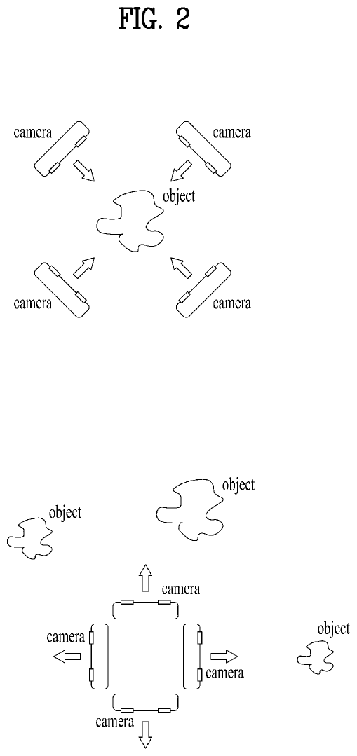

FIG. 2 illustrates capture of point cloud data according to embodiments.

Point cloud data according to embodiments may be acquired by a camera or the like. A capturing technique according to embodiments may include, for example, inward-facing and/or outward-facing.

In the inward-facing according to the embodiments, one or more cameras inwardly facing an object of point cloud data may photograph the object from the outside of the object.

In the outward-facing according to the embodiments, one or more cameras outwardly facing an object of point cloud data may photograph the object. For example according to embodiments, there may be four cameras.

The point cloud data or the point cloud content according to the embodiments may be a video or a still image of an object/environment represented in various types of 3D spaces. According to embodiments, the point cloud content may include video/audio/an image of an object.

For capture of point cloud content, a combination of camera equipment (a combination of an infrared pattern projector and an infrared camera) capable of acquiring depth and RGB cameras capable of extracting color information corresponding to the depth information may be configured. Alternatively, the depth information may be extracted through LiDAR, which uses a radar system that measures the location coordinates of a reflector by emitting a laser pulse and measuring the return time. A shape of the geometry consisting of points in a 3D space may be extracted from the depth information, and an attribute representing the color/reflectance of each point may be extracted from the RGB information. The point cloud content may include information about the positions (x, y, z) and color (YCbCr or RGB) or reflectance (r) of the points. For the point cloud content, the outward-facing technique of capturing an external environment and the inward-facing technique of capturing a central object may be used. In the VR/AR environment, when an object (e.g., a core object such as a character, a player, a thing, or an actor) is configured into point cloud content that may be viewed by the user in any direction (360 degrees), the configuration of the capture camera may be based on the inward-facing technique. When the current surrounding environment is configured into point cloud content in a mode of a vehicle, such as self-driving, the configuration of the capture camera may be based on the outward-facing technique. Because the point cloud content may be captured by multiple cameras, a camera calibration process may need to be performed before the content is captured to configure a global coordinate system for the cameras.

The point cloud content may be a video or still image of an object/environment presented in various types of 3D spaces.

Additionally, in the point cloud content acquisition method, any point cloud video may be composed based on the captured point cloud video. Alternatively, when a point cloud video for a computer-generated virtual space is to be provided, capturing with an actual camera may not be performed. In this case, the capture process may be replaced simply by a process of generating related data.

Post-processing may be needed for the captured point cloud video to improve the quality of the content. In the video capture process, the maximum/minimum depth may be adjusted within a range provided by the camera equipment. Even after the adjustment, point data of an unwanted area may still be present. Accordingly, post-processing of removing the unwanted area (e.g., the background) or recognizing a connected space and filling the spatial holes may be performed. In addition, point clouds extracted from the cameras sharing a spatial coordinate system may be integrated into one piece of content through the process of transforming each point into a global coordinate system based on the coordinates of the location of each camera acquired through a calibration process. Thereby, one piece of point cloud content having a wide range may be generated, or point cloud content with a high density of points may be acquired.

The point cloud video encoder may encode the input point cloud video into one or more video streams. One video may include a plurality of frames, each of which may correspond to a still image/picture. In this specification, a point cloud video may include a point cloud image/frame/picture/video/audio. In addition, the term “point cloud video” may be used interchangeably with a point cloud image/frame/picture. The point cloud video encoder may perform a video-based point cloud compression (V-PCC) procedure. The point cloud video encoder may perform a series of procedures such as prediction, transformation, quantization, and entropy coding for compression and encoding efficiency. The encoded data (encoded video/image information) may be output in the form of a bitstream. Based on the V-PCC procedure, the point cloud video encoder may encode point cloud video by dividing the same into a geometry video, an attribute video, an occupancy map video, and auxiliary information, which will be described later. The geometry video may include a geometry image, the attribute video may include an attribute image, and the occupancy map video may include an occupancy map image. The auxiliary information may include auxiliary patch information. The attribute video/image may include a texture video/image.

The encapsulation processor (file/segment encapsulation module) 1003 may encapsulate the encoded point cloud video data and/or metadata related to the point cloud video in the form of, for example, a file. Here, the metadata related to the point cloud video may be received from the metadata processor. The metadata processor may be included in the point cloud video encoder or may be configured as a separate component/module. The encapsulation processor may encapsulate the data in a file format such as ISOBMFF or process the same in the form of a DASH segment or the like. According to an embodiment, the encapsulation processor may include the point cloud video-related metadata in the file format. The point cloud video metadata may be included, for example, in boxes at various levels on the ISOBMFF file format or as data in a separate track within the file. According to an embodiment, the encapsulation processor may encapsulate the point cloud video-related metadata into a file. The transmission processor may perform processing for transmission on the point cloud video data encapsulated according to the file format. The transmission processor may be included in the transmitter or may be configured as a separate component/module. The transmission processor may process the point cloud video data according to a transmission protocol. The processing for transmission may include processing for delivery over a broadcast network and processing for delivery through a broadband. According to an embodiment, the transmission processor may receive point cloud video-related metadata from the metadata processor along with the point cloud video data, and perform processing of the point cloud video data for transmission.

The transmitter 1004 may transmit the encoded video/image information or data that is output in the form of a bitstream to the receiver of the reception device through a digital storage medium or a network in the form of a file or streaming. The digital storage medium may include various storage media such as USB, SD, CD, DVD, Blu-ray, HDD, and SSD. The transmitter may include an element for generating a media file in a predetermined file format, and may include an element for transmission over a broadcast/communication network. The receiver may extract the bitstream and transmit the extracted bitstream to the decoding device.

The receiver 1003 may receive point cloud video data transmitted by the point cloud video transmission device according to the present disclosure. Depending on the transmission channel, the receiver may receive the point cloud video data over a broadcast network or through a broadband. Alternatively, the point cloud video data may be received through a digital storage medium.

The reception processor may process the received point cloud video data according to the transmission protocol. The reception processor may be included in the receiver or may be configured as a separate component/module. The reception processor may reversely perform the above-described process of the transmission processor such that the processing corresponds to the processing for transmission performed at the transmission side. The reception processor may deliver the acquired point cloud video data to the decapsulation processor, and the acquired point cloud video-related metadata to the metadata parser. The point cloud video-related metadata acquired by the reception processor may take the form of a signaling table.

The decapsulation processor (file/segment decapsulation module) 10007 may decapsulate the point cloud video data received in the form of a file from the reception processor. The decapsulation processor may decapsulate the files according to ISOBMFF or the like, and may acquire a point cloud video bitstream or point cloud video-related metadata (a metadata bitstream). The acquired point cloud video bitstream may be delivered to the point cloud video decoder, and the acquired point cloud video-related metadata (metadata bitstream) may be delivered to the metadata processor. The point cloud video bitstream may include the metadata (metadata bitstream). The metadata processor may be included in the point cloud video decoder or may be configured as a separate component/module. The point cloud video-related metadata acquired by the decapsulation processor may take the form of a box or a track in the file format. The decapsulation processor may receive metadata necessary for decapsulation from the metadata processor, when necessary. The point cloud video-related metadata may be delivered to the point cloud video decoder and used in a point cloud video decoding procedure, or may be transferred to the renderer and used in a point cloud video rendering procedure.

The point cloud video decoder may receive the bitstream and decode the video/image by performing an operation corresponding to the operation of the point cloud video encoder. In this case, the point cloud video decoder may decode the point cloud video by dividing the same into a geometry video, an attribute video, an occupancy map video, and auxiliary information as described below. The geometry video may include a geometry image, and the attribute video may include an attribute image. The occupancy map video may include an occupancy map image. The auxiliary information may include auxiliary patch information. The attribute video/image may include a texture video/image.

The 3D geometry may be reconstructed based on the decoded geometry image, the occupancy map, and auxiliary patch information, and then may be subjected to a smoothing process. A color point cloud image/picture may be reconstructed by assigning color values to the smoothed 3D geometry based on the texture image. The renderer may render the reconstructed geometry and the color point cloud image/picture. The rendered video/image may be displayed through the display. The user may view all or part of the rendered result through a VR/AR display or a typical display.

The feedback process may include transferring various kinds of feedback information that may be acquired in the rendering/displaying process to the transmission side or to the decoder of the reception side. Interactivity may be provided through the feedback process in consuming point cloud video. According to an embodiment, head orientation information, viewport information indicating a region currently viewed by a user, and the like may be delivered to the transmission side in the feedback process. According to an embodiment, the user may interact with things implemented in the VR/AR/MR/self-driving environment. In this case, information related to the interaction may be delivered to the transmission side or a service provider during the feedback process. According to an embodiment, the feedback process may be skipped.

The head orientation information may represent information about the location, angle and motion of a user's head. On the basis of this information, information about a region of the point cloud video currently viewed by the user, that is, viewport information may be calculated.

The viewport information may be information about a region of the point cloud video currently viewed by the user. Gaze analysis may be performed using the viewport information to check the way the user consumes the point cloud video, a region of the point cloud video at which the user gazes, and how long the user gazes at the region. The gaze analysis may be performed at the reception side and the result of the analysis may be delivered to the transmission side on a feedback channel. A device such as a VR/AR/MR display may extract a viewport region based on the location/direction of the user's head, vertical or horizontal FOV supported by the device, and the like.

According to an embodiment, the aforementioned feedback information may not only be delivered to the transmission side, but also be consumed at the reception side. That is, decoding and rendering processes at the reception side may be performed based on the aforementioned feedback information. For example, only the point cloud video for the region currently viewed by the user may be preferentially decoded and rendered based on the head orientation information and/or the viewport information.

Here, the viewport or viewport region may represent a region of the point cloud video currently viewed by the user. A viewpoint is a point which is viewed by the user in the point cloud video and may represent a center point of the viewport region. That is, a viewport is a region around a viewpoint, and the size and form of the region may be determined by the field of view (FOV).

The present disclosure relates to point cloud video compression as described above. For example, the methods/embodiments disclosed in the present disclosure may be applied to the point cloud compression or point cloud coding (PCC) standard of the moving picture experts group (MPEG) or the next generation video/image coding standard.

As used herein, a picture/frame may generally represent a unit representing one image in a specific time interval.

A pixel or a pel may be the smallest unit constituting one picture (or image). Also, “sample” may be used as a term corresponding to a pixel. A sample may generally represent a pixel or a pixel value. It may represent only a pixel/pixel value of a luma component, only a pixel/pixel value of a chroma component, or only a pixel/pixel value of a depth component.

A unit may represent a basic unit of image processing. The unit may include at least one of a specific region of the picture and information related to the region. The unit may be used interchangeably with term such as block or area in some cases. In a general case, an M×N block may include samples (or a sample array) or a set (or array) of transform coefficients configured in M columns and N rows.

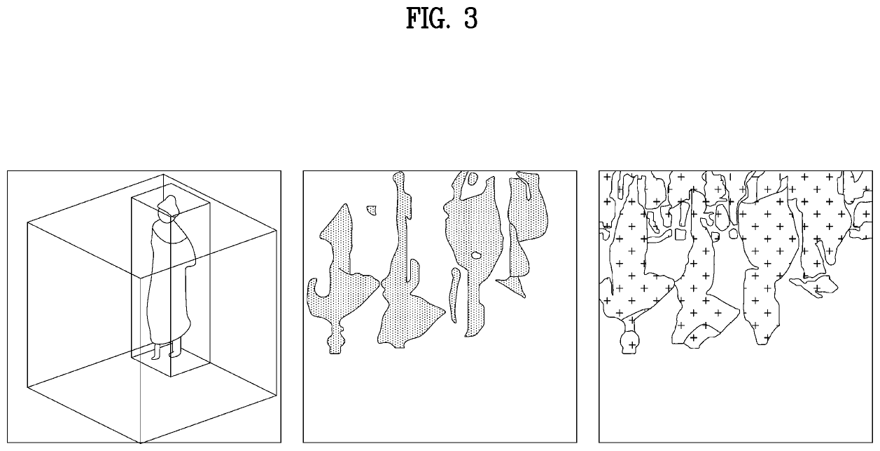

FIG. 3 illustrates an example of a point cloud, a geometry image, and a texture image according to embodiments.

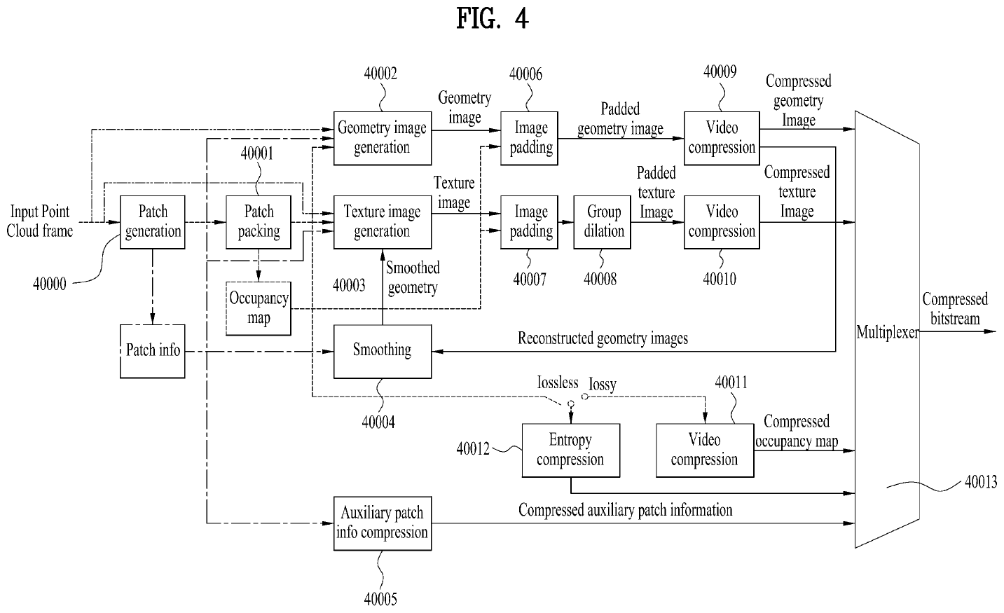

A point cloud according to the embodiments may be input to the V-PCC encoding process of FIG. 4, which will be described later, to generate a geometry image and a texture image. According to embodiments, a point cloud may have the same meaning as point cloud data.

As shown in the figure, the left part shows a point cloud, in which an object is positioned in a 3D space and may be represented by a bounding box or the like. The middle part shows the geometry, and the right part shows a texture image (non-padded image).

Video-based point cloud compression (V-PCC) according to embodiments may provide a method of compressing 3D point cloud data based on a 2D video codec such as HEVC or VVC. Data and information that may be generated in the V-PCC compression process are as follows:

Occupancy map: this is a binary map indicating whether there is data at a corresponding position in a 2D plane, using a value of 0 or 1 in dividing the points constituting a point cloud into patches and mapping the same to the 2D plane. The occupancy map may represent a 2D array corresponding to ATLAS, and the values of the occupancy map may indicate whether each sample position in the atlas corresponds to a 3D point.

An atlas is a collection of 2D bounding boxes positioned in a rectangular frame that correspond to a 3D bounding box in a 3D space in which volumetric data is rendered and information related thereto.

The atlas bitstream is a bitstream for one or more atlas frames constituting an atlas and related data.

The atlas frame is a 2D rectangular array of atlas samples onto which patches are projected.

An atlas sample is a position of a rectangular frame onto which patches associated with the atlas are projected.

An atlas frame may be partitioned into tiles. A tile is a unit in which a 2D frame is partitioned. That is, a tile is a unit for partitioning signaling information of point cloud data called an atlas.

Patch: A set of points constituting a point cloud, which indicates that points belonging to the same patch are adjacent to each other in 3D space and are mapped in the same direction among 6-face bounding box planes in the process of mapping to a 2D image.

Geometry image: this is an image in the form of a depth map that presents position information (geometry) about each point constituting a point cloud on a patch-by-patch basis. The geometry image may be composed of pixel values of one channel. Geometry represents a set of coordinates associated with a point cloud frame.

Texture image: this is an image representing the color information about each point constituting a point cloud on a patch-by-patch basis. A texture image may be composed of pixel values of a plurality of channels (e.g., three channels of R, G, and B). The texture is included in an attribute. According to embodiments, a texture and/or attribute may be interpreted as the same object and/or having an inclusive relationship.

Auxiliary patch info: this indicates metadata needed to reconstruct a point cloud with individual patches. Auxiliary patch info may include information about the position, size, and the like of a patch in a 2D/3D space.

Point cloud data according to the embodiments, for example, V-PCC components may include an atlas, an occupancy map, geometry, and attributes.

Atlas represents a set of 2D bounding boxes. It may be patches, for example, patches projected onto a rectangular frame. Atlas may correspond to a 3D bounding box in a 3D space, and may represent a subset of a point cloud.

An attribute may represent a scalar or vector associated with each point in the point cloud. For example, the attributes may include color, reflectance, surface normal, time stamps, material ID.

The point cloud data according to the embodiments represents PCC data according to video-based point cloud compression (V-PCC) scheme. The point cloud data may include a plurality of components. For example, it may include an occupancy map, a patch, geometry and/or texture.

FIG. 4 illustrates a V-PCC encoding process according to embodiments.

The figure illustrates a V-PCC encoding process for generating and compressing an occupancy map, a geometry image, a texture image, and auxiliary patch information. The V-PCC encoding process of FIG. 4 may be processed by the point cloud video encoder 10002 of FIG. 1. Each element of FIG. 4 may be performed by software, hardware, processor and/or a combination thereof.

The patch generation or patch generator 40000 receives a point cloud frame (which may be in the form of a bitstream containing point cloud data). The patch generator 40000 generates a patch from the point cloud data. In addition, patch information including information about patch generation is generated.

The patch packing or patch packer 40001 packs patches for point cloud data. For example, one or more patches may be packed. In addition, the patch packer generates an occupancy map containing information about patch packing.

The geometry image generation or geometry image generator 40002 generates a geometry image based on the point cloud data, patches, and/or packed patches. The geometry image refers to data containing geometry related to the point cloud data.

The texture image generation or texture image generator 40003 generates a texture image based on the point cloud data, patches, and/or packed patches. In addition, the texture image may be generated further based on smoothed geometry generated by smoothing processing of smoothing based on the patch information.

The smoothing or smoother 40004 may mitigate or eliminate errors contained in the image data. For example, based on the patched reconstructed geometry image, portions that may cause errors between data may be smoothly filtered out to generate smoothed geometry.

The auxiliary patch info compression or auxiliary patch info compressor 40005, auxiliary patch information related to the patch information generated in the patch generation is compressed. In addition, the compressed auxiliary patch information may be transmitted to the multiplexer. The auxiliary patch information may be used in the geometry image generation 40002.

The image padding or image padder 40006, 40007 may pad the geometry image and the texture image, respectively. The padding data may be padded to the geometry image and the texture image.

The group dilation or group dilator 40008 may add data to the texture image in a similar manner to image padding. The added data may be inserted into the texture image.

The video compression or video compressor 40009, 40010, 40011 may compress the padded geometry image, the padded texture image, and/or the occupancy map, respectively. The compression may encode geometry information, texture information, occupancy information, and the like.

The entropy compression or entropy compressor 40012 may compress (e.g., encode) the occupancy map based on an entropy scheme.

According to embodiments, the entropy compression and/or video compression may be performed, respectively depending on whether the point cloud data is lossless and/or lossy.

The multiplexer 40013 multiplexes the compressed geometry image, the compressed texture image, and the compressed occupancy map into a bitstream.

The specific operations in the respective processes of FIG. 4 are described below.

Patch generation 40000

The patch generation process refers to a process of dividing a point cloud into patches, which are mapping units, in order to map the point cloud to the 2D image. The patch generation process may be divided into three steps: normal value calculation, segmentation, and patch segmentation.

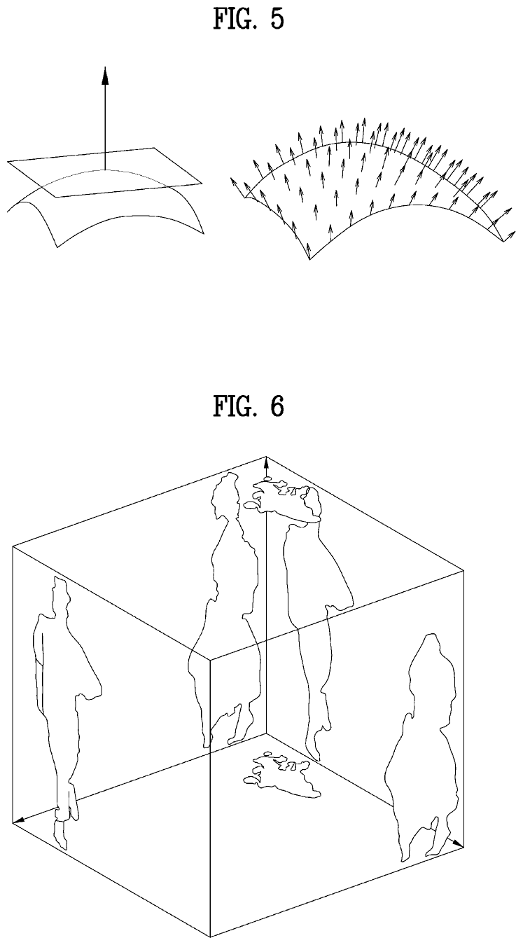

The normal value calculation process will be described in detail with reference to FIG. 5.

FIG. 5 illustrates an example of a tangent plane and a normal vector of a surface according to embodiments.

The surface of FIG. 5 is used in the patch generation process 40000 of the V-PCC encoding process of FIG. 4 as follows.

### Normal Calculation Related to Patch Generation:

Each point of a point cloud has its own direction, which is represented by a 3D vector called a normal vector. Using the neighbors of each point obtained using a K-D tree or the like, a tangent plane and a normal vector of each point constituting the surface of the point cloud as shown in the figure may be obtained. The search range applied to the process of searching for neighbors may be defined by the user.

The tangent plane refers to a plane that passes through a point on the surface and completely includes a tangent line to the curve on the surface.

FIG. 6 illustrates an exemplary bounding box of a point cloud according to embodiments.

A method/device according to embodiments, for example, patch generation, may employ a bounding box in generating a patch from point cloud data.

The bounding box according to the embodiments refers to a box of a unit for dividing point cloud data based on a hexahedron in a 3D space.

The bounding box may be used in the process of projecting a target object of the point cloud data onto a plane of each planar face of a hexahedron in a 3D space. The bounding box may be generated and processed by the point cloud video acquirer 10000 and the point cloud video encoder 10002 of FIG. 1. Further, based on the bounding box, the patch generation 40000, patch packing 40001, geometry image generation 40002, and texture image generation 40003 of the V-PCC encoding process of FIG. 2 may be performed.

### Segmentation Related to Patch Generation

Segmentation is divided into two processes: initial segmentation and refine segmentation.

The point cloud encoder 10002 according to the embodiments projects a point onto one face of a bounding box. Specifically, each point constituting a point cloud is projected onto one of the six faces of a bounding box surrounding the point cloud as shown in the figure. Initial segmentation is a process of determining one of the planar faces of the bounding box onto which each point is to be projected.
\vec{n}ₚ_{ᵢ}, which is a normal value corresponding to each of the six planar faces, is defined as follows:
(1.0, 0.0, 0.0), (0.0, 1.0, 0.0), (0.0, 0.0, 1.0), (−1.0, 0.0, 0.0), (0.0, −1.0, 0.0), (0.0, 0.0, −1.0).

As shown in the equation below, a face that yields the maximum value of dot product of the normal vector \vec{n}ₚ_{ᵢ} of each point, which is obtained in the normal value calculation process, and \vec{n}ₚ_{_{idx}} is determined as a projection plane of the corresponding point. That is, a plane whose normal vector is most similar to the direction of the normal vector of a point is determined as the projection plane of the point.

$${max}_{{p}_{idx}} \{ {\vec{n}}_{{p}_{i}} \cdot {\vec{n}}_{{p}_{idx}} \}$$

The determined plane may be identified by one cluster index, which is one of 0 to 5.

Refine segmentation is a process of enhancing the projection plane of each point constituting the point cloud determined in the initial segmentation process in consideration of the projection planes of neighboring points. In this process, a score normal, which represents the degree of similarity between the normal vector of each point and the normal of each planar face of the bounding box which are considered in determining the projection plane in the initial segmentation process, and score smooth, which indicates the degree of similarity between the projection plane of the current point and the projection planes of neighboring points, may be considered together.

Score smooth may be considered by assigning a weight to the score normal. In this case, the weight value may be defined by the user. The refine segmentation may be performed repeatedly, and the number of repetitions may also be defined by the user.

### Patch Segmentation Related to Patch Generation

Patch segmentation is a process of dividing the entire point cloud into patches, which are sets of neighboring points, based on the projection plane information about each point constituting the point cloud obtained in the initial/refine segmentation process. The patch segmentation may include the following steps:
1) Calculate neighboring points of each point constituting the point cloud, using the K-D tree or the like. The maximum number of neighbors may be defined by the user;
2) When the neighboring points are projected onto the same plane as the current point (when they have the same cluster index), extract the current point and the neighboring points as one patch;
3) Calculate geometry values of the extracted patch. The details are described below; and
4) Repeat operations 2) to 4) until there is no unextracted point.

The occupancy map, geometry image and texture image for each patch as well as the size of each patch are determined through the patch segmentation process.

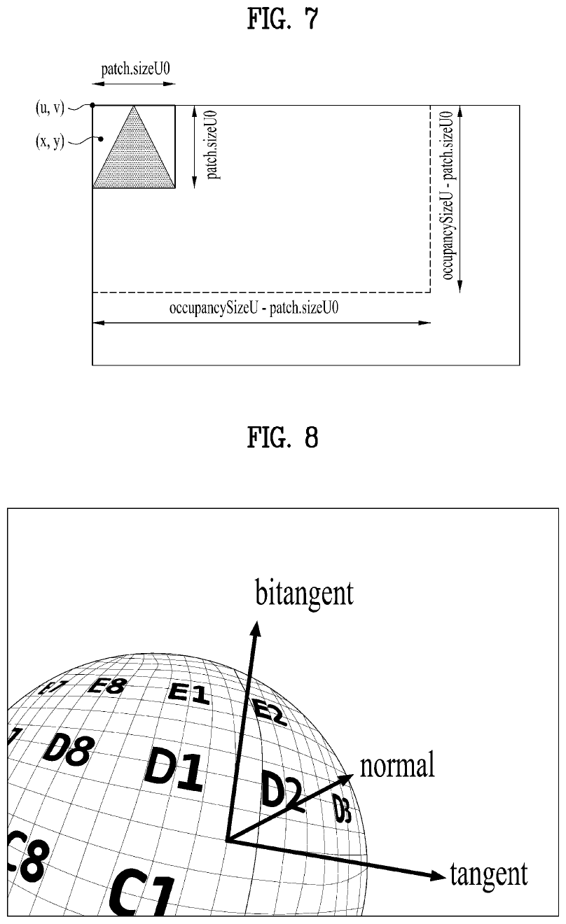

FIG. 7 illustrates an example of determination of individual patch positions on an occupancy map according to embodiments.

The point cloud encoder 10002 according to the embodiments may perform patch packing and generate an occupancy map.

### Patch Packing & Occupancy Map Generation (40001)

This is a process of determining the positions of individual patches in a 2D image to map the segmented patches to the 2D image. The occupancy map, which is a kind of 2D image, is a binary map that indicates whether there is data at a corresponding position, using a value of 0 or 1. The occupancy map is composed of blocks and the resolution thereof may be determined by the size of the block. For example, when the block is 1*1 block, a pixel-level resolution is obtained. The occupancy packing block size may be determined by the user.

The process of determining the positions of individual patches on the occupancy map may be configured as follows:
1) Set all positions on the occupancy map to 0;
2) Place a patch at a point (u, v) having a horizontal coordinate within the range of (0, occupancySizeU—patch.sizeU0) and a vertical coordinate within the range of (0, occupancy SizeV—patch.sizeV0) in the occupancy map plane;
3) Set a point (x, y) having a horizontal coordinate within the range of (0, patch.sizeU0) and a vertical coordinate within the range of (0, patch.sizeV0) in the patch plane as a current point;
4) Change the position of point (x, y) in raster order and repeat operations 3) and 4) if the value of coordinate (x, y) on the patch occupancy map is 1 (there is data at the point in the patch) and the value of coordinate (u+x, v+y) on the global occupancy map is 1 (the occupancy map is filled with the previous patch). Otherwise, proceed to operation 6);
5) Change the position of (u, v) in raster order and repeat operations 3) to 5);
6) Determine (u, v) as the position of the patch and copy the occupancy map data about the patch onto the corresponding portion on the global occupancy map; and
7) Repeat operations 2) to 7) for the next patch.
occupancySizeU: indicates the width of the occupancy map. The unit thereof is occupancy packing block size.
occupancySizeV: indicates the height of the occupancy map. The unit thereof is occupancy packing block size.
patch.sizeU0: indicates the width of the occupancy map. The unit thereof is occupancy packing block size.
patch.sizeV0: indicates the height of the occupancy map. The unit thereof is occupancy packing block size.

For example, as shown in FIG. 7, there is a box corresponding to a patch having a patch size in a box corresponding to an occupancy packing size block, and a point (x, y) may be located in the box.

FIG. 8 shows an exemplary relationship among normal, tangent, and bitangent axes according to embodiments.

The point cloud encoder 10002 according to embodiments may generate a geometry image. The geometry image refers to image data including geometry information about a point cloud. The geometry image generation process may employ three axes (normal, tangent, and bitangent) of a patch in FIG. 8.

### Geometry Image Generation (40002)

In this process, the depth values constituting the geometry images of individual patches are determined, and the entire geometry image is generated based on the positions of the patches determined in the patch packing process described above. The process of determining the depth values constituting the geometry images of individual patches may be configured as follows.

1) Calculate parameters related to the position and size of an individual patch. The parameters may include the following information.

A normal index indicating the normal axis is obtained in the previous patch generation process. The tangent axis is an axis coincident with the horizontal axis u of the patch image among the axes perpendicular to the normal axis, and the bitangent axis is an axis coincident with the vertical axis v of the patch image among the axes perpendicular to the normal axis. The three axes may be expressed as shown in the figure.

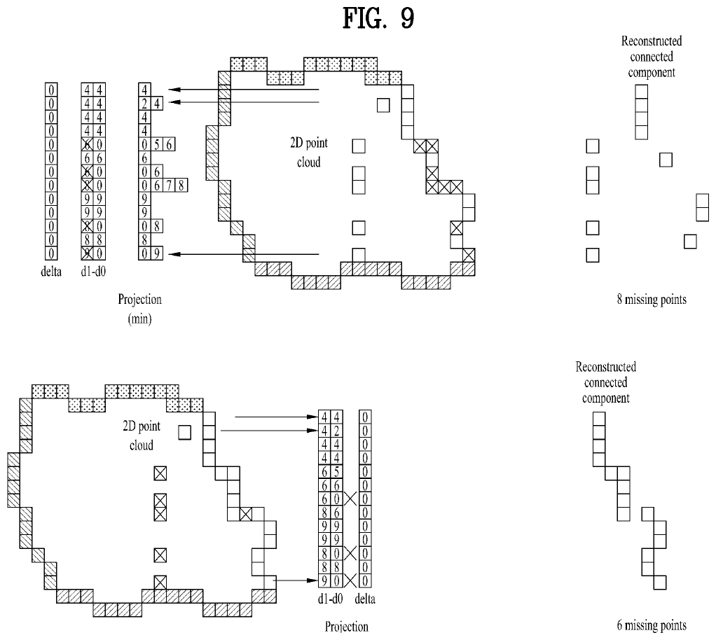

FIG. 9 shows an exemplary configuration of the minimum mode and maximum mode of a projection mode according to embodiments.

The point cloud encoder 10002 according to embodiments may perform patch-based projection to generate a geometry image, and the projection mode according to the embodiments includes a minimum mode and a maximum mode.

3D spatial coordinates of a patch may be calculated based on the bounding box of the minimum size surrounding the patch. For example, the 3D spatial coordinates may include the minimum tangent value of the patch (on the patch 3d shift tangent axis) of the patch, the minimum bitangent value of the patch (on the patch 3d shift bitangent axis), and the minimum normal value of the patch (on the patch 3d shift normal axis).

2D size of a patch indicates the horizontal and vertical sizes of the patch when the patch is packed into a 2D image. The horizontal size (patch 2d size u) may be obtained as a difference between the maximum and minimum tangent values of the bounding box, and the vertical size (patch 2d size v) may be obtained as a difference between the maximum and minimum bitangent values of the bounding box.

2) Determine a projection mode of the patch. The projection mode may be either the min mode or the max mode. The geometry information about the patch is expressed with a depth value. When each point constituting the patch is projected in the normal direction of the patch, two layers of images, an image constructed with the maximum depth value and an image constructed with the minimum depth value, may be generated.

In the min mode, in generating the two layers of images d0 and d1, the minimum depth may be configured for d0, and the maximum depth within the surface thickness from the minimum depth may be configured for d1, as shown in the figure.

For example, when a point cloud is located in 2D as illustrated in the figure, there may be a plurality of patches including a plurality of points. As shown in the figure, it is indicated that points marked with the same style of shadow may belong to the same patch. The figure illustrates the process of projecting a patch of points marked with blanks.

When projecting points marked with blanks to the left/right, the depth may be incremented by 1 as 0, 1, 2, . . . ,6, 7, 8, 9 with respect to the left side, and the number for calculating the depths of the points may be marked on the right side.

The same projection mode may be applied to all point clouds or different projection modes may be applied to respective frames or patches according to user definition. When different projection modes are applied to the respective frames or patches, a projection mode that may enhance compression efficiency or minimize missed points may be adaptively selected. 3) Calculate the depth values of the individual points.

In the min mode, image d0 is constructed with depth0, which is a value obtained by subtracting the minimum normal value of the patch (on the patch 3d shift normal axis) calculated in operation 1) from the minimum normal value of the patch (on the patch 3d shift normal axis) for the minimum normal value of each point. If there is another depth value within the range between depth0 and the surface thickness at the same position, this value is set to depth1. Otherwise, the value of depth0 is assigned to depth1. Image d1 is constructed with the value of depth1.

For example, a minimum value may be calculated in determining the depth of points of image d0 (4 2 4 4 0 6 0 0 9 9 0 8 0). In determining the depth of points of image d1, a greater value among two or more points may be calculated. When only one point is present, the value thereof may be calculated (4 4 4 4 6 6 6 8 9 9 8 8 9). In the process of encoding and reconstructing the points of the patch, some points may be lost (For example, in the figure, eight points are lost).

In the max mode, image d0 is constructed with depth0, which is a value obtained by subtracting the minimum normal value of the patch (on the patch 3d shift normal axis) calculated in operation 1) from the minimum normal value of the patch (on the patch 3d shift normal axis) for the maximum normal value of each point. If there is another depth value within the range between depth0 and the surface thickness at the same position, this value is set to depth1. Otherwise, the value of depth0 is assigned to depth1. Image d1 is constructed with the value of depth1.

For example, a maximum value may be calculated in determining the depth of points of do (4 4 4 4 6 6 6 8 9 9 8 8 9). In addition, in determining the depth of points of d1, a lower value among two or more points may be calculated. When only one point is present, the value thereof may be calculated (4 2 4 4 5 6 0 6 9 9 0 8 0). In the process of encoding and reconstructing the points of the patch, some points may be lost (For example, in the figure, six points are lost).

The entire geometry image may be generated by placing the geometry images of the individual patches generated through the above-described processes onto the entire geometry image based on the patch position information determined in the patch packing process.

Layer d1 of the generated entire geometry image may be encoded using various methods. A first method (absolute d1 method) is to encode the depth values of the previously generated image d1. A second method (differential method) is to encode a difference between the depth values of previously generated image d1 and the depth values of image d0.

In the encoding method using the depth values of the two layers, d0 and d1 as described above, if there is another point between the two depths, the geometry information about the point is lost in the encoding process, and therefore an enhanced-delta-depth (EDD) code may be used for lossless coding.

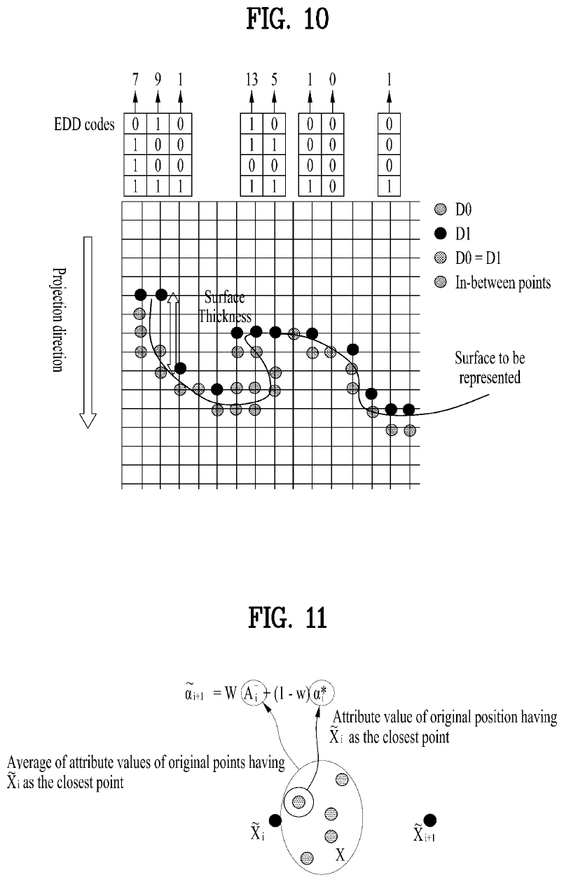

Hereinafter, the EDD code will be described in detail with reference to FIG. 10.

FIG. 10 illustrates an exemplary EDD code according to embodiments.

In some/all processes of the point cloud encoder 10002 and/or V-PCC encoding (e.g., video compression 40009), the geometry information about points may be encoded based on the EOD code.

As shown in the figure, the EDD code is used for binary encoding of the positions of all points within the range of surface thickness including d1. For example, in the figure, the points included in the second left column may be represented by an EDD code of 0b1001 (=9) because the points are present at the first and fourth positions over DO and the second and third positions are empty. When the EDD code is encoded together with DO and transmitted, a reception terminal may restore the geometry information about all points without loss.

For example, when there is a point present above a reference point, the value is 1. When there is no point, the value is 0. Thus, the code may be expressed based on 4 bits.

### Smoothing (40004)

Smoothing is an operation for eliminating discontinuity that may occur on the patch boundary due to deterioration of the image quality occurring during the compression process. Smoothing may be performed by the point cloud encoder or smoother:
1) Reconstruct the point cloud from the geometry image. This operation may be the reverse of the geometry image generation described above. For example, the reverse process of encoding may be reconstructed;
2) Calculate neighboring points of each point constituting the reconstructed point cloud using the K-D tree or the like;
3) Determine whether each of the points is positioned on the patch boundary. For example, when there is a neighboring point having a different projection plane (cluster index) from the current point, it may be determined that the point is positioned on the patch boundary;
4) If there is a point present on the patch boundary, move the point to the center of mass of the neighboring points (positioned at the average x, y, z coordinates of the neighboring points). That is, change the geometry value. Otherwise, maintain the previous geometry value.

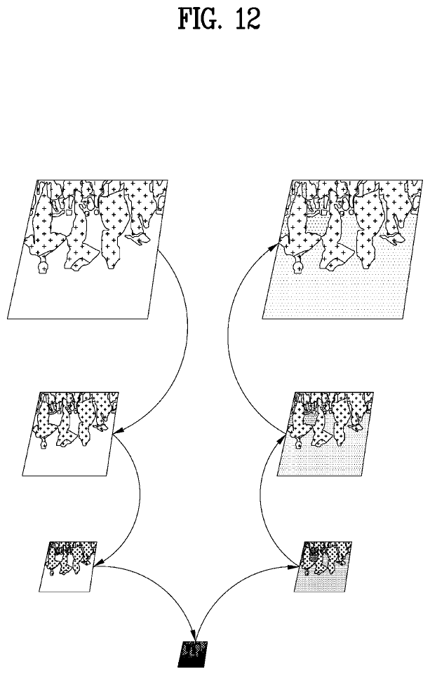

FIG. 11 illustrates an example of recoloring based on color values of neighboring points according to embodiments.

The point cloud encoder or the texture image generator 40003 according to the embodiments may generate a texture image based on recoloring.

### Texture Image Generation (40003)

The texture image generation process, which is similar to the geometry image generation process described above, includes generating texture images of individual patches and generating an entire texture image by arranging the texture images at determined positions. However, in the operation of generating texture images of individual patches, an image with color values (e.g., R, G, and B values) of the points constituting a point cloud corresponding to a position is generated in place of the depth values for geometry generation.

In estimating a color value of each point constituting the point cloud, the geometry previously obtained through the smoothing process may be used. In the smoothed point cloud, the positions of some points may have been shifted from the original point cloud, and accordingly a recoloring process of finding colors suitable for the changed positions may be required. Recoloring may be performed using the color values of neighboring points. For example, as shown in the figure, a new color value may be calculated in consideration of the color value of the nearest neighboring point and the color values of the neighboring points.

For example, referring to the figure, in the recoloring, a suitable color value for a changed position may be calculated based on the average of the attribute information about the closest original points to a point and/or the average of the attribute information about the closest original positions to the point.

Texture images may also be generated in two layers of t0 and t1, like the geometry images, which are generated in two layers of d0 and d1.

### Auxiliary Patch Info Compression (40005)

The point cloud encoder or the auxiliary patch info compressor according to the embodiments may compress the auxiliary patch information (auxiliary information about the point cloud).

The auxiliary patch info compressor compresses the auxiliary patch information generated in the operations of patch generation, patch packing, and geometry generation described above. The auxiliary patch information may include the following parameters:

### Index (Cluster Index) for Identifying the Projection Plane (Normal Plane);

3D spatial position of a patch, i.e., the minimum tangent value of the patch (on the patch 3d shift tangent axis), the minimum bitangent value of the patch (on the patch 3d shift bitangent axis), and the minimum normal value of the patch (on the patch 3d shift normal axis);

2D spatial position and size of the patch, i.e., the horizontal size (patch 2d size u), the vertical size (patch 2d size v), the minimum horizontal value (patch 2d shift u), and the minimum vertical value (patch 2d shift u); and

Mapping information about each block and patch, i.e., a candidate index (when patches are disposed in order based on the 2D spatial position and size information about the patches, multiple patches may be mapped to one block in an overlapping manner. In this case, the mapped patches constitute a candidate list, and the candidate index indicates the position in sequential order of a patch whose data is present in the block), and a local patch index (which is an index indicating one of the patches present in the frame). Table X shows a pseudo code representing the process of matching between blocks and patches based on the candidate list and the local patch indexes.

The maximum number of candidate lists may be defined by a user.

### Pseudo Code for Block to Patch Mapping

for(i=0; i<BlockCount; i++) {
if(candidatePatches[i].size( ) == 1) {
blockToPatch[i] = candidatePatches[i][0] } else {
candidate_index
if(candidate_index == max_candidate_count){
blockToPatch[i] = local_patch_index } else {
blockToPatch[i] = candidatePatches[i][candidate_index }
}

FIG. 12 illustrates push-pull background filling according to embodiments. Image padding and group dilation (40006, 40007, 40008)

The image padder according to the embodiments may fill the space except the patch area with meaningless supplemental data based on the push-pull background filling technique.

Image padding is a process of filling the space other than the patch region with meaningless data to improve compression efficiency. For image padding, pixel values in columns or rows close to a boundary in the patch may be copied to fill the empty space. Alternatively, as shown in the figure, a push-pull background filling method may be used. According to this method, the empty space is filled with pixel values from a low resolution image in the process of gradually reducing the resolution of a non-padded image and increasing the resolution again.

Group dilation is a process of filling the empty spaces of a geometry image and a texture image configured in two layers, d0/d1 and t0/t1, respectively. In this process, the empty spaces of the two layers calculated through image padding are filled with the average of the values for the same position.

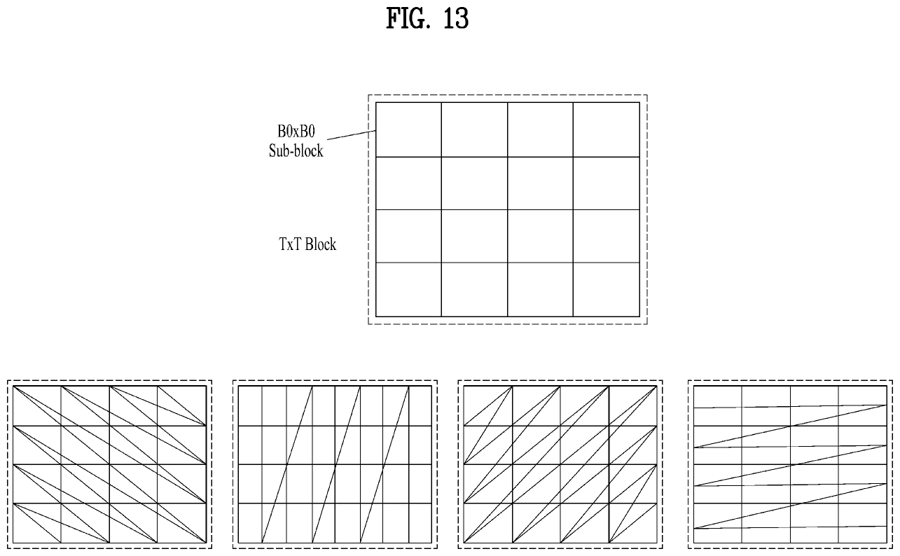

FIG. 13 shows an exemplary possible traversal order for a 4*4 block according to embodiments.

### Occupancy Map Compression (40012, 40011)

The occupancy map compressor according to the embodiments may compress the previously generated occupancy map. Specifically, two methods, namely video compression for lossy compression and entropy compression for lossless compression, may be used. Video compression is described below.

The entropy compression may be performed through the following operations.
1) If a block constituting an occupancy map is fully occupied, encode 1 and repeat the same operation for the next block of the occupancy map. Otherwise, encode 0 and perform operations 2) to 5).
2) Determine the best traversal order to perform run-length coding on the occupied pixels of the block. The figure shows four possible traversal orders for a 4*4 block.

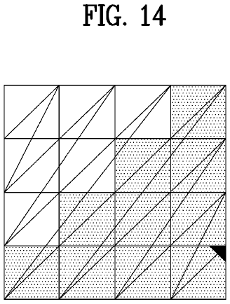

FIG. 14 illustrates an exemplary best traversal order according to embodiments.

As described above, the entropy compressor according to the embodiments may code (encode) a block based on the traversal order scheme as described above.

For example, the best traversal order with the minimum number of runs is selected from among the possible traversal orders and the index thereof is encoded. The figure illustrates a case where the third traversal order in FIG. 13 is selected. In the illustrated case, the number of runs may be minimized to 2, and therefore the third traversal order may be selected as the best traversal order.
3) Encode the number of runs. In the example of FIG. 14, there are two runs, and therefore 2 is encoded.
4) Encode the occupancy of the first run. In the example of FIG. 14, 0 is encoded because the first run corresponds to unoccupied pixels.
5) Encode lengths of the individual runs (as many as the number of runs). In the example of FIG. 14, the lengths of the first run and the second run, 6 and 10, are sequentially encoded.

### Video Compression (40009, 40010, 40011)

The video compressor according to the embodiments encodes a sequence of a geometry image, a texture image, an occupancy map image, and the like generated in the above-described operations, using a 2D video codec such as HEVC or VVC.

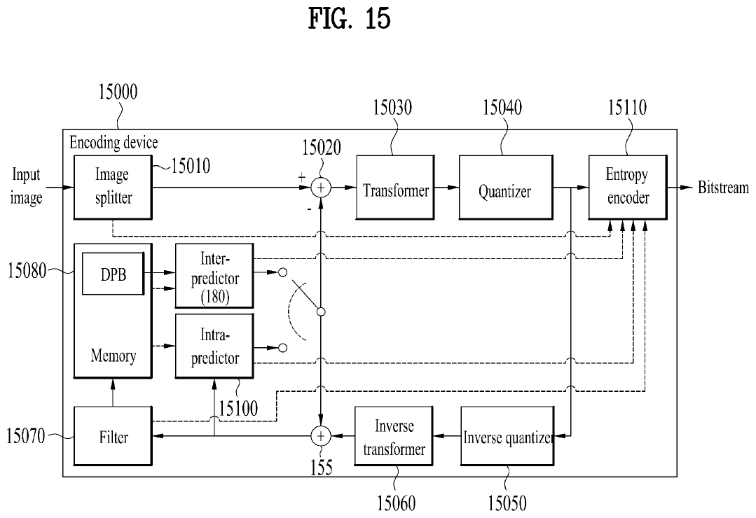

FIG. 15 illustrates an exemplary 2D video/image encoder according to embodiments.

The figure, which represents an embodiment to which the video compression or video compressor 40009, 40010, and 40011 described above is applied, is a schematic block diagram of a 2D video/image encoder 15000 configured to encode a video/image signal. The 2D video/image encoder 15000 may be included in the point cloud video encoder described above or may be configured as an internal/external component. Each component of FIG. 15 may correspond to software, hardware, processor and/or a combination thereof.

Here, the input image may include the geometry image, the texture image (attribute(s) image), and the occupancy map image described above. The output bitstream (i.e., the point cloud video/image bitstream) of the point cloud video encoder may include output bitstreams for the respective input images (i.e., the geometry image, the texture image (attribute(s) image), the occupancy map image, etc.).

An inter-predictor 15090 and an intra-predictor 15100 may be collectively called a predictor. That is, the predictor may include the inter-predictor 15090 and the intra-predictor 15100. A transformer 15030, a quantizer 15040, an inverse quantizer 15050, and an inverse transformer 15060 may be included in the residual processor. The residual processor may further include a subtractor 15020. According to an embodiment, the image splitter 15010, the subtractor 15020, the transformer 15030, the quantizer 15040, the inverse quantizer 15050, the inverse transformer 15060, the adder 155, the filter 15070, the inter-predictor 15090, the intra-predictor 15100, and the entropy encoder 15110 described above may be configured by one hardware component (e.g., an encoder or a processor). In addition, the memory 15080 may include a decoded picture buffer (DPB) and may be configured by a digital storage medium.

The image splitter 15010 may spit an image (or a picture or a frame) input to the encoder 15000 into one or more processing units. For example, the processing unit may be called a coding unit (CU). In this case, the CU may be recursively split from a coding tree unit (CTU) or a largest coding unit (LCU) according to a quad-tree binary-tree (QTBT) structure. For example, one CU may be split into a plurality of CUs of a lower depth based on a quad-tree structure and/or a binary-tree structure. In this case, for example, the quad-tree structure may be applied first and the binary-tree structure may be applied later. Alternatively, the binary-tree structure may be applied first. The coding procedure according to the present disclosure may be performed based on a final CU that is not split anymore. In this case, the LCU may be used as the final CU based on coding efficiency according to characteristics of the image. When necessary, a CU may be recursively split into CUs of a lower depth, and a CU of the optimum size may be used as the final CU. Here, the coding procedure may include prediction, transformation, and reconstruction, which will be described later. As another example, the processing unit may further include a prediction unit (PU) or a transform unit (TU). In this case, the PU and the TU may be split or partitioned from the aforementioned final CU. The PU may be a unit of sample prediction, and the TU may be a unit for deriving a transform coefficient and/or a unit for deriving a residual signal from the transform coefficient.

The term “unit” may be used interchangeably with terms such as block or area. In a general case, an M×N block may represent a set of samples or transform coefficients configured in M columns and N rows. A sample may generally represent a pixel or a value of a pixel, and may indicate only a pixel/pixel value of a luma component, or only a pixel/pixel value of a chroma component. “Sample” may be used as a term corresponding to a pixel or a pel in one picture (or image).

The encoder 15000 may generate a residual signal (residual block or residual sample array) by subtracting a prediction signal (predicted block or predicted sample array) output from the inter-predictor 15090 or the intra-predictor 15100 from an input image signal (original block or original sample array), and the generated residual signal is transmitted to the transformer 15030. In this case, as shown in the figure, the unit that subtracts the prediction signal (predicted block or predicted sample array) from the input image signal (original block or original sample array) in the encoder 15000 may be called a subtractor 15020. The predictor may perform prediction for a processing target block (hereinafter referred to as a current block) and generate a predicted block including prediction samples for the current block. The predictor may determine whether intra-prediction or inter-prediction is applied on a current block or CU basis. As will be described later in the description of each prediction mode, the predictor may generate various kinds of information about prediction, such as prediction mode information, and deliver the generated information to the entropy encoder 15110. The information about the prediction may be encoded and output in the form of a bitstream by the entropy encoder 15110.

The intra-predictor 15100 may predict the current block with reference to the samples in the current picture. The samples may be positioned in the neighbor of or away from the current block depending on the prediction mode. In intra-prediction, the prediction modes may include a plurality of non-directional modes and a plurality of directional modes. The non-directional modes may include, for example, a DC mode and a planar mode. The directional modes may include, for example, 33 directional prediction modes or 65 directional prediction modes according to fineness of the prediction directions. However, this is merely an example, and more or fewer directional prediction modes may be used depending on the setting. The intra-predictor 15100 may determine a prediction mode to be applied to the current block, based on the prediction mode applied to the neighboring block.

The inter-predictor 15090 may derive a predicted block for the current block based on a reference block (reference sample array) specified by a motion vector on the reference picture. In this case, in order to reduce the amount of motion information transmitted in the inter-prediction mode, the motion information may be predicted on a per block, subblock, or sample basis based on the correlation in motion information between the neighboring blocks and the current block. The motion information may include a motion vector and a reference picture index. The motion information may further include information about an inter-prediction direction (L0 prediction, L1 prediction, Bi prediction, etc.). In the case of inter-prediction, the neighboring blocks may include a spatial neighboring block, which is present in the current picture, and a temporal neighboring block, which is present in the reference picture. The reference picture including the reference block may be the same as or different from the reference picture including the temporal neighboring block. The temporal neighboring block may be referred to as a collocated reference block or a collocated CU (colCU), and the reference picture including the temporal neighboring block may be referred to as a collocated picture (colPic). For example, the inter-predictor 15090 may configure a motion information candidate list based on the neighboring blocks and generate information indicating a candidate to be used to derive a motion vector and/or a reference picture index of the current block. Inter-prediction may be performed based on various prediction modes. For example, in a skip mode and a merge mode, the inter-predictor 15090 may use motion information about a neighboring block as motion information about the current block. In the skip mode, unlike the merge mode, the residual signal may not be transmitted. In a motion vector prediction (MVP) mode, the motion vector of a neighboring block may be used as a motion vector predictor and the motion vector difference may be signaled to indicate the motion vector of the current block.

The prediction signal generated by the inter-predictor 15090 or the intra-predictor 15100 may be used to generate a reconstruction signal or to generate a residual signal.

The transformer 15030 may generate transform coefficients by applying a transformation technique to the residual signal. For example, the transformation technique may include at least one of discrete cosine transform (DCT), discrete sine transform (DST), Karhunen-Loève transform (KLT), graph-based transform (GBT), or conditionally non-linear transform (CNT). Here, the GBT refers to transformation obtained from a graph depicting the relationship between pixels. The CNT refers to transformation obtained based on a prediction signal generated based on all previously reconstructed pixels. In addition, the transformation operation may be applied to pixel blocks having the same size of a square, or may be applied to blocks of a variable size other than the square.

The quantizer 15040 may quantize the transform coefficients and transmit the same to the entropy encoder 15110. The entropy encoder 15110 may encode the quantized signal (information about the quantized transform coefficients) and output a bitstream of the encoded signal. The information about the quantized transform coefficients may be referred to as residual information. The quantizer 15040 may rearrange the quantized transform coefficients, which are in a block form, in the form of a one-dimensional vector based on a coefficient scan order, and generate information about the quantized transform coefficients based on the quantized transform coefficients in the form of the one-dimensional vector. The entropy encoder 15110 may employ various encoding techniques such as, for example, exponential Golomb, context-adaptive variable length coding (CAVLC), and context-adaptive binary arithmetic coding (CABAC). The entropy encoder 15110 may encode information necessary for video/image reconstruction (e.g., values of syntax elements) together with or separately from the quantized transform coefficients. The encoded information (e.g., encoded video/image information) may be transmitted or stored in the form of a bitstream on a network abstraction layer (NAL) unit basis. The bitstream may be transmitted over a network or may be stored in a digital storage medium. Here, the network may include a broadcast network and/or a communication network, and the digital storage medium may include various storage media such as USB, SD, CD, DVD, Blu-ray, HDD, and SSD. A transmitter (not shown) to transmit the signal output from the entropy encoder 15110 and/or a storage (not shown) to store the signal may be configured as internal/external elements of the encoder 15000. Alternatively, the transmitter may be included in the entropy encoder 15110.

The quantized transform coefficients output from the quantizer 15040 may be used to generate a prediction signal. For example, inverse quantization and inverse transform may be applied to the quantized transform coefficients through the inverse quantizer 15050 and the inverse transformer 15060 to reconstruct the residual signal (residual block or residual samples). The adder 155 may add the reconstructed residual signal to the prediction signal output from the inter-predictor 15090 or the intra-predictor 15100. Thereby, a reconstructed signal (reconstructed picture, reconstructed block, reconstructed sample array) may be generated. When there is no residual signal for a processing target block as in the case where the skip mode is applied, the predicted block may be used as the reconstructed block. The adder 155 may be called a reconstructor or a reconstructed block generator. The generated reconstructed signal may be used for intra-prediction of the next processing target block in the current picture, or may be used for inter-prediction of the next picture through filtering as described below.

The filter 15070 may improve subjective/objective image quality by applying filtering to the reconstructed signal. For example, the filter 15070 may generate a modified reconstructed picture by applying various filtering techniques to the reconstructed picture, and the modified reconstructed picture may be stored in the memory 15080, specifically, the DPB of the memory 15080. The various filtering techniques may include, for example, deblocking filtering, sample adaptive offset, adaptive loop filtering, and bilateral filtering. As described below in the description of the filtering techniques, the filter 15070 may generate various kinds of information about filtering and deliver the generated information to the entropy encoder 15110. The information about filtering may be encoded and output in the form of a bitstream by the entropy encoder 15110.

The modified reconstructed picture transmitted to the memory 15080 may be used as a reference picture by the inter-predictor 15090. Thus, when inter-prediction is applied, the encoder may avoid prediction mismatch between the encoder 15000 and the decoder and improve encoding efficiency.

The DPB of the memory 15080 may store the modified reconstructed picture so as to be used as a reference picture by the inter-predictor 15090. The memory 15080 may store the motion information about a block from which the motion information in the current picture is derived (or encoded) and/or the motion information about the blocks in a picture that has already been reconstructed. The stored motion information may be delivered to the inter-predictor 15090 so as to be used as motion information about a spatial neighboring block or motion information about a temporal neighboring block. The memory 15080 may store the reconstructed samples of the reconstructed blocks in the current picture and deliver the reconstructed samples to the intra-predictor 15100.

At least one of the prediction, transform, and quantization procedures described above may be skipped. For example, for a block to which the pulse coding mode (PCM) is applied, the prediction, transform, and quantization procedures may be skipped, and the value of the original sample may be encoded and output in the form of a bitstream.

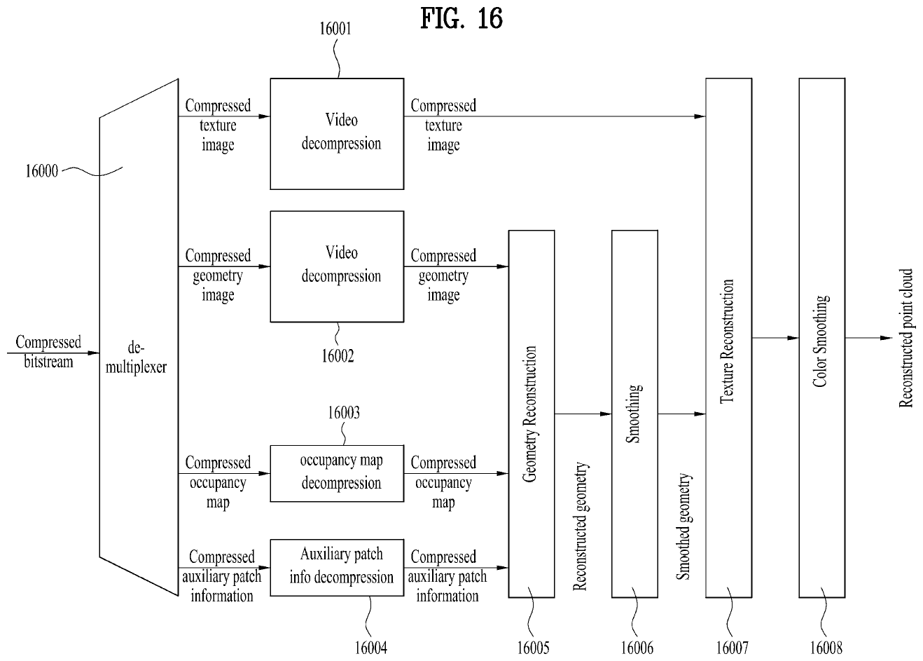

FIG. 16 illustrates an exemplary V-PCC decoding process according to embodiments.

The V-PCC decoding process or V-PCC decoder may follow the reverse process of the V-PCC encoding process (or encoder) of FIG. 4. Each component in FIG. 16 may correspond to software, hardware, a processor, and/or a combination thereof.

The demultiplexer 16000 demultiplexes the compressed bitstream to output a compressed texture image, a compressed geometry image, a compressed occupancy map, and compressed auxiliary patch information.

The video decompression or video decompressor 16001, 16002 decompresses (or decodes) each of the compressed texture image and the compressed geometry image.

The occupancy map decompression or occupancy map decompressor 16003 decompresses the compressed occupancy map.

The auxiliary patch info decompression or auxiliary patch info decompressor 16004 decompresses auxiliary patch information.

The geometry reconstruction or geometry reconstructor 16005 restores (reconstructs) the geometry information based on the decompressed geometry image, the decompressed occupancy map, and/or the decompressed auxiliary patch information. For example, the geometry changed in the encoding process may be reconstructed.

The smoothing or smoother 16006 may apply smoothing to the reconstructed geometry. For example, smoothing filtering may be applied.

The texture reconstruction or texture reconstructor 16007 reconstructs the texture from the decompressed texture image and/or the smoothed geometry.

The color smoothing or color smoother 16008 smoothes color values from the reconstructed texture. For example, smoothing filtering may be applied.

As a result, reconstructed point cloud data may be generated.

The figure illustrates a decoding process of the V-PCC for reconstructing a point cloud by decoding the compressed occupancy map, geometry image, texture image, and auxiliary path information. Each process according to the embodiments is operated as follows.

### Video Decompression (1600, 16002)

Video decompression is a reverse process of the video compression described above. In video decompression, a 2D video codec such as HEVC or VVC is used to decode a compressed bitstream containing the geometry image, texture image, and occupancy map image generated in the above-described process.

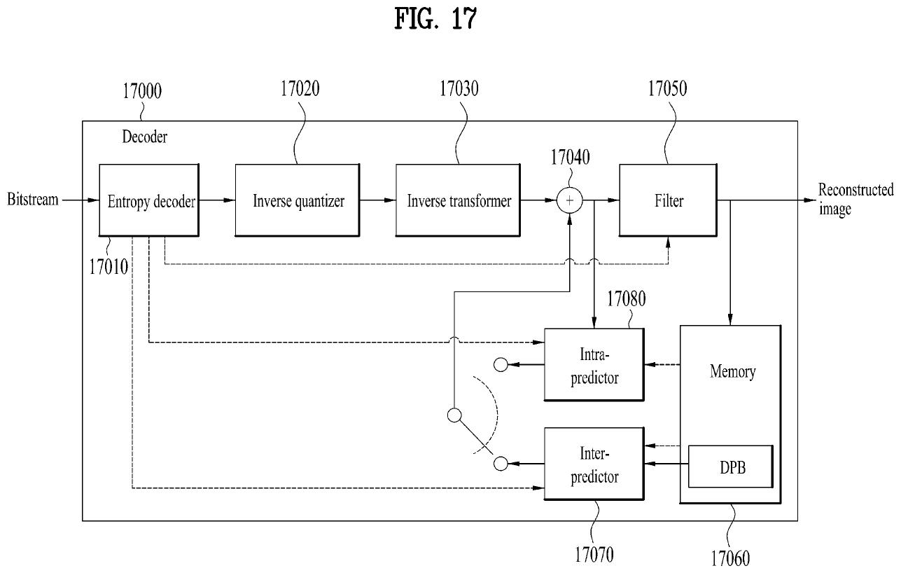

FIG. 17 illustrates an exemplary 2D video/image decoder according to embodiments.

The 2D video/image decoder may follow the reverse process of the 2D video/image encoder of FIG. 15.

The 2D video/image decoder of FIG. 17 is an embodiment of the video decompression or video decompressor of FIG. 16. FIG. 17 is a schematic block diagram of a 2D video/image decoder 17000 by which decoding of a video/image signal is performed. The 2D video/image decoder 17000 may be included in the point cloud video decoder of FIG. 1, or may be configured as an internal/external component. Each component in FIG. 17 may correspond to software, hardware, a processor, and/or a combination thereof.

Here, the input bitstream may include bitstreams for the geometry image, texture image (attribute(s) image), and occupancy map image described above. The reconstructed image (or the output image or the decoded image) may represent a reconstructed image for the geometry image, texture image (attribute(s) image), and occupancy map image described above.

Referring to the figure, an inter-predictor 17070 and an intra-predictor 17080 may be collectively referred to as a predictor. That is, the predictor may include the inter-predictor 17070 and the intra-predictor 17080. An inverse quantizer 17020 and an inverse transformer 17030 may be collectively referred to as a residual processor. That is, the residual processor may include the inverse quantizer 17020 and the inverse transformer 17030. The entropy decoder 17010, the inverse quantizer 17020, the inverse transformer 17030, the adder 17040, the filter 17050, the inter-predictor 17070, and the intra-predictor 17080 described above may be configured by one hardware component (e.g., a decoder or a processor) according to an embodiment. In addition, the memory 170 may include a decoded picture buffer (DPB) or may be configured by a digital storage medium.

When a bitstream containing video/image information is input, the decoder 17000 may reconstruct an image in a process corresponding to the process in which the video/image information is processed by the encoder of FIG. 1. For example, the decoder 17000 may perform decoding using a processing unit applied in the encoder. Thus, the processing unit of decoding may be, for example, a CU. The CU may be split from a CTU or an LCU along a quad-tree structure and/or a binary-tree structure. Then, the reconstructed video signal decoded and output through the decoder 17000 may be played through a player.

The decoder 17000 may receive a signal output from the encoder in the form of a bitstream, and the received signal may be decoded through the entropy decoder 17010. For example, the entropy decoder 17010 may parse the bitstream to derive information (e.g., video/image information) necessary for image reconstruction (or picture reconstruction). For example, the entropy decoder 17010 may decode the information in the bitstream based on a coding technique such as exponential Golomb coding, CAVLC, or CABAC, output values of syntax elements required for image reconstruction, and quantized values of transform coefficients for the residual. More specifically, in the CABAC entropy decoding, a bin corresponding to each syntax element in the bitstream may be received, and a context model may be determined based on decoding target syntax element information and decoding information about neighboring and decoding target blocks or information about a symbol/bin decoded in a previous step. Then, the probability of occurrence of a bin may be predicted according to the determined context model, and arithmetic decoding of the bin may be performed to generate a symbol corresponding to the value of each syntax element. According to the CABAC entropy decoding, after a context model is determined, the context model may be updated based on the information about the symbol/bin decoded for the context model of the next symbol/bin. Information about the prediction in the information decoded by the entropy decoder 17010 may be provided to the predictors (the inter-predictor 17070 and the intra-predictor 17080), and the residual values on which entropy decoding has been performed by the entropy decoder 17010, that is, the quantized transform coefficients and related parameter information, may be input to the inverse quantizer 17020. In addition, information about filtering of the information decoded by the entropy decoder 17010 may be provided to the filter 17050. A receiver (not shown) configured to receive a signal output from the encoder may be further configured as an internal/external element of the decoder 17000. Alternatively, the receiver may be a component of the entropy decoder 17010.

The inverse quantizer 17020 may output transform coefficients by inversely quantizing the quantized transform coefficients. The inverse quantizer 17020 may rearrange the quantized transform coefficients in the form of a two-dimensional block. In this case, the rearrangement may be performed based on the coefficient scan order implemented by the encoder. The inverse quantizer 17020 may perform inverse quantization on the quantized transform coefficients using a quantization parameter (e.g., quantization step size information), and acquire transform coefficients.

The inverse transformer 17030 acquires a residual signal (residual block and residual sample array) by inversely transforming the transform coefficients.

The predictor may perform prediction on the current block and generate a predicted block including prediction samples for the current block. The predictor may determine whether intra-prediction or inter-prediction is to be applied to the current block based on the information about the prediction output from the entropy decoder 17010, and may determine a specific intra-/inter-prediction mode.

The intra-predictor 265 may predict the current block with reference to the samples in the current picture. The samples may be positioned in the neighbor of or away from the current block depending on the prediction mode. In intra-prediction, the prediction modes may include a plurality of non-directional modes and a plurality of directional modes. The intra-predictor 17080 may determine a prediction mode to be applied to the current block, using the prediction mode applied to the neighboring block.

The inter-predictor 17070 may derive a predicted block for the current block based on a reference block (reference sample array) specified by a motion vector on the reference picture. In this case, in order to reduce the amount of motion information transmitted in the inter-prediction mode, the motion information may be predicted on a per block, subblock, or sample basis based on the correlation in motion information between the neighboring blocks and the current block. The motion information may include a motion vector and a reference picture index. The motion information may further include information about an inter-prediction direction (L0 prediction, L1 prediction, Bi prediction, etc.). In the case of inter-prediction, the neighboring blocks may include a spatial neighboring block, which is present in the current picture, and a temporal neighboring block, which is present in the reference picture. For example, the inter-predictor 17070 may configure a motion information candidate list based on neighboring blocks and derive a motion vector of the current block and/or a reference picture index based on the received candidate selection information. Inter-prediction may be performed based on various prediction modes. The information about the prediction may include information indicating an inter-prediction mode for the current block.

The adder 17040 may add the acquired residual signal to the prediction signal (predicted block or prediction sample array) output from the inter-predictor 17070 or the intra-predictor 17080, thereby generating a reconstructed signal (a reconstructed picture, a reconstructed block, or a reconstructed sample array). When there is no residual signal for a processing target block as in the case where the skip mode is applied, the predicted block may be used as the reconstructed block.

The adder 17040 may be called a reconstructor or a reconstructed block generator. The generated reconstructed signal may be used for intra-prediction of the next processing target block in the current picture, or may be used for inter-prediction of the next picture through filtering as described below.

The filter 17050 may improve subjective/objective image quality by applying filtering to the reconstructed signal. For example, the filter 17050 may generate a modified reconstructed picture by applying various filtering techniques to the reconstructed picture, and may transmit the modified reconstructed picture to the memory 250, specifically, the DPB of the memory 17060. The various filtering techniques may include, for example, deblocking filtering, sample adaptive offset, adaptive loop filtering, and bilateral filtering.

The reconstructed picture stored in the DPB of the memory 17060 may be used as a reference picture in the inter-predictor 17070. The memory 17060 may store the motion information about a block from which the motion information is derived (or decoded) in the current picture and/or the motion information about the blocks in a picture that has already been reconstructed. The stored motion information may be delivered to the inter-predictor 17070 so as to be used as the motion information about a spatial neighboring block or the motion information about a temporal neighboring block. The memory 17060 may store the reconstructed samples of the reconstructed blocks in the current picture, and deliver the reconstructed samples to the intra-predictor 17080.

In the present disclosure, the embodiments described regarding the filter 160, the inter-predictor 180, and the intra-predictor 185 of the encoding device 100 may be applied to the filter 17050, the inter-predictor 17070 and the intra-predictor 17080 of the decoder 17000, respectively, in the same or corresponding manner.

At least one of the prediction, transform, and quantization procedures described above may be skipped. For example, for a block to which the pulse coding mode (PCM) is applied, the prediction, transform, and quantization procedures may be skipped, and the value of a decoded sample may be used as a sample of the reconstructed image.

### Occupancy Map Decompression (16003)

This is a reverse process of the occupancy map compression described above. Occupancy map decompression is a process for reconstructing the occupancy map by decompressing the occupancy map bitstream.

### Auxiliary Patch Info Decompression (16004)

The auxiliary patch information may be reconstructed by performing the reverse process of the aforementioned auxiliary patch info compression and decoding the compressed auxiliary patch info bitstream.

### Geometry Reconstruction (16005)

This is a reverse process of the geometry image generation described above. Initially, a patch is extracted from the geometry image using the reconstructed occupancy map, the 2D position/size information about the patch included in the auxiliary patch info, and the information about mapping between a block and the patch. Then, a point cloud is reconstructed in a 3D space based on the geometry image of the extracted patch and the 3D position information about the patch included in the auxiliary patch info. When the geometry value corresponding to a point (u, v) within the patch is g (u, v), and the coordinates of the position of the patch on the normal, tangent and bitangent axes of the 3D space are (δ0, s0, r0), □δ(u, v), s(u, v), and r(u, v), which are the normal, tangent, and bitangent coordinates in the 3D space of a position mapped to point (u, v) may be expressed as follows:

$$δ ( u , v ) = δ 0 + g ( u , v ) ;$$

$$s ( u , v ) = s 0 + u ;$$

$$r ( u , v ) = r 0 + v .$$

### Smoothing (16006)

Smoothing, which is the same as the smoothing in the encoding process described above, is a process for eliminating discontinuity that may occur on the patch boundary due to deterioration of the image quality occurring during the compression process.

### Texture Reconstruction (16007)

Texture reconstruction is a process of reconstructing a color point cloud by assigning color values to each point constituting a smoothed point cloud. It may be performed by assigning color values corresponding to a texture image pixel at the same position as in the geometry image in the 2D space to points of a point of a point cloud corresponding to the same position in the 3D space, based on the mapping information about the geometry image and the point cloud in the geometry reconstruction process described above.

### Color Smoothing (16008)

Color smoothing is similar to the process of geometry smoothing described above. Color smoothing is a process for eliminating discontinuity that may occur on the patch boundary due to deterioration of the image quality occurring during the compression process. Color smoothing may be performed through the following operations:
1) Calculate neighboring points of each point constituting the reconstructed point cloud using the K-D tree or the like. The neighboring point information calculated in the geometry smoothing process described in section 2.5 may be used.
2) Determine whether each of the points is positioned on the patch boundary. These operations may be performed based on the boundary information calculated in the geometry smoothing process described above.
3) Check the distribution of color values for the neighboring points of the points present on the boundary and determine whether smoothing is to be performed. For example, when the entropy of luminance values is less than or equal to a threshold local entry (there are many similar luminance values), it may be determined that the corresponding portion is not an edge portion, and smoothing may be performed. As a method of smoothing, the color value of the point may be replaced with the average of the color values of the neighboring points.

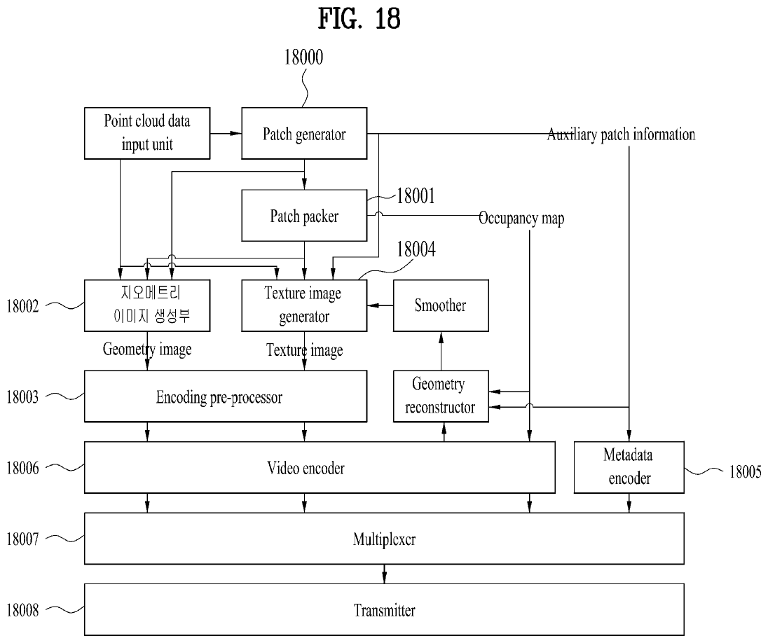

FIG. 18 is a flowchart illustrating operation of a transmission device according to embodiments of the present disclosure.

The transmission device according to the embodiments may correspond to the transmission device of FIG. 1, the encoding process of FIG. 4, and the 2D video/image encoder of FIG. 15, or perform some/all of the operations thereof. Each component of the transmission device may correspond to software, hardware, a processor and/or a combination thereof.

An operation process of the transmission terminal for compression and transmission of point cloud data using V-PCC may be performed as illustrated in the figure.

The point cloud data transmission device according to the embodiments may be referred to as a transmission device.

Regarding a patch generator 18000, a patch for 2D image mapping of a point cloud is generated. Auxiliary patch information is generated as a result of the patch generation. The generated information may be used in the processes of geometry image generation, texture image generation, and geometry reconstruction for smoothing.

Regarding a patch packer 18001, a patch packing process of mapping the generated patches into the 2D image is performed. As a result of patch packing, an occupancy map may be generated. The occupancy map may be used in the processes of geometry image generation, texture image generation, and geometry reconstruction for smoothing.

A geometry image generator 18002 generates a geometry image based on the auxiliary patch information and the occupancy map. The generated geometry image is encoded into one bitstream through video encoding.

An encoding preprocessor 18003 may include an image padding procedure. The geometry image regenerated by decoding the generated geometry image or the encoded geometry bitstream may be used for 3D geometry reconstruction and then be subjected to a smoothing process.

A texture image generator 18004 may generate a texture image based on the (smoothed) 3D geometry, the point cloud, the auxiliary patch information, and the occupancy map. The generated texture image may be encoded into one video bitstream.

A metadata encoder 18005 may encode the auxiliary patch information into one metadata bitstream.

A video encoder 18006 may encode the occupancy map into one video bitstream.

A multiplexer 18007 may multiplex the video bitstreams of the generated geometry image, texture image, and occupancy map and the metadata bitstream of the auxiliary patch information into one bitstream.

A transmitter 18008 may transmit the bitstream to the reception terminal. Alternatively, the video bitstreams of the generated geometry image, texture image, and the occupancy map and the metadata bitstream of the auxiliary patch information may be processed into a file of one or more track data or encapsulated into segments and may be transmitted to the reception terminal through the transmitter.

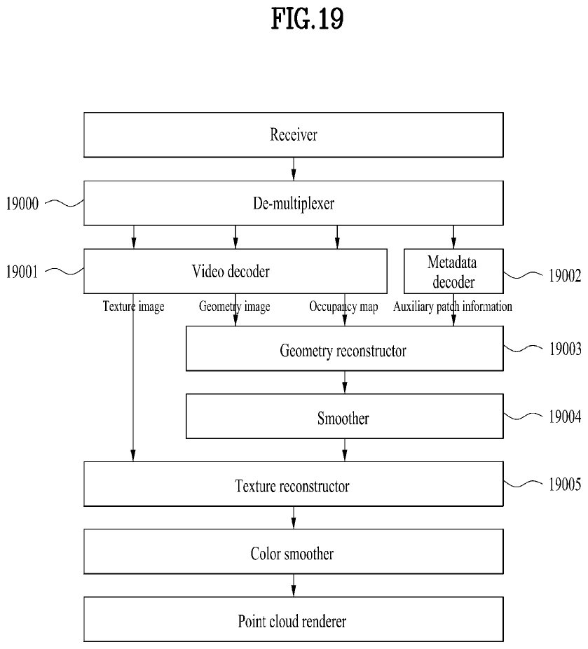

FIG. 19 is a flowchart illustrating operation of a reception device according to embodiments.

The reception device according to the embodiments may correspond to the reception device of FIG. 1, the decoding process of FIG. 16, and the 2D video/image encoder of FIG. 17, or perform some/all of the operations thereof. Each component of the reception device may correspond to software, hardware, a processor and/or a combination thereof.

The operation of the reception terminal for receiving and reconstructing point cloud data using V-PCC may be performed as illustrated in the figure. The operation of the V-PCC reception terminal may follow the reverse process of the operation of the V-PCC transmission terminal of FIG. 18.

The point cloud data reception device according to the embodiments may be referred to as a reception device.

The bitstream of the received point cloud is demultiplexed into the video bitstreams of the compressed geometry image, texture image, occupancy map and the metadata bitstream of the auxiliary patch information by a demultiplexer 19000 after file/segment decapsulation. A video decoder 19001 and a metadata decoder 19002 decode the demultiplexed video bitstreams and metadata bitstream. 3D geometry is reconstructed by a geometry reconstructor 19003 based on the decoded geometry image, occupancy map, and auxiliary patch information, and is then subjected to a smoothing process performed by a smoother 19004. A color point cloud image/picture may be reconstructed by a texture reconstructor 19005 by assigning color values to the smoothed 3D geometry based on the texture image. Thereafter, a color smoothing process may be additionally performed to improve the objective/subjective visual quality, and a modified point cloud image/picture derived through the color smoothing process is shown to the user through the rendering process (through, for example, the point cloud renderer). In some cases, the color smoothing process may be skipped.

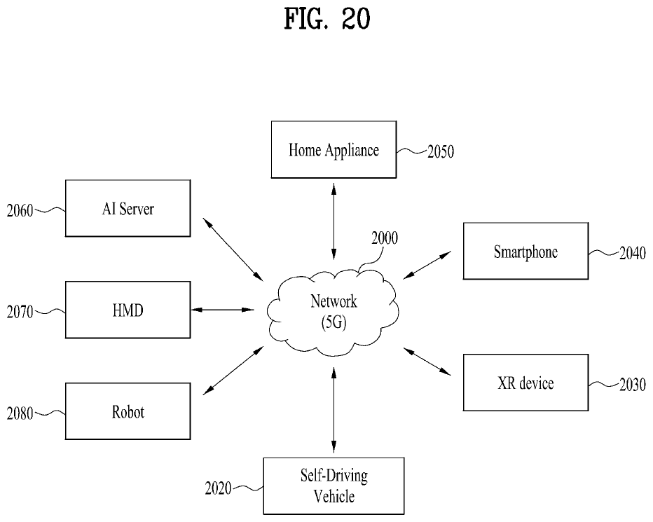

FIG. 20 illustrates an exemplary structure operable in connection with point cloud data transmission/reception methods/devices according to embodiments.

In the structure according to the embodiments, at least one of a server 2060, a robot 2010, a self-driving vehicle 2020, an XR device 2030, a smartphone 2040, a home appliance 2050 and/or a head-mount display (HMD) 2070 is connected to a cloud network 2010. Here, the robot 2010, the self-driving vehicle 2020, the XR device 2030, the smartphone 2040, or the home appliance 2050 may be referred to as a device. In addition, the XR device 2030 may correspond to a point cloud data (PCC) device according to embodiments or may be operatively connected to the PCC device.

The cloud network 2000 may represent a network that constitutes part of the cloud computing infrastructure or is present in the cloud computing infrastructure. Here, the cloud network 2000 may be configured using a 3G network, 4G or Long Term Evolution (LTE) network, or a 5G network.

The server 2060 may be connected to at least one of the robot 2010, the self-driving vehicle 2020, the XR device 2030, the smartphone 2040, the home appliance 2050, and/or the HMD 2070 over the cloud network 2000 and may assist at least a part of the processing of the connected devices 2010 to 2070.

The HMD 2070 represents one of the implementation types of the XR device and/or the PCC device according to the embodiments. An HMD type device according to embodiments includes a communication unit, a control unit, a memory, an I/O unit, a sensor unit, and a power supply unit.

Hereinafter, various embodiments of the devices 2010 to 2050 to which the above-described technology is applied will be described. The devices 2010 to 2050 illustrated in FIG. 20 may be operatively connected/coupled to a point cloud data transmission and reception device according to the above-described embodiments.

<PCC+XR> The XR/PCC device 2030 may employ PCC technology and/or XR (AR+VR) technology, and may be implemented as an HMD, a head-up display (HUD) provided in a vehicle, a television, a mobile phone, a smartphone, a computer, a wearable device, a home appliance, a digital signage, a vehicle, a stationary robot, or a mobile robot.

The XR/PCC device 2030 may analyze 3D point cloud data or image data acquired through various sensors or from an external device and generate position data and attribute data about 3D points. Thereby, the XR/PCC device 2030 may acquire information about the surrounding space or a real object, and render and output an XR object. For example, the XR/PCC device 2030 may match an XR object including auxiliary information about a recognized object with the recognized object and output the matched XR object.

<PCC+Self-driving+XR> The self-driving vehicle 2020 may be implemented as a mobile robot, a vehicle, an unmanned aerial vehicle, or the like by applying the PCC technology and the XR technology.

The self-driving vehicle 2020 to which the XR/PCC technology is applied may represent an autonomous vehicle provided with means for providing an XR image, or an autonomous vehicle that is a target of control/interaction in the XR image. In particular, the self-driving vehicle 2020, which is a target of control/interaction in the XR image, may be distinguished from the XR device 2030 and may be operatively connected thereto.

The self-driving vehicle 2020 having means for providing an XR/PCC image may acquire sensor information from the sensors including a camera, and output the generated XR/PCC image based on the acquired sensor information. For example, the self-driving vehicle may have an HUD and output an XR/PCC image thereto to provide an occupant with an XR/PCC object corresponding to a real object or an object present on the screen.

In this case, when the XR/PCC object is output to the HUD, at least a part of the XR/PCC object may be output to overlap the real object to which the occupant's eyes are directed. On the other hand, when the XR/PCC object is output on a display provided inside the self-driving vehicle, at least a part of the XR/PCC object may be output to overlap the object on the screen. For example, the self-driving vehicle may output XR/PCC objects corresponding to objects such as a road, another vehicle, a traffic light, a traffic sign, a two-wheeled vehicle, a pedestrian, and a building.

The virtual reality (VR) technology, the augmented reality (AR) technology, the mixed reality (MR) technology and/or the point cloud compression (PCC) technology according to the embodiments are applicable to various devices.

In other words, the VR technology is a display technology that provides only real-world objects, backgrounds, and the like as CG images. On the other hand, the AR technology refers to a technology for showing a CG image virtually created on a real object image. The MR technology is similar to the AR technology described above in that virtual objects to be shown are mixed and combined with the real world. However, the MR technology differs from the AR technology makes a clear distinction between a real object and a virtual object created as a CG image and uses virtual objects as complementary objects for real objects, whereas the MR technology treats virtual objects as objects having the same characteristics as real objects. More specifically, an example of MR technology applications is a hologram service.

Recently, the VR, AR, and MR technologies are sometimes referred to as extended reality (XR) technology rather than being clearly distinguished from each other. Accordingly, embodiments of the present disclosure are applicable to all VR, AR, MR, and XR technologies. For such technologies, encoding/decoding based on PCC, V-PCC, and G-PCC techniques may be applied.

The PCC method/device according to the embodiments may be applied to a vehicle that provides a self-driving service.

A vehicle that provides the self-driving service is connected to a PCC device for wired/wireless communication.

When the point cloud data transmission and reception device (PCC device) according to the embodiments is connected to a vehicle for wired/wireless communication, the device may receive and process content data related to an AR/VR/PCC service that may be provided together with the self-driving service and transmit the processed content data to the vehicle. In the case where the point cloud data transmission and reception device is mounted on a vehicle, the point cloud transmitting and reception device may receive and process content data related to the AR/VR/PCC service according to a user input signal input through a user interface device and provide the processed content data to the user. The vehicle or the user interface device according to the embodiments may receive a user input signal. The user input signal according to the embodiments may include a signal indicating the self-driving service.

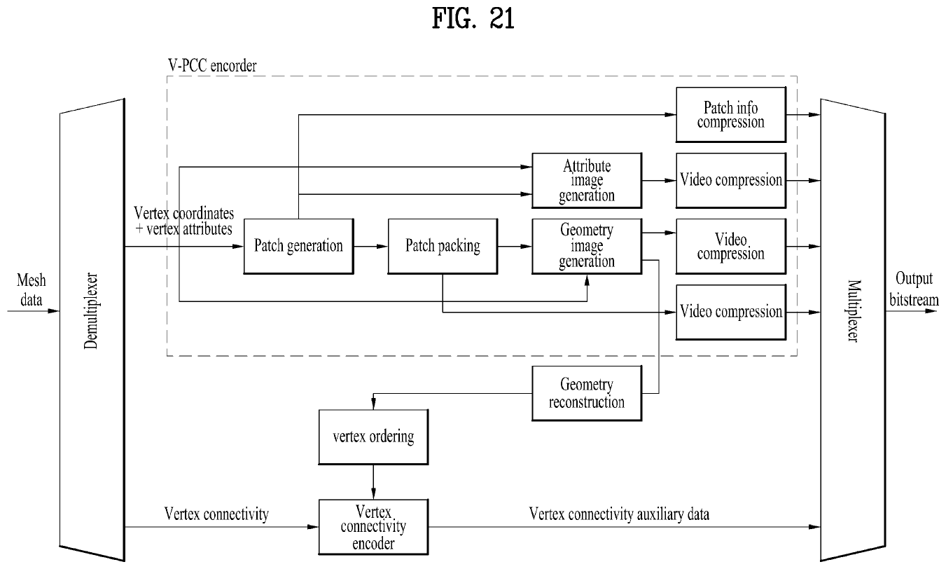

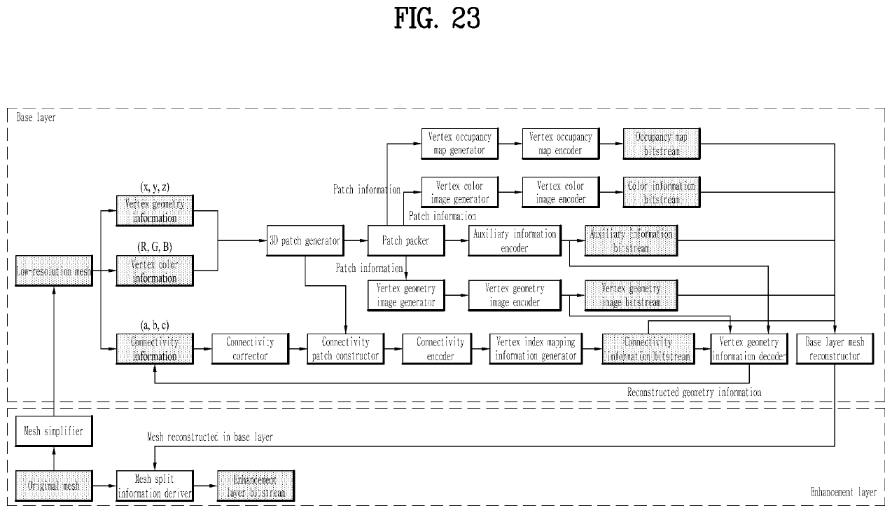

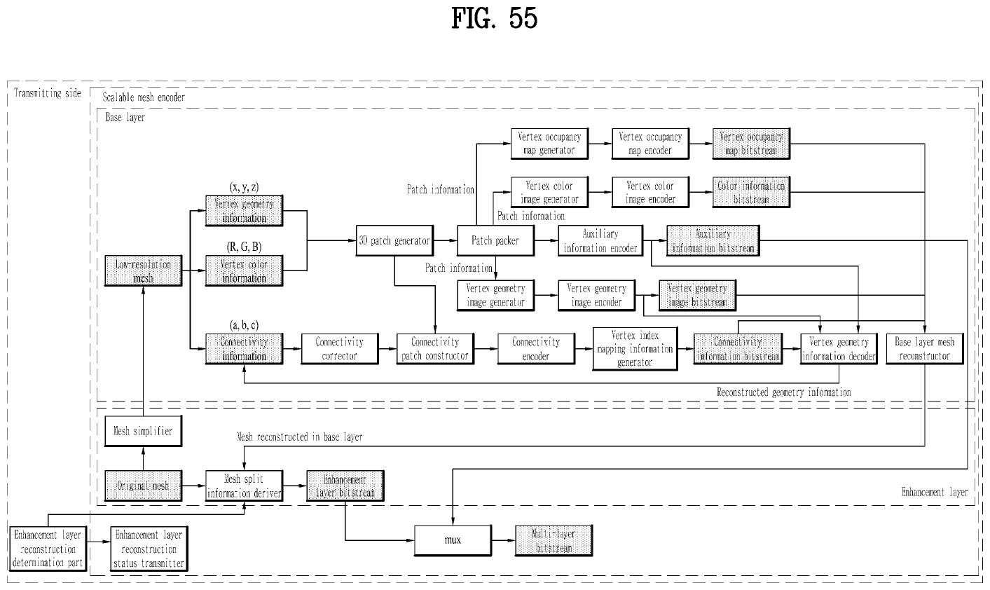

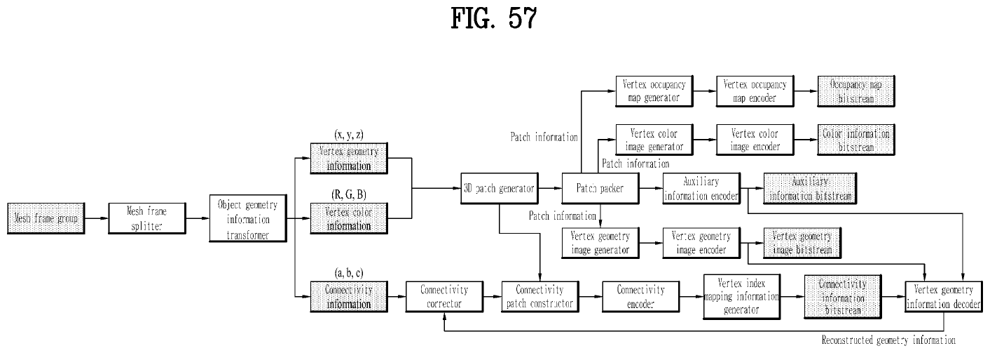

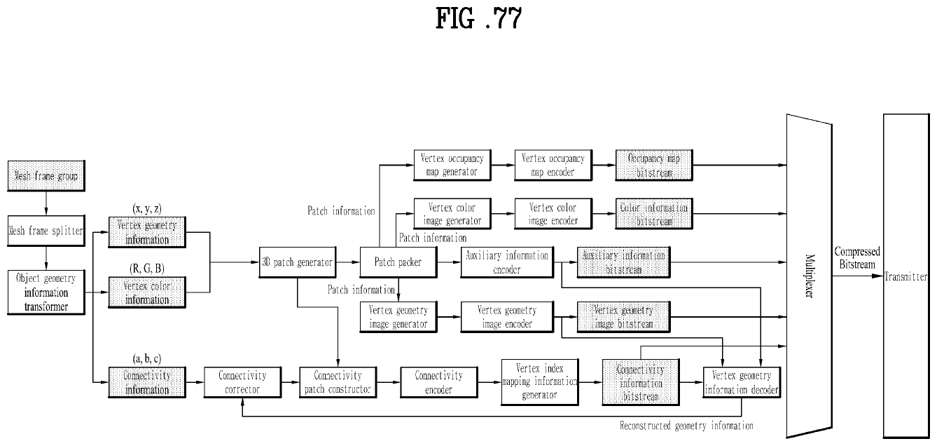

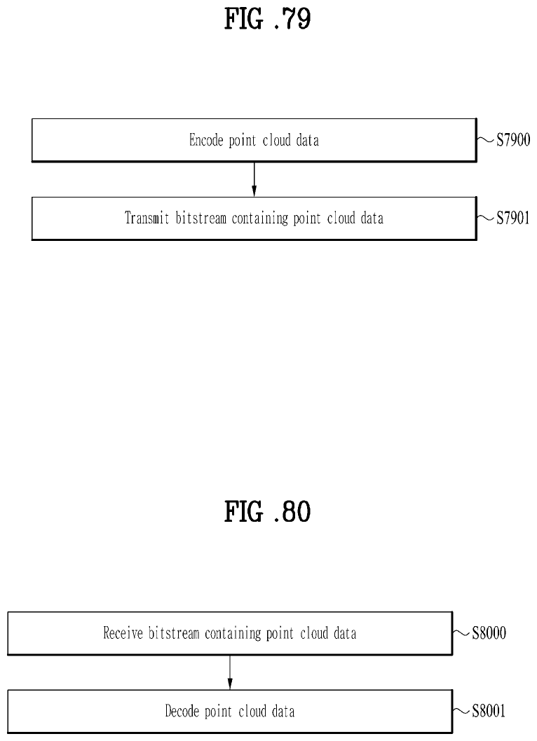

A point cloud data transmission device/method (hereinafter, transmission device/method) according to embodiments may correspond to the point cloud video encoder 1000, the point cloud video encoder 10002, the file/segment encapsulator 10003, the transmitter 10004 of FIG. 1, the encoder of FIG. 4, the encoder of FIG. 15, the transmission device of FIG. 18, the XR device 2030 of FIG. 20, the transmission device/method of FIG. 21, the transmission device/method of FIG. 23, the transmission device/method of FIG. 55, the transmission device/method of FIG. 57, the transmission device/method of FIG. 77, and/or the transmission device/method of FIG. 79. Further, the transmission device/method according to the embodiments may be configured by a connection or combination of some or all of the components of the embodiments described herein.

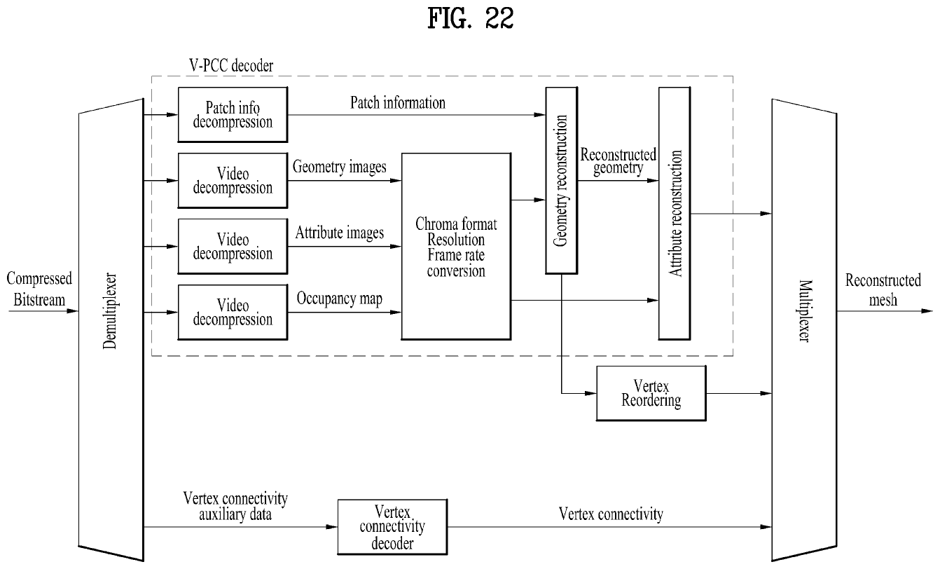

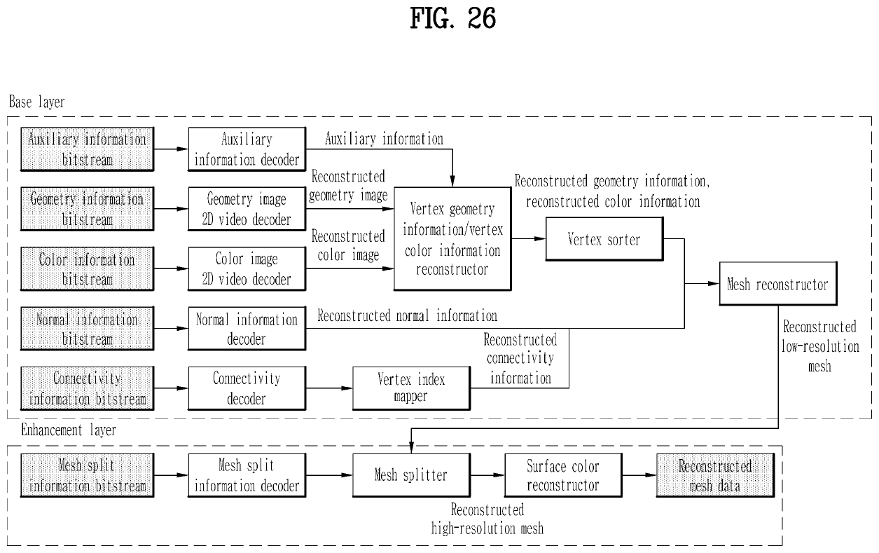

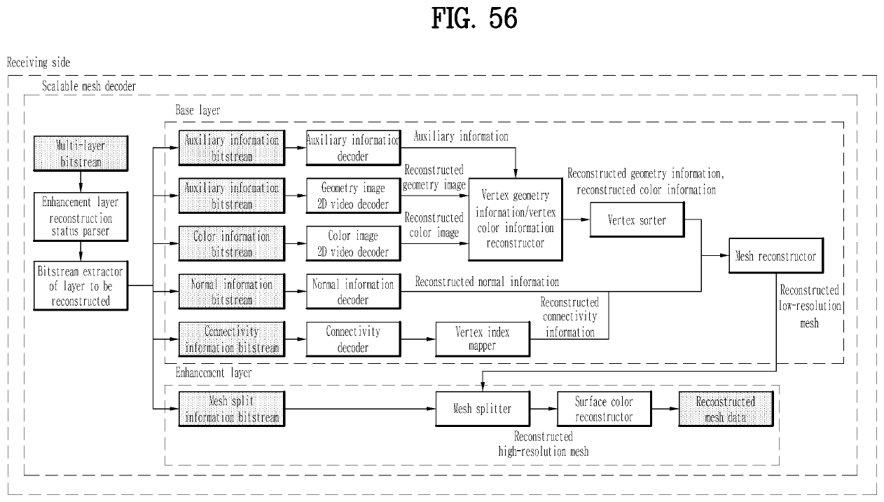

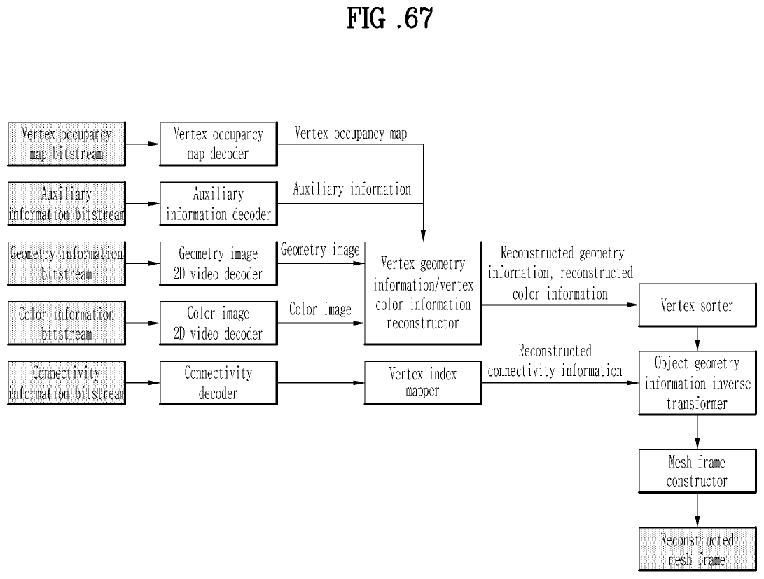

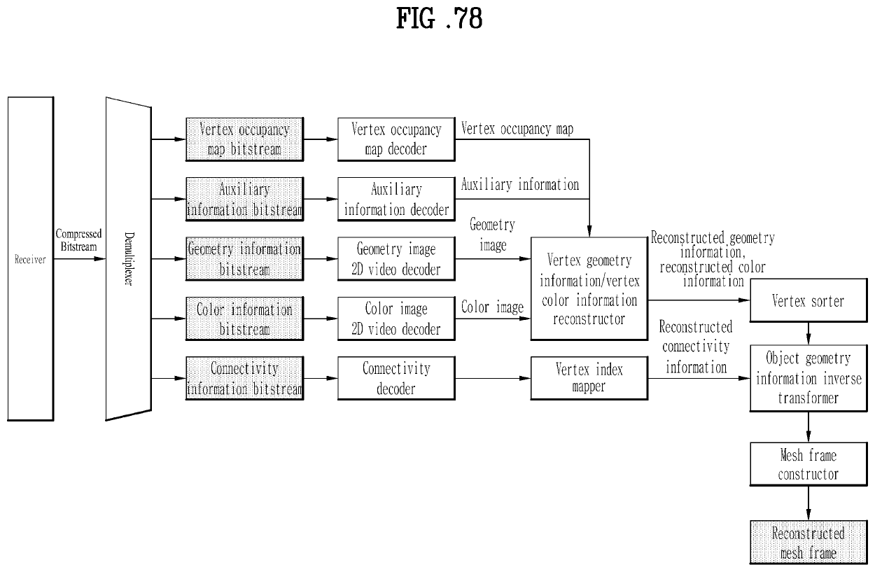

A point cloud data reception device/method (hereinafter, reception device/method) according to embodiments may correspond to the reception device 10005, the point cloud video decoder 10008, the file/segment decapsulator 10007, the receiver 10006 FIG. 1, the decoder of FIGS. 16 and 17, the reception device of FIG. 19, the XR device 2030 of FIG. 20, the reception device/method of FIG. 22, the reception device/method of FIG. 26, the reception device/method of FIG. 56, the reception device/method of FIG. 67, the reception device/method of FIG. 78, and/or the reception device/method of FIG. 80. Further, the reception device/method according to the embodiments may be configured by a connection or combination of some or all of the components of the embodiments described herein.

A method/device according to embodiments may include and perform mesh geometry data compression based on video encoding.

The method/device according to the embodiments relates to a mesh coding method/device that adds a separate encoder/decoder to the scheme of video-based point cloud compression (V-PCC), which is a method of compressing 3D point cloud data using a conventional 2D video codec, to encode/decode mesh information. Embodiments propose a structure in which mesh data is simplified to compress and reconstruct a low-resolution mesh at the base layer and the mesh is split at the enhancement layer to reconstruct a high-resolution mesh. Scalable transmission of the mesh may improve transmission efficiency by allowing applications that use a network bandwidth and mesh data to adjust data volume and quality to meet user requirements.

The method/device according to the embodiments proposes a structure and syntax and semantics information for splitting connectivity information in a frame into multiple connectivity patches and performing encoding/decoding on a patch-by-patch basis. The operations of a transmitter and receiver employing the same will be described.

FIG. 21 illustrates a transmission device/method according to embodiments.

FIG. 22 illustrates a reception device/method according to embodiments.

Referring to FIGS. 21 and 22, a separate encoder and decoder may be added to the existing V-PCC standard. The added encoder and decoder may encode and decode the vertex connectivity information related to the mesh information and transmit the same as a bitstream. The conventional mesh compression structure encodes the mesh frame input to the encoder into one bitstream according to the quantization rate. Therefore, regardless of the network situation or the resolution of the reception device when a pre-compressed mesh frame is to be transmitted, there is a limitation that the mesh frame with the bitrate (or image quality) determined by the encoding must be transmitted, or transcoding must be performed at the desired bitrate. In the case where the mesh frames are encoded and stored at multiple bitrates in order to variably adjust the transmission amount of the mesh frames, the memory capacity required for storage and the encoding time are greatly increased. A transmission/reception device according to embodiments includes a scalable mesh compression structure as a method for variably adjusting the transmission amount of encoded frames while minimizing the above-described disadvantages.

The device/method according to the embodiments includes a scalable mesh structure in which a low-resolution mesh is reconstructed in a base layer and an enhancement layer receives mesh split information to reconstruct a high-resolution mesh. Also, it may parse a mesh splitting method on a patch-by-patch basis, and may perform mesh splitting in a patch per triangle fan, triangle strip, or triangle.

As used herein, the term video-based point cloud compression (V-PCC) may have the same meaning as visual volumetric video-based coding (V3C). The two terms may be used interchangeably. Accordingly, in the present disclosure, the term V-PCC may be construed as V3C.

FIG. 23 illustrates a transmission device (or encoder)/method according to embodiments. The transmission device according to the embodiments may be referred to as an encoder or mesh data encoder. FIG. 23 illustrates components that the transmission device includes, and may illustrate a transmission method by showing the processing of data by each component.

Referring to FIG. 23, the base layer of the transmission device (or encoder) according to the embodiments may include a 3D patch generator, a patch packer, an auxiliary information encoder, a vertex occupancy map generator, a vertex color image generator, a vertex geometry image generator, a vertex occupancy map encoder, a vertex color image encoder, a vertex geometry image encoder, a connectivity corrector, a connectivity patch constructor, a connectivity encoder, a vertex index mapping information generator, a vertex geometry information decoder, and/or a mesh reconstructor. Further, the enhancement layer of the transmission device may include a mesh split information deriver and/or a mesh simplifier. The transmission device according to the embodiments may include components corresponding to the base layer or the enhancement layer together.

Referring to FIG. 23, a low-resolution mesh contains vertex geometry information, vertex color information, and connectivity information. The vertex geometry information may include X, Y, and Z values, and the vertex color information may include R, G, and B values. The connectivity information represents information about the connection relationship between vertices.

The 3D patch generator generates a 3D patch based on the vertex geometry and vertex color information. The connectivity patch constructor constructs a connectivity patch based on the connectivity information corrected by the connectivity corrector and the 3D patch. The connectivity patch is encoded by the connectivity encoder. The vertex index mapping information generator generates vertex index mapping information and generates a connectivity information bitstream.

The patch packer packs the 3D patch generated by the 3D patch generator. The patch packer generates patch information. The patch information may be used by the vertex occupancy map generator, the vertex color image generator, and the vertex geometry image generator. The vertex occupancy map generator generates a vertex occupancy map based on the patch information, and the generated vertex occupancy map is encoded by the vertex occupancy map encoder to configure an occupancy map bitstream. The vertex color image generator generates a vertex color image based on the patch information, and the generated vertex color image is encoded by the vertex color image encoder to configure a color information bitstream. The vertex geometry image generator generates a vertex geometry image based on the patch information, and the generated vertex geometry image is encoded by the vertex geometry image encoder to configure a geometry information bitstream. The auxiliary information may be encoded by the auxiliary information encoder to configure an auxiliary information bitstream.

The auxiliary information bitstream and the geometry information bitstream may be reconstructed by the vertex geometry decoder, and the reconstructed geometry information may be delivered to the connectivity corrector. A mesh is reconstructed from the occupancy map bitstream, color information bitstream, auxiliary information bitstream, geometry information bitstream, and connectivity information bitstream by the mesh reconstructor of the base layer. The reconstructed mesh may be delivered to the mesh split information deriver of the enhancement layer. The mesh split information deriver may split the mesh reconstructed in the base layer, compare the same with the original mesh, and derive split information for a splitting method that causes the smallest difference from the original mesh. The information generated by the mesh split information deriver may include an enhancement layer bitstream.

The transmission device according to the embodiments may simplify the original mesh input to the scalable mesh encoder and output a low-resolution mesh, as shown in FIG. 23. The low-resolution mesh may be processed through the existing compression operation in the base layer, and the base layer may derive split information for splitting the reconstructed low-resolution mesh into high-resolution meshes, and transmit the same in an enhancement layer bitstream. In this regard, it may be derived whether to split the reconstructed mesh on a per patch basis. When patch splitting is performed, the submesh type (triangle, triangle fan, triangle strip) that is the basic unit of splitting may be determined.

Referring to FIG. 23, the 3D patch generator may receive vertex geometry information, and/or vertex color information, and/or normal information, and/or connectivity information as input and perform splitting into multiple 3D patches based on the information. For each of the split 3D patches, an optimal projection plane may be determined based on the normal information and/or the color information.

The patch packer determines positions in the W×H image space where the patches determined by the 3D patch generator are to be packed without overlapping each other. According to an embodiment, the patches may be packed such that only one patch is present in the M×N space when the W×H image space is divided into M×N grids.

The auxiliary information encoder may encode a 3D reconstruction position (x0, y0, z0), and/or a patch index map in M×N units in the W×H image space based on a projection plane index determined per patch, and/or a 2D bounding box position (u0, v0, u1, v1) of the patch, and/or the bounding box of the patch.

The vertex geometry image generator generates a vertex geometry image by constructing a single channel image of the distance of each vertex to the plane onto which each vertex is projected, based on the patch information generated by the patch packer.

When the original mesh data has vertex color information, the vertex color image generator generates an image for the vertex color information about the projected patch.

The 2D video encoder may encode the images generated by the vertex geometry image generator and the vertex color image generator.

The vertex geometry decoder may reconstruct the encoded auxiliary information and geometry information to generate reconstructed vertex geometry information.

The vertex occupancy map generator may generate a map with a value of 1 for a pixel with a projected vertex and a value of 0 for an empty pixel based on the patch information generated by the patch packer.

The vertex occupancy map encoder may encode a binary image indicating whether a pixel has a projected vertex in the image space in which the patches determined by the patch packer are positioned. According to embodiments, the occupancy map binary image may be encoded by the 2D video encoder.

The connectivity corrector may correct the connectivity information with reference to the reconstructed vertex geometry information.

The connectivity patch constructor may split connectivity information into one or more connectivity patches using point partitioning information generated by the 3D patch generator in the process of partitioning the input points into one or more 3D vertex patches.

The connectivity encoder may encode the connectivity on a patch-by-patch basis.

The vertex index mapping information generator may generate information for mapping a vertex index of the connectivity information to a corresponding reconstructed vertex index.

The mesh simplifier of FIG. 23 may simplify the mesh input to the scalable mesh encoder and output a low-resolution mesh. The mesh simplification may be performed as follows.

In the transmission device according to the embodiments, the mesh simplifier may simplify the original mesh data and output low-resolution mesh data.

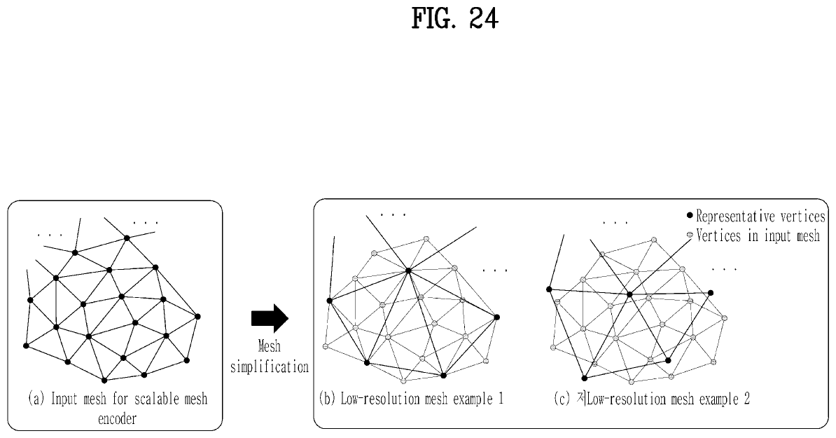

FIG. 24 illustrates an exemplary mesh simplification process according to embodiments.

The transmission device (or encoder) according to the embodiments may vertices in the input mesh (FIG. 24-(a)) may be grouped into multiple sets, and a representative vertex may be derived from each group. The representative vertex may be a specific vertex in the group (FIG. 24-(b)), or a new vertex generated by weighted summation of the geometry information about the vertices in the group (FIG. 24-(c)). The procedure of grouping and selecting a representative vertex in a group may be performed as follows.

The transmission device (or encoder) according to the embodiments may perform grouping may be performed such that the distance between centers in the groups is above a threshold and each group has a uniform shape. The threshold may be set to differ between a specific important region and an unimportant region specified by the encoder. The most centered vertex in each group may be selected as a representative vertex (FIG. 24-(b)), or the representative vertices may be derived by averaging all vertices in the group (FIG. 24-(c)).

After deleting all vertices other than the representative vertices, the transmission device/method according to the embodiments may newly define the connections between the representative vertices and generate a low-resolution mesh. The generated low-resolution mesh may be encoded in the base layer.

The transmission device/method according to the embodiments may group vertices, select or generate representative vertices per group, and connect the representative vertices to generate a low-resolution mesh.

In FIG. 23, the mesh split information deriver may derive splitting information for splitting the encoded and reconstructed low-resolution mesh in the base layer into a high-resolution mesh. The mesh split information may be derived in order to reduce the difference between the high-resolution mesh generated by splitting the reconstructed low-resolution mesh and the original mesh.

By referencing encoding and transmission status (is_enhancement_layer_coded) from a reconstruction determination part of the enhancement layer, the device/method according to embodiments may derive whether to split the mesh (split_mesh_flag) per patch of the reconstructed low-resolution mesh.

When splitting is performed on a patch, the submesh type (submesh_type_idx) and submesh split type (submesh_split_type_idx), which are the basic units for splitting, may be determined.

Information such as whether to split the mesh (split_mesh_flag), submesh type (submesh_type_idx), and submesh split type (submesh_split_type_idx) may be transmitted through the syntax of enhancement_layer_patch_information_data, or may be invoked in the form of a function on enhancement_layer_tile_data_unit.

To split a submesh, the transmission device/method according to the embodiments may add one or more vertices in the submesh and newly define the connections between the vertices. In splitting a submesh, the number of vertices added (split_num) or the split depth (split_depth) may be determined. To derive the geometry of the added vertices, the initial geometry of the added vertices may be derived by weighted summation of the geometry of the existing vertices, and the final geometry may be derived by summing the offset to the initial geometry. The offset may be determined for the purpose of reducing the difference between the high-resolution mesh generated by newly defining the connections between the added vertices and the existing vertices and the original mesh. The offset may be an offset value (delta_geometry_x, delta_geometry_y, delta_geometry_z) or an offset index (delta_geometry_idx) with respect to each of the x, y, and z axes. The offset may be an index of a combination of offsets on two or more of the x, y, or z axes. Information such as the number of vertices added when splitting the submesh (split_num), the depth of the split (split_depth), the offset values (delta_geometry_x, delta_geometry_y, delta_geometry_z), and the offset index (delta_geometry_idx) may be transmitted as signaling information through the syntax of submesh_split_data.

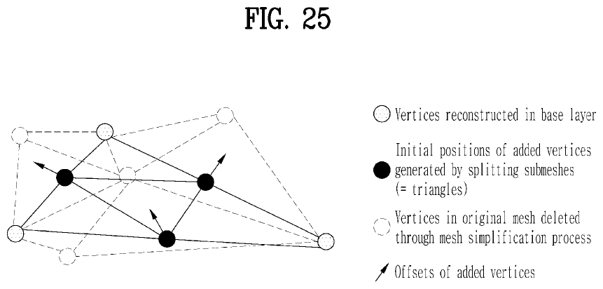

FIG. 25 illustrates initial positions and offsets of added vertices when a submesh is a triangle according to embodiments.

Referring to FIG. 25, the submesh is a triangle and the initial positions of the added vertices may be derived by splitting the centers of the triangle edges. The n original mesh vertices closest to the respective added vertices may be selected, and the offset may be the difference between the average geometry of the selected vertices and the geometry of the added vertices.

Referring to FIG. 25, added vertices may be generated based on the vertices of the low-resolution mesh reconstructed in the base layer, and the offset information about the added vertices may be derived.

FIG. 26 illustrates an exemplary reception device according to embodiments.

As shown in FIG. 26, the reception device according to the embodiments may reconstruct the surface color and reconstruct a high-resolution mesh based on the low-resolution mesh reconstructed in the base layer. The submesh splitting module of the mesh splitter may include a triangle fan vertex splitting method, a triangle fan edge method, a triangle splitting method, and a strip splitting method.

Referring to FIG. 26, the base layer of the reception device (or decoder) according to the embodiments may include an auxiliary information decoder, a geometry 2D video decoder, a color image 2D video decoder, a normal information decoder, a connectivity decoder, a vertex geometry information/color information decoder, a vertex index mapper, a vertex sorter, and/or a mesh reconstructor. Also, the enhancement layer of the reception device may include a mesh split information decoder, a mesh splitter, and/or a surface color reconstructor.

The auxiliary information bitstream is decoded by the auxiliary information decoder. The reconstructed auxiliary information is used for the vertex geometry information/vertex color information reconstructor to reconstruct geometry and color information. The geometry information bitstream is decoded by the geometry decoder, and the reconstructed geometry is used for the vertex geometry information/vertex color information reconstructor to reconstruct the geometry and color information. The color information bitstream is decoded by the color image decoder. The reconstructed color image is used for the vertex geometry information/vertex color information reconstructor to reconstruct the geometry and color information. The reconstructed geometry and color information are processed through the vertex sorter and used for the mesh reconstructor to reconstruct a low-resolution mesh.

The normal information bitstream is decoded by the normal information decoder. The reconstructed normal information is used for the mesh reconstructor to reconstruct the low-resolution mesh. The connectivity information bitstream is decoded by the connectivity decoder. The reconstructed connectivity information is used for the mesh reconstructor to reconstruct the low-resolution mesh.

The mesh split information bitstream (the enhancement layer bitstream in FIG. 23) is decoded by the mesh split information decoder, and the mesh split information is used for the mesh splitter to reconstruct the high-resolution mesh. The high-resolution mesh is processed into reconstructed mesh data through the surface color reconstructor.

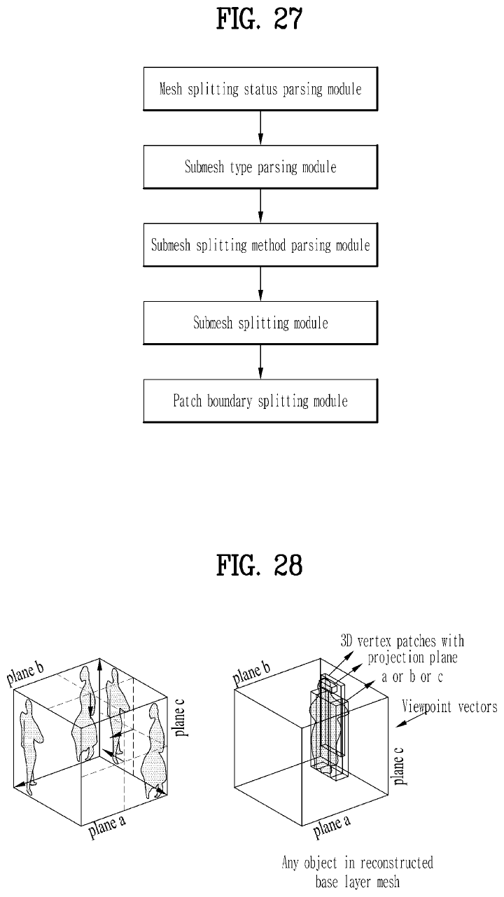

The mesh splitter of FIG. 26 may generate a high-resolution mesh by splitting the reconstructed low-resolution mesh into submeshes. The mesh splitter may be operated as shown in FIG. 27.

FIG. 27 illustrates an exemplary mesh splitter according to embodiments.

The mesh splitter (see FIG. 26) according to the embodiments may split the mesh data based on the mesh splitting method described with reference to FIGS. 27 to 49. That is, it may reconstruct high-resolution mesh data close to the original data from the simplified low-resolution mesh data. Then, vertices of the mesh data may be added and connections between the vertices may be created. Methods for adding vertices and creating connections will be described with reference to FIGS. 27 to 49.

Further, the mesh split information deriver (see FIG. 23) according to the embodiments may split the mesh data based on the mesh splitting method illustrated in FIGS. 27 to 49. The mesh split information deriver may split the simplified mesh data reconstructed in the base layer using various splitting methods, and derive signal information in relation to a splitting method that causes the smallest difference from the original mesh data.

FIG. 28 illustrates an example of an object and a 3D vertex patch in a mesh reconstructed in a base layer according to embodiments.

The mesh splitter according to the embodiments may include a mesh splitting status parsing module, a submesh type parsing module, a submesh splitting module, and a patch boundary splitting module. As shown in FIG. 27, the reception device/method may parse whether to split the mesh, parse the type of submeshes, parse the submesh splitting method, perform splitting into submeshes according to the method, and perform patch boundary splitting. The parsing operations may be reordered or some of the operations may be skipped.

In the mesh splitter, modules such as the mesh splitting status parsing module, the submesh type parsing module, the submesh splitting method module, and the patch boundary splitting module may be executed, and some of the modules may be omitted or the order of execution may be changed.

The mesh splitting status parsing module may parse or derive whether to split the mesh (split_mesh_flag) on a per object or 3D vertex patch basis. A 3D vertex patch may be a patch obtained by back-projecting a reconstructed 2D vertex patch (geometry information patch, color information patch, occupancy map patch) into 3D space based on atlas information. For example, split_mesh_flag may be parsed on a per 3D vertex patch basis. When split_mesh_flag indicates splitting, a subsequent splitting operation may be performed on the 3D vertex patch.
1) split_mesh_flag may be parsed or inferred on a per object basis.
2) split_mesh_flag may be parsed on a per 3D vertex patch basis. When mesh splitting is performed, the splitting method may be parsed on a per 3D vertex patch or per submesh in a 3D vertex patch.
3) Whether to split the mesh on the per 3D vertex patch basis may be inferred. A viewpoint vector index may be parsed from high-level information in the enhancement layer. The viewpoint vector index may be used to derive the 3D vertex patch index on which mesh splitting is to be performed. A viewpoint vector may be derived from the viewpoint vector index. The viewpoint vector may be a vector in 3D space of the reconstructed mesh in the base layer. Semantically, the viewpoint vector may be the user's viewpoint or a major viewpoint in the application where the reconstructed mesh is used. Mesh splitting may be performed on a 3D vertex patch when the normal vector to a plane (atlas) and the viewpoint vector in the 3D space into which the 3D vertex patch has been projected form an angle less than or equal to θ°.

The submesh type parsing module of FIG. 27 may parse the submesh type (submesh_type_idx) per mesh object or patch on mesh splitting is performed. A submesh may refer to the basic unit in which the splitting is performed. For example, when the submesh of any patch is a triangle fan, each triangle fan may be split by traversing multiple triangle fans in the patch. The syntax of submesh_type_idx may be an index representing a submesh type, and the submesh type corresponding to the index may be set. Submesh types may be triangle, triangle fan, and triangle strip.

The submesh splitting method parsing module of FIG. 27 may parse the submesh splitting method (submesh_split_type_idx) on a per mesh object or per patch basis. The unit of parsing of the submesh splitting method may be the same as or smaller than the unit of submesh type parsing. For example, when the submesh type is parsed on the per mesh object basis and is triangle fan, the triangle fan splitting method may be parsed per patch. The submesh_split_type_idx syntax may be an index indicating a submesh splitting method, and may be set to the submesh splitting method that corresponds to the index. When the submesh is a triangle fan, the triangle fan may be split using a triangle fan vertex splitting method, a triangle fan edge splitting method, or the like. When the submesh is a triangle, the triangle may be split using one of multiple triangle splitting methods. When the submesh is a triangle strip, a triangle splitting method may be used to split the triangles in the strip.

The submesh splitting module of FIG. 27 may traverse multiple submeshes in a mesh and split each submesh with a parsed splitting method. Splitting may be performed successively on all submeshes in any unit of mesh splitting status parsing or any unit of submesh type parsing. This operation may be performed in a specific order for every mesh splitting status parsing unit or any submesh type parsing unit in which splitting is performed.

Each of these syntaxes may be entropy decoded using Exponential Golomb, Variable Length Coding (VLC), Context-Adaptive Variable Length Coding (CAVLC), Context-Adaptive Binary Arithmetic Coding (CABAC), or the like.

The submesh splitting module of FIG. 27 may vary depending on the shape of the submesh and a splitting method for the same, as described below.

### 1) Triangle Fan Vertex Splitting (Submesh=Triangle Fan)

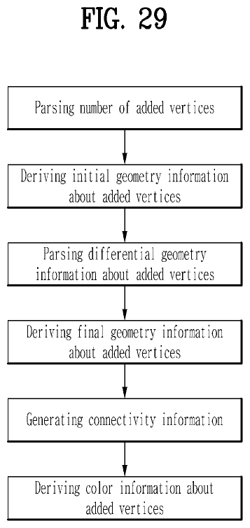

FIG. 29 illustrates a method of splitting triangle fan vertices according to embodiments.

The triangle fan vertex splitting method according to the embodiments may include parsing the number of added vertices, deriving initial geometry information about the added vertices, parsing the differential geometry information about the vertices, deriving final geometry information about the added vertices, generating connectivity information, and/or deriving color information about the added vertices. The order of the operations may be changed, and some of the operations may be skipped.

The triangle fan vertex splitting method according to the embodiments may include splitting a center vertex in a triangle fan into two or more vertices and splitting the triangle fan by correcting the connections between the vertices. After splitting the center vertex, the center vertex may or may not be deleted. The geometry information about the split vertices may be derived by parsing the number of vertices into the center vertex is to be split (split_num), the differential geometry index of each vertex generated by splitting (delta_geometry_idx, delta_geometry_x, delta_geometry_y, delta_geometry_z), and the like.

FIG. 30 illustrates an example of a method of splitting triangle fan vertices according to embodiments.

FIG. 30 illustrates an example of the result of splitting a triangle fan reconstructed in the base layer using the “triangle fan vertex splitting method.” FIG. 30-(b) may illustrate the result of splitting a center vertex (vertex 0) into two vertices (two vertices 0′) and removing the center vertex, and FIG. 30-(c) may illustrate the result of splitting the center vertex (vertex 0) into three vertices (three vertices 0′) and removing the center vertex. FIG. 30-(d) may illustrate the result of splitting the center vertex (vertex 0) into three vertices (three vertices 0′) and not removing the center vertex.

A “triangle fan” according to embodiments may represent a mesh shape formed in the shape of a fan with all triangles sharing a single vertex. In this case, the triangle fan vertex splitting method may include splitting a vertex shared by a plurality of triangles, correcting the connections between the vertices, and splitting a triangle fan.

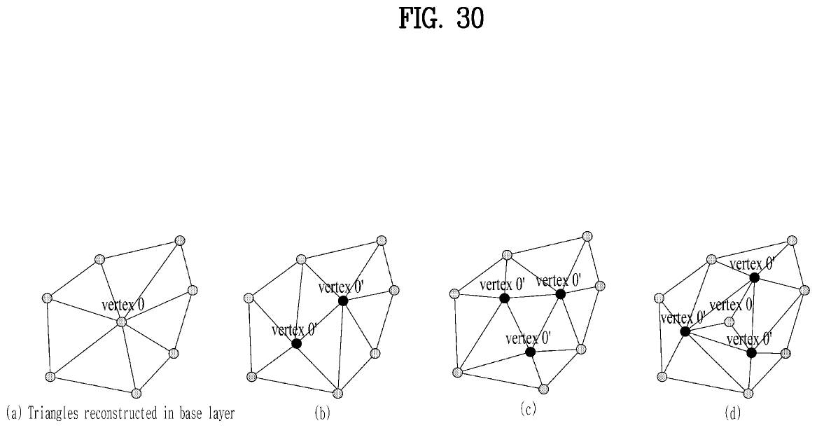

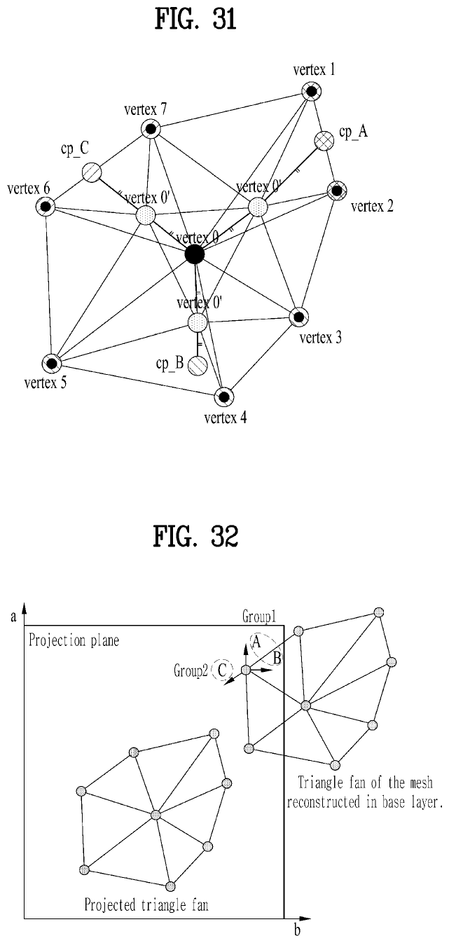

FIG. 31 illustrates an example of a method of splitting triangle fan vertices according to embodiments.

FIG. 31 may illustrate a method of deriving geometry information about vertices generated by splitting a triangle fan using the “triangle fan vertex splitting method.” In the operation of parsing the number of added vertices of FIG. 29, a value or index (split_num) indicating the number of vertices into which the center vertex is to be split may be parsed. When the index is parsed, the value corresponding to the index may be derived from a predefined table.

In the operation of deriving the initial geometry information about the added vertices in FIG. 29, a submesh may be split to derive the initial geometry information about the added vertices generated by the splitting. For example, when the value indicated by the split_num syntax is n, the initial geometry information about the n added vertices may be derived. In FIG. 29, (b) may show the result of deriving the initial geometry information about n added vertices (vertex 0′) when n=2, and (c) and (d) may show the results when n=3, respectively. The initial geometry information about the added vertices may be derived based on the geometry information about the base layer vertices as follows. The vertices at the boundary of the current triangle fan may be classified into N groups based on the geometry information, and the center vertices (cp_A, cp_B, and cp_C in FIG. 31) of the respective groups may be derived. The initial geometry information about each vertex 0′ may be the average of the geometry information about the center vertices of the respective groups and the geometry information about the center vertex of the current triangle fan. Alternatively, the initial geometry information about each vertex 0′ may be the average of the geometry information about the vertices in each group and the geometry information about the center vertex of the current triangle fan.

In the operation of parsing differential geometry information about the added vertices in FIG. 29, the differential geometry information to be added to the initial geometry information about the added vertices may be parsed. The differential geometry information may be values for the x, y, and z axes (delta_geometry_x, delta_geometry_y, and delta_geometry_z), or may be a bundle of differential geometry information for the three axes represented as an index (delta_geometry_idx). When the index is parsed, the geometry information values corresponding to the index may be derived from a predefined table.

In the operation of deriving the final geometry information about added vertices in FIG. 29, the final geometry information may be derived by summing the initial geometry information about the added vertices and the differential geometry information.

In the operation of generating connectivity information in FIG. 29, the existing connection of the base layer may be removed, and the connectivity between the base layer vertices and the added vertices may be newly defined.

In the operation of deriving the color information about the added vertices in FIG. 29, the color information about the added vertices may be derived based on the color information about the base layer vertices. For example, to derive the color information about the current added vertex, the color information about a specific number of base layer vertices adjacent to the current added vertex may be weighted and summed, wherein the weight may be inversely proportional to the distance from the current added vertex.

Alternatively, in the operation of deriving the initial geometry information about the added vertices in FIG. 29, the initial geometry information on some axes of the added vertices may be derived based on the geometry information in 3D space of the existing vertices reconstructed from the base layer, and the initial geometry information about the remaining axes may be derived with reference to the geometry image reconstructed from the base layer. FIG. 31 may show the result of the operations of FIG. 29. The process of FIG. 29 may be performed to derive initial geometry information about each added vertex (vertex 0′ in FIG. 31).

FIG. 32 illustrates an example of axes of a vertex included in groups 1 and 2 according to embodiments.

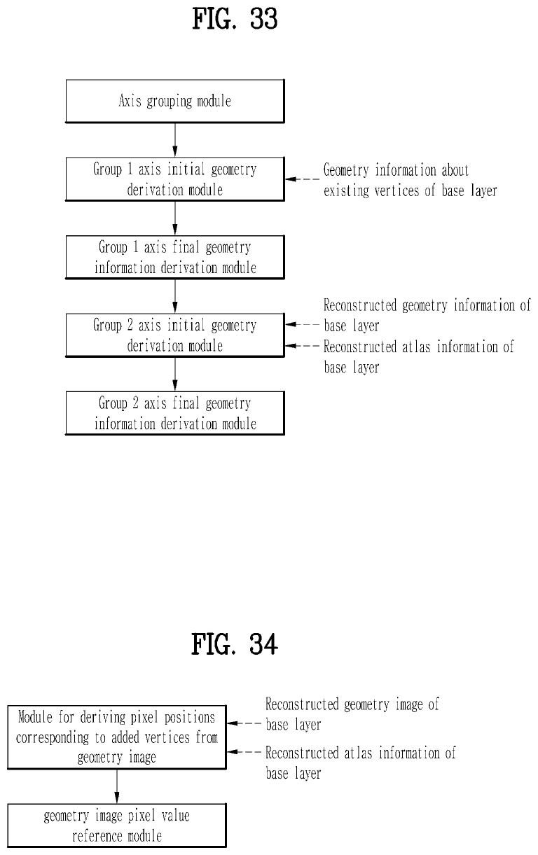

FIG. 33 illustrates the operations of deriving initial geometry information about added vertices and deriving final geometry information about added vertices in FIG. 29.

FIG. 34 illustrates operations of the “group 2 axis initial geometry derivation module” of FIG. 33.

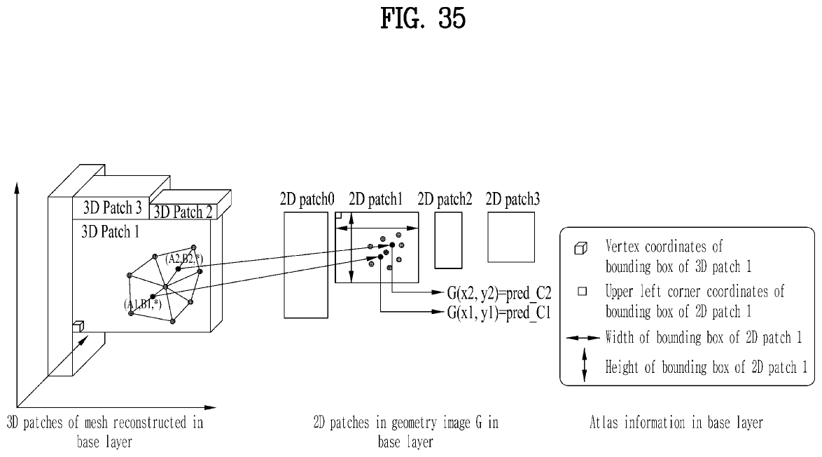

FIG. 35 illustrates a visualization of the operations of FIG. 34.

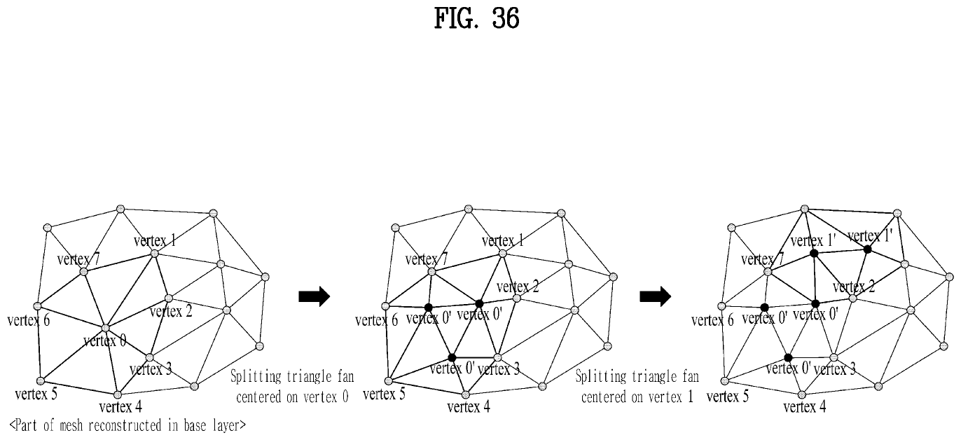

FIG. 36 illustrates an example of traversing multiple triangle fans in a reconstructed mesh and splitting each triangle fan with a “triangle fan vertex splitting method” according to embodiments.

The mesh splitter (FIG. 26) or mesh split information deriver (FIG. 23) according to the embodiments may split mesh data in any of the methods illustrated in FIGS. 32 to 36.

The axis grouping module of FIG. 33 may group the axes of the added vertex geometry information into multiple groups, wherein each group may have a different method of deriving the initial geometry information. For example, as shown in FIG. 32, the three axes of the geometry information, A, B, and C, may be grouped into groups 1 (A and B axes) and 2 (C axis). Among the axes, i axes may belong to group 1, and the remaining j axes may belong to group 2 (i+j=the total number of axes in the geometry information about the vertex). The axes included in group 1 may be the two axes parallel to the plane onto which the current triangle fan has been projected in the base layer, and the axis included in group 2 may be the axis perpendicular to the plane. The initial geometry information about the axes included in group 1 may be derived in a 3D domain based on the existing vertex geometry information, and the initial geometry information about the axis included in group 2 may be generated by referencing a geometry image reconstructed in the base layer.

The group 1 axis initial geometry derivation module of FIG. 33 may derive the initial geometry information about the axes included in group 1 (the A and B axes of FIG. 32) among the axes of the added vertex geometry information. The information may be derived by performing the following operations for the axes included in group 1 only. The vertices at the boundary of the current triangle fan in FIG. 31 may be classified into N groups based on the geometry information, and the center vertices of the respective groups (cp_A, cp_B, and cp_C in FIG. 31) may be derived. The initial geometry information about each added vertex (vertex 0′ in FIG. 31) may be the average of the geometry information about the center vertices of the respective groups and the geometry information about the center vertex of the current triangle fan. Alternatively, the initial geometry information about each added vertex (vertex 0′ in FIG. 31) may be the average of the geometry information about the vertices in each group and the geometry information about the center vertex of the current triangle fan.

The group 1 axis final geometry information derivation module of FIG. 33 may derive the final geometry by summing the residual geometry and the initial geometry information about the group 1 axes of the added vertices. The residual geometry information may be parsed as a value or an index. When parsed as an index, residual geometry information or a residual geometry information group corresponding to the index may be derived.

The group 2 axis initial geometry information derivation module of FIG. 33 may derive the initial geometry information about the axis included in group 2 (the C axis of FIG. 32) among the axes of the added vertex geometry information based on the corresponding pixel values in the geometry image. The derivation operation may be performed as illustrated in FIG. 34. A module for deriving pixel positions corresponding to added vertices from the geometry image and a geometry image pixel value correction module may be executed sequentially.

The module for deriving pixel positions corresponding to added vertices from the geometry image of FIG. 34 may derive pixel positions in the geometry image corresponding to the final geometry information about the axes of group 1 of added vertices based on atlas information. The atlas information may include information such as coordinates of the vertices of a bounding box of each 3D patch into which the mesh is split, and coordinates/width/height of the upper left corner of a bounding box of a 2D patch into which the 3D patch is projected as an image.

FIG. 35 may visualize the execution process, which may be performed as follows. A 2D patch corresponding to the 3D patch containing the current triangle fan may be derived from the geometry image recovered in the base layer. For the leftmost pixel coordinates, width, and height of the 2D patch corresponding to the 3D patch, the atlas information reconstructed in the base layer may be referenced, and the corresponding 2D patch may be derived from the geometry image based on the atlas information. Within the 3D patch, relative values of the axis values of added vertex group 1 (A1, A2, B1, and B2 in FIG. 35) with respect to the axes of group 1 (A and B axes in FIG. 35) may be derived, and pixels corresponding to the relative values may be derived in the 2D patch region. The derived pixels may be G (x1, y1) and G (x2, y2) in FIG. 35.

The geometry image pixel value reference module of FIG. 34 may specify group 2 axis initial geometry information by referencing the values (pred_C1, pred_C2) of the pixels (G (x1, y1) and G (x2, y2) of FIG. 35) derived by the previous module.

The group 2 axis final geometry information derivation module of FIG. 33 may derive the final geometry information by summing the residual geometry with the initial geometry about the group 2 axes of the added vertices. The residual geometry information may be parsed as a value or an index. When parsed as an index, residual geometry information or a residual geometry information group corresponding to the index may be derived.

FIG. 36 may illustrate an example of traversing vertices within a mesh reconstructed in the base layer and splitting a triangle fan centered on the vertices using the “triangle fan vertex splitting method.”

The mesh splitter according to embodiments may split the mesh data using the method as illustrated in FIG. 36.

Starting from any vertex within the mesh, all or some of the vertices may be traversed. The vertices traversed may be those reconstructed in the base layer, and the vertices generated by the splitting may not be traversed. The boundary vertices of the triangle fan centered on the traversed vertices may include vertices generated by the splitting.

The vertices may be traversed in the following order. The boundary vertices of the triangle fan currently being split may be stored in a stack in a specific order, and the operation of traversing a vertex stored last in the stack as a next traverse target may be recursively repeated until the stack becomes empty. Alternatively, the reconstructed mesh may be divided into multiple non-overlapping triangle fans and splitting may be performed on the triangle fans in parallel.

### 2) Triangle Fan Edge Splitting Method (Submesh=Triangle Fan)

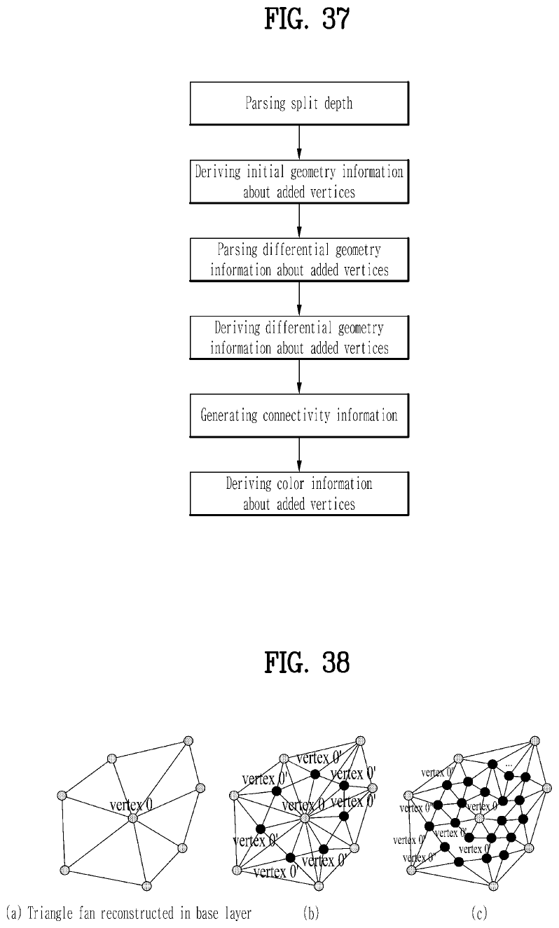

FIG. 37 illustrates the operations in a triangle fan edge splitting method according to embodiments.

The mesh splitter (FIG. 26) or the mesh split information deriver (FIG. 23) according to the embodiments may split mesh data using the methods as illustrated in FIGS. 37 to 49.

The triangle fan edge splitting method according to the embodiments may include parsing a split depth, deriving initial geometry information about added vertices, parsing differential geometry information about the added vertices, deriving final geometry information about the added vertices, generation connectivity information, and/or deriving color information about the added vertices. The order of the operations may be changed, or some of the operations may be skipped.

FIG. 38 illustrates an example of splitting using a triangle fan edge splitting method according to embodiments.

The triangle fan edge splitting method according to the embodiments may be carried out by the mesh split information deriver of FIG. 23 or the mesh splitter of FIG. 26.

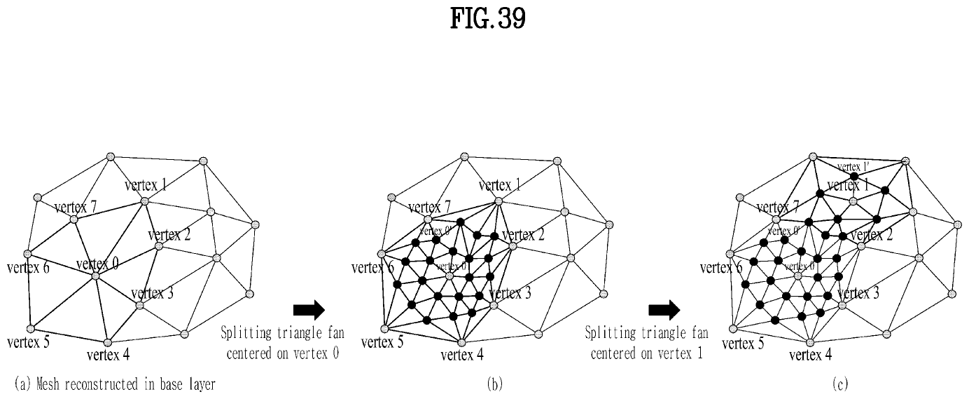

FIG. 39 illustrates an example of traversing multiple triangle fans in a reconstructed mesh and splitting each triangle fan with a triangle fan edge splitting method according to embodiments.

According to the “triangle fan edge splitting method,” new vertices may be added by splitting an edge between a center vertex and a boundary vertex of a triangle fan, and the triangle fan may be split by correcting connections between vertices. The operations may be performed as illustrated in FIG. 37. The geometry information about the vertices may be derived based on information obtained by parsing the split depth (split_depth) and the differential coordinates or indices (delta_geometry_idx, delta_geometry_x, delta_geometry_y, delta_geometry_z) of each vertex added by splitting.

FIG. 38 may be an example of splitting a reconstructed triangle fan using the “triangle fan edge splitting method,” where (a) may show an arbitrary triangle fan reconstructed ni the base layer, (b) may be an example of splitting a triangle fan by depth 1 using the “triangle fan edge splitting method,” and (c) may be an example of splitting a triangle fan by depth 2 using the “triangle fan edge splitting method.”

FIG. 38 may be an example of splitting a reconstructed triangle fan using the “triangle fan edge splitting method,” where (a) may show an arbitrary triangle fan reconstructed ni the base layer, (b) may be an example of splitting a triangle fan by depth 1 using the “triangle fan edge splitting method,” and (c) may be an example of splitting a triangle fan by depth 2 using the “triangle fan edge splitting method.”

Each of the operations in FIG. 37 may be performed as follows. In the operation of parsing a split depth in FIG. 37, the split depth index (split_depth) may be parsed to derive a depth value by which the current triangle fan is to be split. The operation of splitting the submesh may be repeated as many times as the depth value indicated by split_depth in the operation of deriving initial geometry information about added vertices in FIG. 37. In the operation of deriving initial geometry information about added vertices in FIG. 37, the submesh may be split to derive the initial geometry information about the added vertices generated by the splitting. When split_depth is n, the initial geometry information about the added vertices corresponding to depths 1 to n of the current submesh may be derived. For example, initial geometry information about vertices corresponding to depth 1 may be derived based on the base layer vertices of the current submesh, initial geometry information about depth 2 may be derived based on the base layer vertices and the vertices at depth 1. This process may be repeated until the initial geometry information about depth n is generated. The initial geometry information about the added vertices to be added to depth n may be a weighted average of the geometry information about two neighboring vertices a depth n−1 and the geometry information about a vertex in the base layer, or a weighted average of the geometry information about a vertex at depth n and two neighboring vertices in the base layer. For example, as shown in (b) of FIG. 38, the initial geometry information about a vertex (vertex 0′) to be generated in the depth 1 splitting process may be derived by weighted summation of the geometry information about the center vertex (vertex 0) of the triangle fan and the geometry information about two neighboring vertices at the boundary. For example, as shown in (c) of FIG. 38, the initial geometry information about a vertex (vertex 0″) to be generated during the depth 2 splitting process may be derived by weighted averaging of the geometry information about two neighboring vertices at the base layer boundary and a vertex at depth 1, or by weighted averaging of the geometry information about a vertex in the base layer boundary and two neighboring vertices at depth 1. Depending on the total split_depth of the current triangle fan, the weights to use in the weighted averaging in generating vertices at each depth may be defined. For example, when split_depth=1, the weights for generating added vertices of depth 1 may be 1:1:1. For example, when split_depth=2, the weights for generating added vertices of depth 1 may be 2 (for the center of the submesh): 1 (for boundary vertices): 1 (for boundary vertices), and the weights for generating added vertices of depth 2 may be 1:1:1.

In the operation of parsing differential geometry information about added vertices in FIG. 37, the differential geometry information to be added to the initial geometry information about the added vertices may be parsed. The differential geometry information may be values for the x, y, and z axes (delta_geometry_x, delta_geometry_y, and delta_geometry_z), or may be a bundle of differential geometry information for the three axes represented as an index (delta_geometry_idx). When the index is parsed, the geometry information values corresponding to the index may be derived from a predefined table.

In the operation of deriving the final geometry information about added vertices in FIG. 37, the final geometry information may be derived by summing the initial geometry information about the added vertices and the differential geometry information.

In the operation of generating connectivity information in FIG. 37, the existing connection of the base layer may be removed, and the connectivity between the base layer vertices and the added vertices may be newly defined.

In the operation of deriving the color information about the added vertices in FIG. 37, the color information about the added vertices may be derived based on the color information about the base layer vertices. For example, to derive the color information about the current added vertex, the color information about a specific number of base layer vertices adjacent to the current added vertex may be weighted and summed, wherein the weight may be inversely proportional to the distance from the current added vertex.

FIG. 39 may be an example of traversing vertices within a mesh reconstructed in the base layer and splitting a triangle fan centered on the vertices using the “triangle fan edge splitting method.”

Starting from any vertex within the mesh, all or some of the vertices may be traversed. The vertices traversed may be those reconstructed in the base layer, and the vertices generated by the splitting may not be traversed. The boundary vertices of the triangle fan centered on the traversed vertices may include vertices generated by the splitting.

The vertices may be traversed in the following order. The boundary vertices of the triangle fan currently being split may be stored in a stack in a specific order, and a vertex stored last in the stack may be traversed as a next traverse target. These operations may be repeated until the stack becomes empty. Alternatively, the reconstructed mesh may be divided into multiple non-overlapping triangle fans and splitting may be performed on the triangle fans in parallel.

### 3) Triangle Splitting (Submesh=Triangle)

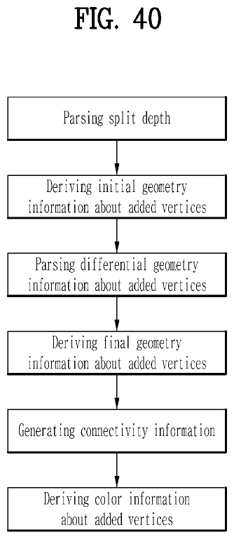

FIG. 40 illustrates a triangle splitting operation according to embodiments.

The triangle splitting method according to the embodiments may be carried out by the mesh split information deriver of FIG. 23 or the mesh splitter of FIG. 26.

The triangle splitting method according to the embodiments may include parsing a split depth, deriving initial geometry information about added vertices, deriving differential geometry information about the added vertices, deriving final geometry information about the added vertices, generation connectivity information, and/or deriving color information about the added vertices. The order of the operations may be changed, and some of the operations may be skipped.

The triangle splitting method may include splitting a triangle in the reconstructed mesh into multiple triangles and may be carried in a process as illustrated in FIG. 40. The triangles may be split according to triangle splitting methods 1, 2, 3, 4, etc. The splitting method for each triangle may be parsed on a triangle-by-triangle, patch-by-patch, or frame-by-frame basis. Splitting methods 1, 2, 3, and 4 may be expressed as a first splitting method, a second splitting method, a third splitting method, and a fourth splitting method, respectively.

### Triangle Splitting Method 1

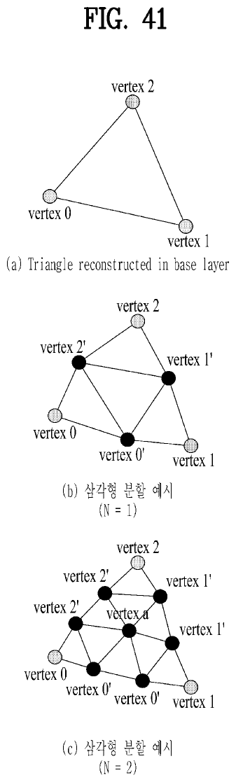

FIG. 41 illustrates triangle splitting method 1 according to embodiments.

In triangle splitting method 1, N vertices may be added to each edge of the triangle and edges connecting the added vertices may be generated to split the triangle. FIG. 41 may illustrate an example of splitting a triangle when N=1 in (b) and N=2 in (c).

In the split depth or number parsing operation of FIG. 40, the number of vertices to add to each edge of the triangle (split_num) may be parsed. split_num may indicate the number or number index of the added vertices. When it indicates the index, a value mapped to the index may be derived from a predefined table.

In the operation of deriving the initial geometry information about the vertices in FIG. 40, the initial geometry information about the N vertices indicated by split_num for each edge and the vertices inside the triangle may be derived. The initial geometry information about the added edge vertices (vertex 0′, vertex 1′, and vertex 2′ in FIG. 41) may be N pieces of geometry information that are evenly spaced between the two vertices of the base layer that are the end vertices of each edge. When the vertices added to each edge are connected, an added vertex (vertex a) may be generated at the intersection of the vertices.

In the operation of parsing differential geometry information about added vertices in FIG. 40, the differential geometry information to be added to the initial geometry information about the added vertices may be parsed. The differential geometry information may be values for the x, y, and z axes (delta_geometry_x, delta_geometry_y, and delta_geometry_z), or may be a bundle of differential geometry information for the three axes represented as an index (delta_geometry_idx). When the index is parsed, the geometry information values corresponding to the index may be derived from a predefined table.

In the operation of deriving the final geometry information about added vertices in FIG. 40, the final geometry information may be derived by summing the initial geometry information about the added vertices and the differential geometry information.

In the operation of generating connectivity information in FIG. 40, the existing connection of the base layer may be removed, and the connectivity between the base layer vertices and the added vertices may be newly defined.

In the operation of deriving the color information about the added vertices in FIG. 40, the color information about the added vertices may be derived based on the color information about the base layer vertices. For example, to derive the color information about the current added vertex, the color information about a specific number of base layer vertices adjacent to the current added vertex may be weighted and summed, wherein the weight may be inversely proportional to the distance from the current added vertex.

### Triangle Splitting Method 2

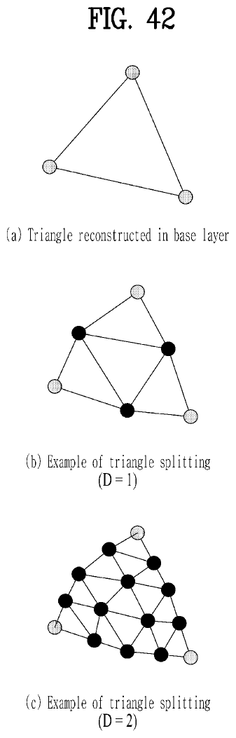

FIG. 42 illustrates triangle splitting method 2 according to embodiments.

In triangle splitting method 2, a triangle may be recursively split as many times as a split depth. In FIG. 42, (b) shows the result of splitting of (a) when D=1, and (c) shows the result of the splitting when D=2. In the operation of deriving initial geometry information about added vertices in FIG. 40, splitting the submesh may be repeated as many times as the depth value indicated by split_depth.

In the operation of deriving initial geometry information about added vertices in FIG. 40, the initial geometry information about added vertices corresponding to depths 1 to D of the current submesh may be derived as much as the value of D indicated by split_depth. For example, the initial geometry information about the vertices corresponding to depth 1 may be derived based on the vertices of the base layer of the current submesh, and the initial geometry information about depth 2 may be derived based on the vertices of the base layer and the vertices of depth 1. This process may be repeated until the initial geometry information about depth D is generated. The initial geometry generation method may be carried out as follows. Each edge of the triangle reconstructed in the base layer may be split at the center to derive the initial geometry information about the added vertices at depth 1. FIG. 42-(b) may show four triangles configured by the added vertices generated at depth 1, base layer vertices, and added vertices. Starting at depth 2, the initial geometry information about the added vertices may be derived by splitting the centers of the edges of all currently existing triangles. In the operation of parsing differential geometry information about added vertices in FIG. 40, the differential geometry information to be added to the initial geometry information about the added vertices may be parsed. The differential geometry information may be values for the x, y, and z axes (delta_geometry_x, delta_geometry_y, and delta_geometry_z), or may be a bundle of differential geometry information for the three axes represented as an index (delta_geometry_idx). When the index is parsed, the geometry information values corresponding to the index may be derived from a predefined table.

In the operation of deriving the final geometry information about added vertices in FIG. 40, the final geometry information may be derived by summing the initial geometry information about the added vertices and the differential geometry information.

In the operation of generating connectivity information in FIG. 40, the existing connection of the base layer may be removed, and the connectivity between the base layer vertices and the added vertices may be newly defined.

In the operation of deriving the color information about the added vertices in FIG. 40, the color information about the added vertices may be derived based on the color information about the base layer vertices. For example, to derive the color information about the current added vertex, the color information about a specific number of base layer vertices adjacent to the current added vertex may be weighted and summed, wherein the weight may be inversely proportional to the distance from the current added vertex.

### Triangle Splitting Method 3

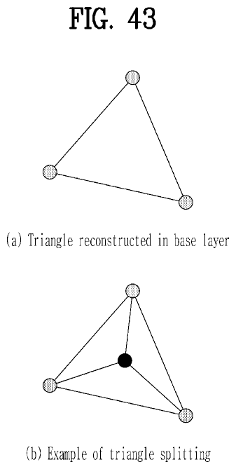

FIG. 43 illustrates triangle splitting method 3 according to embodiments.

Triangle splitting method 3 may add vertices inside the triangle by weighted averaging of the three vertices of the triangle. In FIG. 43, (b) may be the results obtained by deriving the center positions of the three existing vertices in (a) and generating vertices by adding the parsed or derived residual geometry information to the derived positions. The split depth or number parsing operation of FIG. 39 may be skipped. In the operation of deriving the initial geometry information about the added vertices in FIG. 40, the initial geometry information about the added vertices may be derived by weighted averaging of the three vertices of the triangle. The weights used in the weighted averaging may be fixed to a specific value, or may be derived by parsing weight indexes. In the operation of deriving the final geometry information about the added vertices in FIG. 40, the final geometry information may be derived by adding the offsets (delta_geometry_idx, delta_geometry_x, delta_geometry_y, delta_geometry_z) to the initial geometry information about the added vertices.

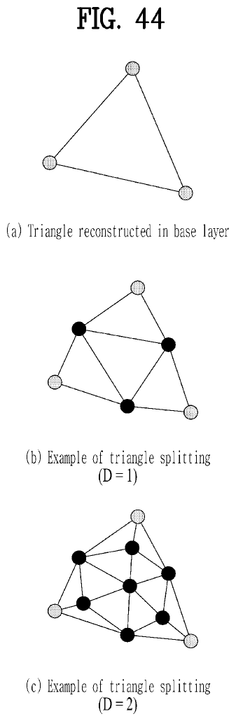

FIG. 44 illustrates triangle splitting method 4 according to embodiments.

In triangle splitting method 4, the total split depth is D, and a different splitting method may be used for splitting at each depth. The split depth or the splitting method at each split depth may be parsed, or a combination of splitting methods may be parsed. Alternatively, the splitting method may be derived in a predetermined way without parsing. In FIG. 44, (b) may be the result of carrying out “triangle splitting method 1” in (a) when D=1, and (c) may be the result of carrying out “triangle splitting method 3” after carrying out “triangle splitting method 1” in (a) when D=2.

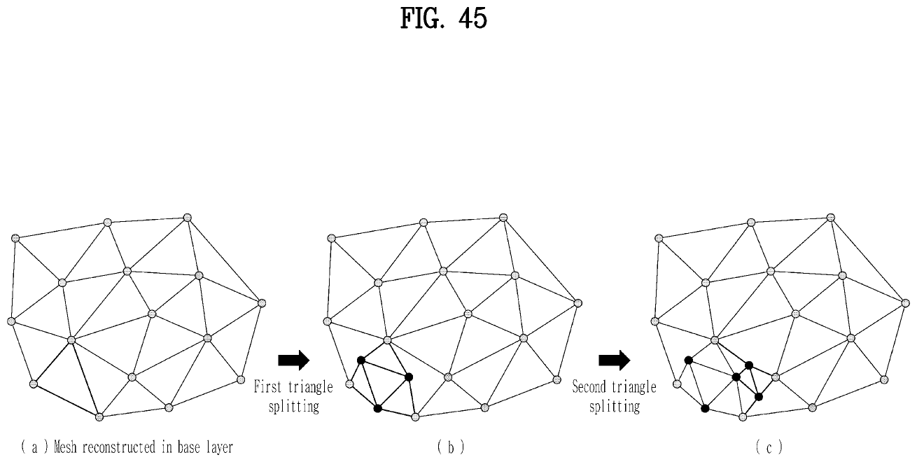

FIG. 45 illustrates an example of traversing multiple triangles in a reconstructed mesh and splitting each triangle with triangle splitting method 2 according to embodiments.

FIG. 45 may be an example of traversing triangles in the mesh reconstructed in the base layer and splitting the triangles using “triangle splitting method 2 (D=1).”

Starting from any triangle in the mesh, all or some triangles may be traversed, and the triangles traversed may be the triangles reconstructed in the base layer, and the triangles generated by the splitting may not be traversed.

### 4) Strip Splitting Method (Submesh=Triangle Strip)

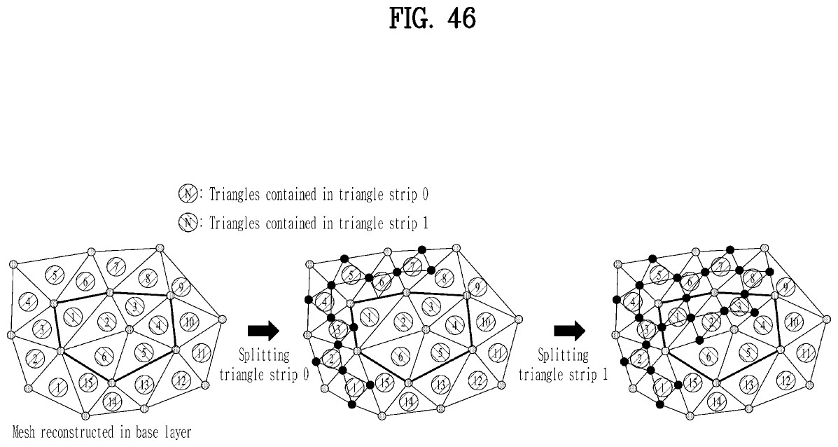

A triangle strip according to the embodiments represents multiple triangles connected like a strip. In FIG. 46, the triangles constituting the center region form a triangle strip, and the triangles constituting the outer region also form a triangle strip.

According to the strip splitting method, the mesh reconstructed in the base layer may be split into triangle strips. In the case where the reconstructed mesh has been reconstructed on a per triangle strip basis, the splitting may be performed in the order of the reconstructed triangle strips. Alternatively, the reconstructed mesh may be divided into triangle strips by performing a separate addition operation, and the splitting may be performed by traversing the triangle strips in a separate order.

The splitting method may be parsed for each triangle strip or each group of triangle strips. The splitting method may be splitting triangles in a triangle strip, and may be triangle splitting method 1, 2, 3, or 4 described above, or another method.

After completing the splitting of each triangle strip, two or more adjacent triangles from different strips may be merged or may be merged and then split.

FIG. 46 illustrates an example of traversing multiple triangles in a reconstructed mesh and splitting each triangle with an edge splitting method according to embodiments. The figure may illustrate an example of traversing one or more triangle strips in a reconstructed mesh object or patch and splitting the same with an edge splitting method.

FIG. 47 illustrates operations of the patch boundary splitting module of FIG. 27.

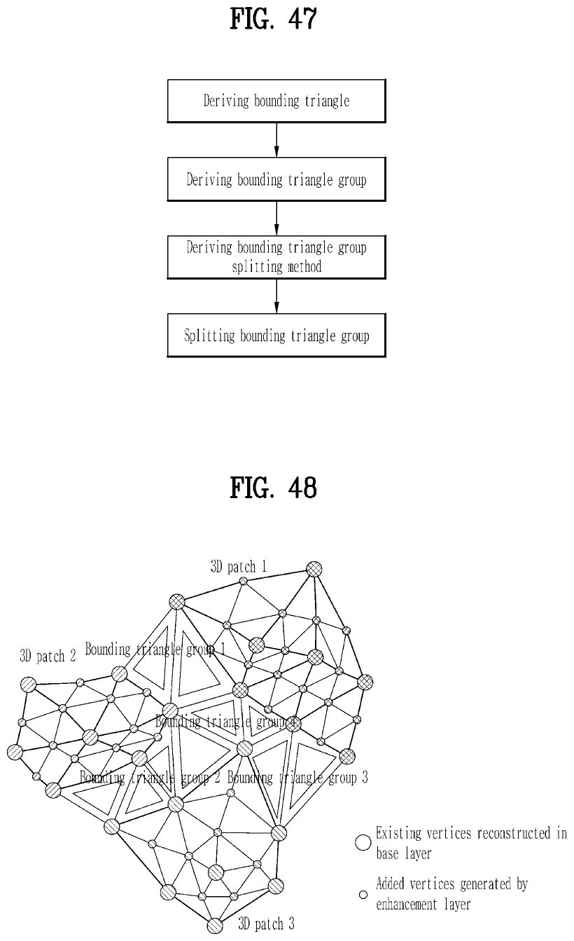

FIG. 48 illustrates an example of bounding triangle groups according to embodiments.

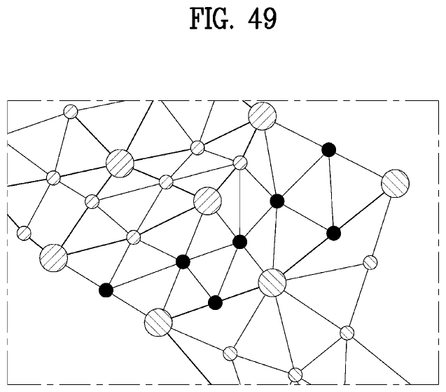

FIG. 49 illustrates a result of splitting bounding triangle group 2 according to embodiments.

The patch boundary splitting module of FIG. 27 may split a bounding triangle including boundary vertices of two or more patches. The operations may be performed in the same order as in FIG. 47.

In the operation of deriving a bounding triangle in FIG. 47, a bounding triangle may be derived by connecting the base layer vertices from adjacent 3D patches. The three vertices of the bounding triangle may belong to different 3D patches, or two of the vertices may belong to the same 3D patch. The operation of deriving a bounding triangle may be performed as follows. Two adjacent boundary vertices may be selected within any 3D patch, and the vertex that is closest to the selected two vertices may be selected from among the boundary vertices of a 3D patch adjacent to the current 3D patch, thereby deriving a single bounding triangle The next bounding triangle may be derived that shares one edge with the derived bounding triangle and contains the vertex closest to the edge. This process may be repeatedly performed until all bounding triangles are derived.

In the operation of deriving a bounding triangle group in FIG. 47, the bounding triangles of the current mesh object may be grouped into one or more bounding triangle groups. A bounding triangle group may be a group of bounding triangles that have the same combination of indexes of the 3D patches containing the vertices of the bounding triangles. FIG. 48 may illustrate an example of bounding triangle groups. A bounding triangle group may include a single bounding triangle (bounding triangle group 4 in FIG. 48), or multiple bounding triangles in the form of triangle strips (e.g., bounding triangle groups 1, 2, and 3 in FIG. 48). Boundary triangle group 1 of FIG. 48 may include the boundary vertices of 3D patch 1 and 3D patch 2, and bounding triangle group 2 may include the boundary vertices of 3D patch 2 and 3D patch 3. Boundary triangle group 3 may include the boundary vertices of 3D patch 1 and 3D patch 3, and bounding triangle group 4 may include the boundary vertices of 3D patch 1, 3D patch 2, and 3D patch 3.

In the operation of deriving a bounding triangle group splitting method in FIG. 47, a triangle-by-triangle splitting method may be derived for each bounding triangle group.

A splitting method index may be parsed per bounding triangle group, and a splitting method may be derived from the index. The splitting method may be one of the triangle splitting methods.

A specific predefined splitting method may be inferred for every bounding triangle group.

The splitting method may be derived by determining a specific condition on a per-bounding triangle group basis. The splitting method may be determined based on the number of vertices included in a triangle in the bounding triangle group. For example, when any triangle in a bounding triangle group includes four vertices, the splitting method may be triangle splitting method 1, 2, or 4. For example, when every triangle in a bounding triangle group includes 3 vertices, the splitting method may be triangle splitting method 3.

In the operation of splitting the bounding triangle group in FIG. 47, the bounding triangle group may be split by the splitting method derived for each bounding triangle group in the previous operation. FIG. 49 may illustrate the result of splitting bounding triangle group 2 in FIG. 48 using triangle splitting method 1.

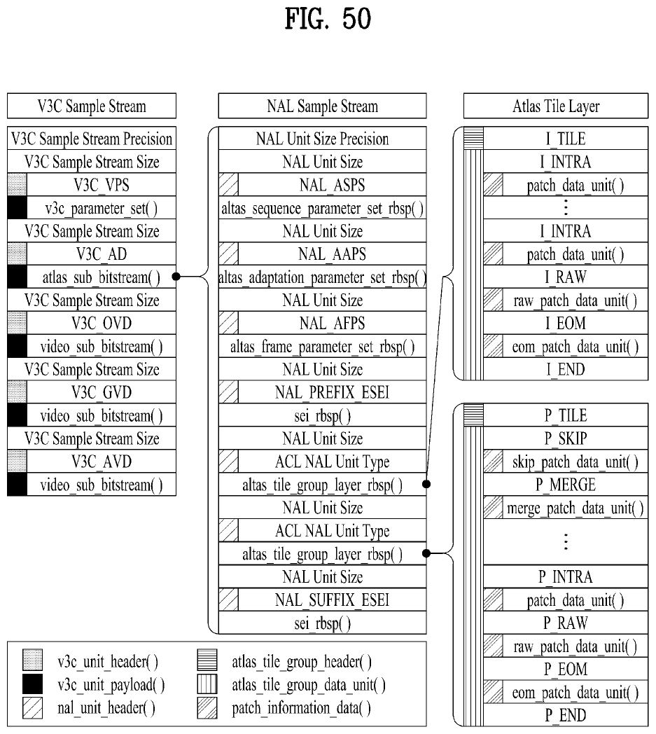

FIG. 50 illustrates a bitstream according to embodiments.

A point cloud data transmission method/device according to embodiments may compress (encode) point cloud data and generate related parameter information to generate and transmit a bitstream as shown in FIG. 50.

A point cloud data reception method/device according to embodiments may receive a bitstream and decode point cloud data contained in the bitstream based on parameter information contained in the bitstream.

In the point cloud data transmission device according to the embodiments, the signaling information (which may be referred to as parameters/metadata, etc.) may be encoded by a metadata encoding device (which may be referred to as a metadata encoder, etc.) and transmitted in the bitstream. Further, in the point cloud data reception device according to the embodiments, it may be decoded by a metadata decoding device (which may be referred to as a metadata decoder or the like) and provided to a process of decoding the point cloud data.

The transmission device/method according to the embodiments may encode the point cloud data to generate a bitstream.

The bitstream according to the embodiments may contain V3C units.

The reception device/method according to the embodiments may receive a bitstream transmitted by the transmission device, and decode and reconstruct the point cloud data. Hereinafter, a specific syntax of the V3C unit and the elements included in the V3C unit according to embodiments are described.

The transmission device/method according to the embodiments may transmit a syntax related to whether to perform and transmit enhancement layer encoding to perform scalable mesh encoding/decoding, mesh split information per tile reconstructed in the base layer, mesh split information per patch, and mesh split information transmitted per submesh in a patch.

FIG. 51 shows the syntax of v3c_parameter_set according to embodiments. is_enhancement_layer_coded may indicate whether the current frame or sequence is to be subjected to the enhancement layer encoding and transmitted.

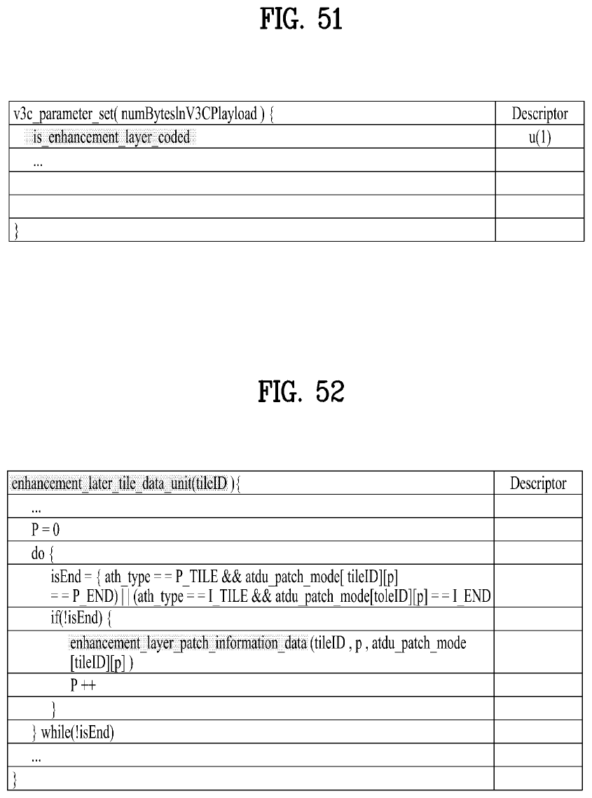

FIG. 52 shows the syntax of enhancement_layer_tile_data_unit according to embodiments.
ath_type may indicate the coding type (P_TILE, I_TILE) of an atlas tile.
atdu_patch_mode [tileID][p] may indicate the patch mode of an atlas tile data unit.

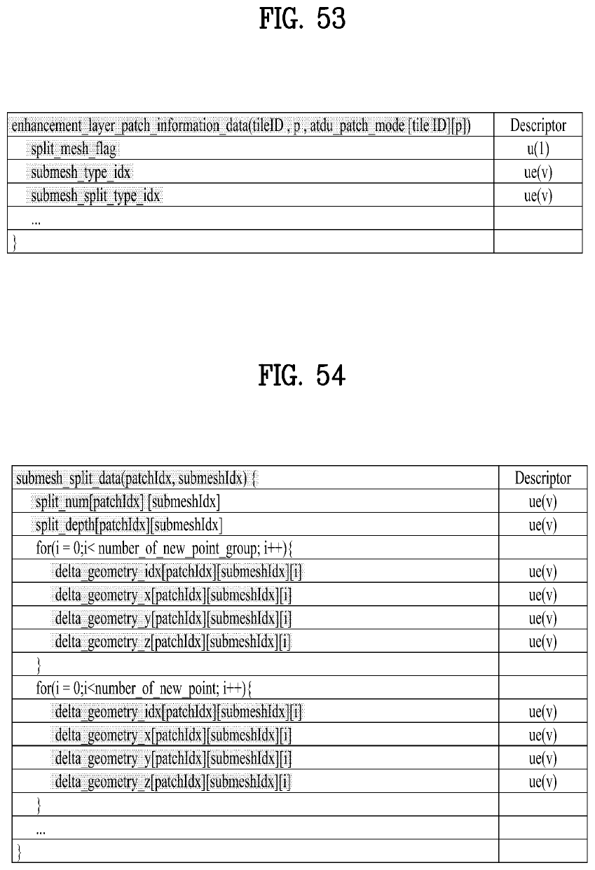

FIG. 53 shows the syntax of enhancement_layer_patch_information_data according to embodiments.
split_mesh_flag may indicate whether the mesh in the current patch is split.
submesh_type_idx may indicate the submesh type index of the current patch.
submesh_split_type_idx may indicate the submesh split type index of the current patch.

FIG. 54 shows the syntax of submesh_split_data according to embodiments.
split_num [patchIdx][submeshIdx] may indicate the number of vertices added when a submesh is split.
split_depth [patchIdx][submeshIdx] may indicate the depth of the submesh split.
delta_geometry_idx [patchIdx][submeshIdx][i] may indicate the geometry offset index of the added vertex.
delta_geometry_x [patchIdx][submeshIdx][i] may indicate the x-axis geometry offset of the added vertex.
delta_geometry_y [patchIdx][submeshIdx][i] may indicate the y-axis geometry offset of the added vertex.
delta_geometry_z [patchIdx][submeshIdx][i] may indicate the z-axis geometry offset of the added vertex.
Table 1—(x, y, z) delta values for delta_geometry_idx
delta_geometry_idx (x, y, z) delta
0 (1, 0, 0)
1 (−1, 0, 0)
2 (0, 1, 0)

FIG. 55 illustrates a transmission device/method according to embodiments.

Referring to FIG. 55, the transmission device/method according to the embodiments may further include an enhancement layer reconstruction status determination part and/or an enhancement layer reconstruction status transmitter. By referencing encoding and transmission status (is_enhancement_layer_coded), the enhancement layer reconstruction determination part may derive whether to split the reconstructed low-resolution mesh into patches (split_mesh_flag). The enhancement layer reconstruction status transmitter may transmit the derived information.

Based on the network situation between the transmitting and receiving sides, the environment of the receiving end (such as the computation/memory performance of the reception device), or the consumption setting at the receiving end (such as the resolution setting of the content consumption application), the transmission device/method according to the embodiments may determine whether the decoder is to reconstruct the enhancement layer for the current frame or sequence.

When the reconstruction status is determined to be TRUE, the enhancement layer may be mandatorily encoded and transmitted by the encoder. When the reconstruction status is determined to be FALSE, the enhancement layer may or may not be encoded and transmitted by the encoder. Whether the enhancement layer is encoded and transmitted (is_enhancement_layer_coded) may be transmitted in v3c_parameter_set, a parameter set that is transmitted on a per sequence or frame basis.

The original 3D mesh data input to the transmitter according to the embodiments is simplified to a low-resolution mesh, and is subdivided into basic units called patches based on a reference including characteristics information about the mesh of the points through the V-PCC encoding process. The patches are then appropriately patch-packed into 2D image regions. For the arrangement of the patches in the 2D image, the depth information and texture information about the patches are compressed and transmitted to the vertex occupancy map generator of FIG. 55 in the vertex geometry image and vertex color image, respectively. The vertex occupancy map image, vertex geometry image, and vertex color image may have different resolutions, and may be compressed in different ways using different video codecs. The connectivity information is encoded by a separate encoder and transmitted in a bitstream along with the result of compression of the existing vertex occupancy map image, vertex geometry image, and vertex color image. The mesh split information deriver of the enhancement layer may derive mesh split information for the purpose of reducing the difference of a high-resolution mesh generated by splitting the reconstructed mesh in the base layer from the original mesh. Then, the mesh split information (enhancement_layer_tile_data_unit) syntax is transmitted per tile reconstructed in the base layer, and the per-patch mesh split information function (enhancement_layer_patch_information_data) is performed in the same patch order as when parsing the atlas information about the patches in the base layer. A tile described above may be a unit of parallel decoding when the vertex occupancy map, vertex color image, and vertex geometry image are decoded. Tiles may have a rectangular shape generated by splitting the image along the width and height directions. Multiple 2D patches may be present in a tile, and the region of a 2D patch may be included in a tile.

In the per-patch split information syntax, data may be transmitted that derives information such as whether the reconstructed low-resolution mesh is subjected to mesh splitting on a per-patch basis (split_mesh_flag), the submesh type of the current patch (submesh_type_idx), and the submesh split type (submesh_split_type_idx).

In addition, to split a submesh, one or more vertices may be added in the submesh and the connectivity between the vertices may be newly defined. In splitting a submesh, the number of vertices added (split_num) or the split depth (split_depth) may be determined. Also, the offset values on the x, y, and z axes (delta_geometry_x, delta_geometry_y, delta_geometry_z) or an offset index (delta_geometry_idx) may be determined in order to reduce the difference of the high-resolution mesh generated by newly defining the connections between the added vertices and the existing vertices from the original mesh. Then, the syntax of mesh split information (Submesh_split_data) may be transmitted per submesh in the patch.

The enhancement layer bitstream containing the mesh split information may be transmitted to the multiplexer and transmitted to the receiver through the transmitter as a single bitstream along with the compressed bitstreams in the base layer.

FIG. 56 illustrates a reception device/method according to embodiments.

The reception device/method according to the embodiments may further include an enhancement layer reconstruction status parser and a bitstream extractor of a layer to be reconstructed.

The reception device/method according to the embodiments may parse is_enhancement_layer_coded in v3c_parameter_set from the received multi-layer bitstream to determine whether the enhancement layer is to be reconstructed in the current frame or sequence. Then, the bitstream be demultiplexed to auxiliary information, geometry information, color information, normal information, connectivity information, and mesh split information bitstreams by a demultiplexer. According to the semantics of the syntax of Is_enhancemet_layer_coded, when there is no enhancement layer information transmitted or decoded, the mesh reconstructed by the mesh reconstructor of the base layer becomes the final reconstructed mesh data; when the enhancement layer information is transmitted and decoded, the reconstructed low-resolution mesh is transmitted to the mesh splitter and the operation of reconstructing a high-resolution mesh is performed.

At the base layer, vertex geometry information and vertex color information may be reconstructed based on the vertex occupancy map, auxiliary information, geometry image, color image, normal information, and connectivity information. Reconstructed low-resolution mesh data may be acquired based on the reconstructed geometry information, color information, normal information, and reconstructed connectivity information.

When a high-resolution mesh is reconstructed, the mesh splitter reconstructs a high-resolution mesh from the low-resolution mesh reconstructed in the base layer by referencing the decoded mesh split information.

The mesh splitting status parsing module (see FIG. 27) of the mesh splitter (see FIG. 23) may perform mesh splitting on a per frame basis or a per 3D vertex patch basis by referencing split_mesh_flag in the enhancement_layer_patch_information_data function. The submesh type parsing module of the mesh splitter may set the type of submesh (triangle, triangle fan, triangle strip, etc.) by referencing submesh_type_idx. In addition, the submesh splitting method parsing module may set a triangle splitting method (triangle fan vertex/edge splitting, triangle splitting, etc.) according to the submesh by referencing submesh_split_type_idx.

The reconstructed low-resolution mesh is split according to the submesh type and submesh splitting method set as described above, and each submesh splitting module performs submesh splitting by parsing the submesh_split_data ( ) function and referencing the mesh split information transmitted per submesh in the patch.

In parsing the number of added vertices by the submesh splitting module, a value or index (split_num) indicating the number of vertices to split the center vertex into may be parsed. Here, when split_num is parsed as an index, the value corresponding to the index may be derived from a predefined table.

Also, depending on the submesh splitting method, added vertex initial geometry information may be derived based on the split depth information about how many times the submesh splitting is performed, through the split_depth information instead of split_num.

In parsing added vertex differential geometry information by the submesh splitting module, the differential geometry information about the added vertices may be obtained as offset values for the x, y, and z axes by referencing delta_geometry_x, delta_geometry_y, and delta_geometry_z. Alternatively, the bundle of the differential geometry information about the three axes may be represented as an index (delta_geomtery_idx).

The final geometry information may be derived by summing the differential geometry information with the previously derived initial geometry information about the added vertices. Then, by reconfiguring the connectivity information with the final geometry information and deriving the color information about the added vertices based on the base layer color information, the submesh splitting is completed. Final mesh data may be reconstructed from the high-resolution mesh obtained by the splitting, through a surface color reconstruction operation.

A conventional mesh compression structure encodes the mesh frame input to the encoder into one bitstream according to the quantization rate. Therefore, there is a limitation that when a pre-compressed mesh frame is to be transmitted, the mesh frame having a bitrate (or image quality) determined by the encoding should be transmitted or transcoded to a desired bitrate for transmission, regardless of the network situation or the resolution of the reception device. In addition, when the mesh frame is encoded at multiple bitrates and stored in order to variably adjust the transmission amount of the mesh frame, the memory capacity required for storage and the encoding time are greatly increased. Therefore, the present disclosure may provide a scalable mesh compression structure in which a low-resolution mesh is reconstructed at a base layer and a high-resolution mesh is reconstructed by receiving split information at the enhancement layer, as a method to variably adjust the transmission amount of the encoded frame while minimizing the above-described disadvantages.

As the scalable transmission structure of the mesh is proposed, the transmission/reception device/method according to embodiments may adjust the data transmission amount and image quality according to the network bandwidth and user requirements for transmission. In addition, a streaming service with a constant frame rate (fps) may be provided by variably adjusting the bitrate per frame even in a situation where the network environment is unstable.

The transmission/reception device/method according to embodiments may encode/decode the mesh data on a frame-by-frame basis, and may encode/decode, on an object-by-object basis, content containing multiple objects in one frame. By independently performing the encoding on the object-by-object basis, a function to perform parallel processing, subjective image quality control, selective transmission, and the like on an object-by-object basis may be provided. Furthermore, the mesh video may be effectively compressed for objects that have large inter-frame duplication in the mesh video.

The transmission/reception device/method according to the embodiments relates to mesh coding, in which a separate encoder/decoder is added to a Video-based Point Cloud Compression (V-PCC) method, which is a method for compressing 3D point cloud data using a 2D video codec, to encode/decode mesh information. The added encoder and decoder each encode and decode vertex connectivity information in the mesh information and transmit a bitstream. The transmission/reception device/method according to the embodiments may reconstruct the mesh on a per object basis in a frame in performing encoding/decoding based on mesh coding, and proposes syntax and semantics information related thereto.

In the conventional mesh compression structure, only a mesh frame consisting of a single object is considered as an input to the encoder, and the encoding is performed by packing the input mesh frame into a single 2D frame. Even when a mesh frame containing multiple objects and covering a large space is input to the encoder, it is still packed into a single 2D frame and encoding is performed. As a result, with the conventional mesh compression structure, it is difficult to adjust quality or perform transmission on a per local region or object basis. The transmission/reception device/method according to the embodiments proposes a structure in which 2D frames are configured on an object-by-object basis to perform encoding/decoding, and proposes a technique for referencing a mesh component on an object-by-object basis or patch-by-patch basis to improve encoding efficiency.

The transmission/reception device/method according to the embodiments may reconstruct mesh data on an object-by-object basis in a frame rather than on a frame-by-frame basis. Further, in the object-by-object decoding procedure, components such as atlas information, geometry information, and color information may be predicted from the reconstructed frame on an object-by-object basis or patch-by-patch basis.

As used herein, the term video-based point cloud compression (V-PCC) may have the same meaning as visual volumetric video-based coding (V3C). The two terms may be used interchangeably. Accordingly, in the present disclosure, the term V-PCC may be construed as V3C.

A point cloud data transmission device/method (hereinafter, transmission device/method) according to embodiments may correspond to the transmission device 1000, the point cloud video encoder 10002, the file/segment encapsulator 10003, the transmitter 10004 of FIG. 1, the encoder of FIG. 4, the encoder of FIG. 15, the transmission device of FIG. 18, the XR device 2030 of FIG. 20, the transmission device/method of FIG. 21, the transmission device/method of FIG. 23, the transmission device/method of FIG. 55, the transmission device/method of FIG. 57, the transmission device/method of FIG. 77, and/or the transmission device/method of FIG. 79. Further, the transmission device/method according to the embodiments may be configured by a connection or combination of some or all of the components of the embodiments described herein.

A point cloud data reception device/method according to embodiments (hereinafter referred to as reception device/method) may correspond to the reception device 10005, the point cloud video decoder 10008, the file/segment decapsulator 10007, the receiver 10006 of FIG. 1, the decoder of FIGS. 16 and 17, the reception device of FIG. 19, the XR device 2030 of FIG. 20, the reception device/method of FIG. 22, the reception device/method of FIG. 26, the reception device/method of FIG. 56, the reception device/method of FIG. 67, the reception device/method of FIG. 78, and/or the reception device/method of FIG. 80. Further, the reception device/method according to the embodiments may be configured by a connection or combination of some or all of the components of the embodiments described herein.

FIG. 57 illustrates a transmission device/method according to embodiments.

Referring to FIG. 57, the transmission device according to the embodiments may include a mesh frame splitter, an object geometry information transformer, a 3D patch generator, a patch packer, an auxiliary information encoder, a vertex occupancy map generator, a vertex color image generator, a vertex geometry image generator, a vertex occupancy map encoder, a vertex color image encoder, a vertex geometry image encoder, a connectivity corrector, a connectivity patch constructor, a connectivity encoder, a vertex index mapping information generator, and/or a vertex geometry information decoder.

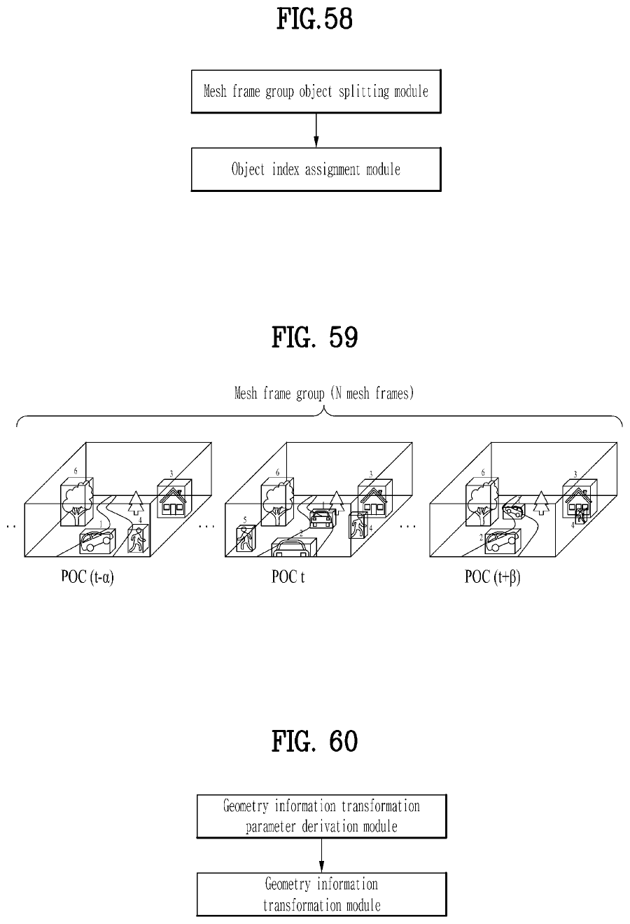

FIG. 58 illustrates elements or operations of the mesh frame splitter of FIG. 57.

The mesh frame splitter according to the embodiments may include a mesh frame group object splitting module and an object index assignment module.

Referring to FIG. 57, the mesh frame splitter may split a mesh frame in a mesh frame group into objects. This operation may be performed as shown in FIG. 58. Referring to FIG. 58, the mesh frame group object splitting module may perform object splitting on a frame-by-frame basis or may perform the object splitting with reference to other frames in the frame group. The object index assignment module of FIG. 58 may assign indexes to objects, and may assign the same index to the same object in each frame.

FIG. 59 illustrates an example of objects specified as a mesh frame group according to embodiments. Referring to FIG. 59, it is shown that objects are partitioned for n mesh frames in a mesh frame group, and each object is assigned an index. In each mesh frame, the same object may be assigned the same index.

In FIG. 59, POC (t−α), POC (t), and POC (t+α) represent mesh frames included in the mesh frame group. FIG. 59 shows that objects such as a car, a person, a tree, and a house included in each mesh frame are assigned indexes. The same index number may be assigned to the same object.

Signaling: The transmission device/method according to the embodiments may transmit information about the objects to be transmitted in Frame_object_info on a frame-by-frame basis. Frame_object_info may include the number of objects included in the frame (num_object), an index of each object (idx_object), and position information (X_global_offset, Y_global_offset, Z_global_offset) about each object in the frame.

FIG. 60 illustrates elements or operations of the geometry information transformer of FIG. 57.

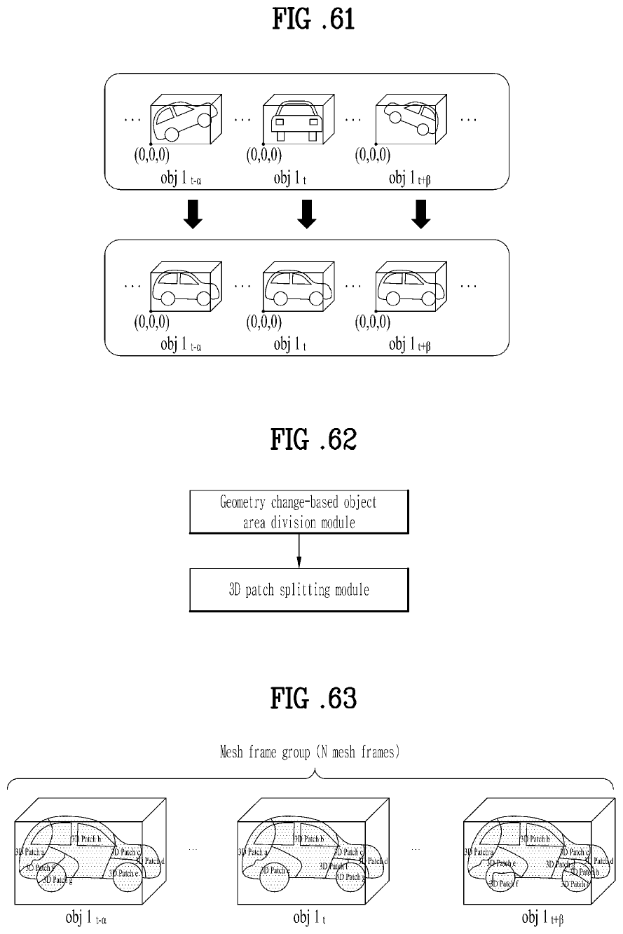

FIG. 61 illustrates geometry information transformation according to embodiments.

The object geometry information transformer of FIG. 57 may perform geometry information transformation on one or more objects having the same index in a mesh frame group based on a common axis. The geometry information transformer according to the embodiments may perform the geometry information transformation as shown in FIG. 60.

The geometry information transformation parameter derivation module of FIG. 60 may derive new axes of the objects and derive transformation parameters for transforming to the new axes. The origin of the new axes may be a specific position with respect to the object, and the direction of each axis may be a specific direction with respect to the object. Transformation parameters may be derived to transform the existing geometry information about the object to the new axes.

The geometry information transformation module of FIG. 60 may transform the geometry information based on the derived geometry information transformation parameters. FIG. 61 is an example of a result of geometry information transformation performed on object 1.

FIG. 62 illustrates elements or operations of the 3D patch generator of FIG. 57.

FIG. 63 illustrates an example of the result of generating a 3D patch of object 1 in a mesh frame according to embodiments.

The 3D patch generator of FIG. 57 may receive as input one or more objects having the same index in a mesh frame group and may split each object into 3D patches. In the operation of splitting into 3D patches, a projection plane for each 3D patch may be determined. The operation may be performed as shown in FIG. 62.

The geometry change-based object area division module of FIG. 62 may compare the input pieces of geometry information about the objects with each other may divide the area of each object into an area with a change in geometry information and an area without a change in geometry information within a mesh frame group.

For the area without the change, the 3D patch splitting module of FIG. 62 may generate identical 3D patches for the object in all mesh frames and specify the same projection plane. For the area with the change, the module may generate different 3D patches for each object and specify different projection planes.

FIG. 63 may show the result of 3D patch packing. For N mesh frames in a mesh frame group, the area where there is no change in geometry information between mesh frames are split into 3D patches a, b, c, and d, and the area where there is a change in geometry information between mesh frames may be optimally split for each mesh frame. For example, in object 1 (obj1_t−α) of the t-th mesh frame, the area where there is a change may be split into 3D patches e, f, and g.

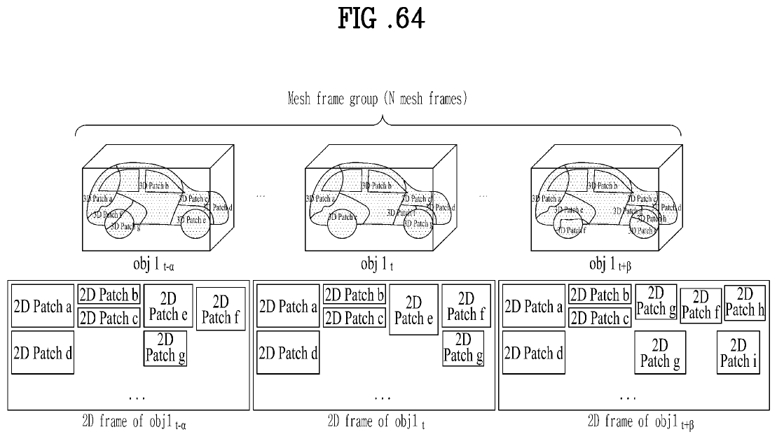

FIG. 64 illustrates an example of the result of 2D frame packing of object 1 in a mesh frame according to embodiments.

The patch packer of FIG. 57, the 3D patch generator may specify a position where packing is to be performed in the 2D frame for each 3D patch generated by the 3D patch generator. For 3D patches in the area where there is no change among the 3D patches generated by the 3D patch generator, packing may be performed at the same position in the 2D frame. For 3D patches in the area where there is a change, packing may be performed at the best position for each object in each mesh frame. FIG. 64 illustrates the result of 2D frame packing of 3D patches.

Referring to FIG. 64, object 1 in each mesh frame included in the mesh frame group is represented as obj1_t−α, obj1_t+α, and obj1_t+α. In object 1, 3D patches a, b, c, and d correspond to the area where there is no change between mesh frames, and 3D patches e, f, and g correspond to the area where there is a change between mesh frames. Therefore, in packing into the 2D frame, 3D patches a, b, c, and d are packed at constant positions in the 2D frames, while 3D patches e, f, and g are optimally packed at different positions in the respective frames.

Signaling information related to the 3D patch generator and the patch packer of FIG. 57: Information related to 3D patch splitting and 2D frame packing may be transmitted as atlas information on a patch-by-patch basis.

The atlas information according to the embodiments may include information such as coordinates of bounding box vertices of each 3D patch into which the mesh is split and coordinates/width/height of the top left corner of the bounding box of the 2D patch into which the 3D patch is projected as an image. (For example, the atlas information may be the same information, may include the same information, and/or may serve the same purpose as the auxiliary patch information according to the embodiments.)

In the 3D patch generator of FIG. 57, when there is no area where there is a change, the atlas information may be transmitted only for the first encoded mesh frame in the mesh frame group. For the remaining mesh frames, the atlas information about the first mesh frame may be referenced without transmitting atlas information. obj_atlas_skip_flag in the Object_header may be sent with a value of TRUE.

In the 3D patch generation, where there is an area where there is a change, patches contained in the area where there is no change may be used by referencing the atlas of the corresponding patch in the first mesh frame. For the patches contained in the area where there is a change, atlas information may be transmitted on a per patch basis. Whether the atlas information is transmitted may be transmitted on a per tile or patch basis.

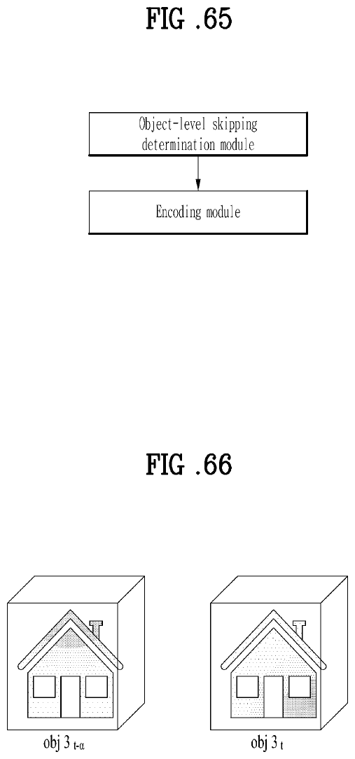

FIG. 65 illustrates elements or operations of the vertex occupancy map encoder, vertex color image encoder, or vertex geometry image encoder of FIG. 57.

FIG. 66 illustrates an exemplary object according to embodiments.

The vertex occupancy map generator, the vertex color image generator, and the vertex geometry image generator of FIG. 57 may generate a vertex occupancy map, a color image, and a geometry image by packing an object into a 2D frame, respectively. The 3D patches generated by the 3D patch generator of FIG. 57 may be packed at the 2D frame positions specified by the patch packer. In the vertex occupancy map, the pixel onto which a vertex is projected may have a value depending on the packing. In the color image, the pixels onto which a vertex is projected may have a color value for the vertex. In the geometry image, the pixel onto which a vertex is projected may have a value for the distance of the vertex from the projection plane.

The vertex occupancy map encoder, the vertex color image encoder, and the vertex geometry encoder of FIG. 57 may encode the vertex occupancy map, the color image, and the geometry image of one or more objects generated in the current mesh frame, respectively. The vertex occupancy maps, color images, and geometry images generated for the respective objects may be encoded in ascending order of the objects in the current mesh frame. The operations may be as shown in FIG. 65.

Referring to FIG. 65, an object-level skipping determination module may determine whether to reference an image of the same object in a previously encoded mesh frame (obj_geometry_image_skip_flag, obj_occupancy_skip_flag, obj_color_image_skip_flag) without encoding the geometry, color image, or vertex occupancy map of the object currently to be encoded. When the previously encoded image is referenced, the index of the reference mesh frame (ref_frame_idx) may be transmitted.

Signaling: The transmission device/method according to the embodiments may transmit obj_geometry_image_skip_flag, obj_occupancy_skip_flag, and obj_color_image_skip_flag in Object_header.

Referring to FIG. 65, an encoding module may encode the geometry image of the object currently to be encoded when obj_geometry_image_skip_flag is FALSE. It may encode the vertex occupancy map when obj_occupancy_skip_flag is FALSE. The module may encode the color image when obj_color_image_skip_flag is FALSE. The encoding module may sequentially encode the objects in the current mesh frame and sequentially perform inter-prediction/intra-prediction, transformation, entropy encoding, and the like. When performing inter-frame prediction, it may reference the 2D image of the same object in the previously encoded mesh frame stored in a 2D image buffer. When the reconstructed object is stored in the 2D image buffer, the object index, the mesh frame index containing the object, and the like may be stored together in the form of metadata.

FIG. 66 may show an example of an object when obj_occupancy_skip_flag=1, obj_geometry_image_skip_flag=1, and obj_color_image_skip_flag=0. In this case, object 3 in the current mesh frame and object 3 in the previously encoded mesh frame may have the same geometry information, and different color information.

The auxiliary information encoder of FIG. 57 may encode a projection plane index determined per patch, and/or a 2D bounding box position (u0,v0,u1,v1) of the patch, and/or a 3D reconstruction position (x0,y0,z0) based on the bounding box of the patch, and/or a patch index map in M×N units in the W×H image space.

The connectivity collector of FIG. 57 may collect connectivity information based on the reconstructed vertex geometry information.

The connectivity patch constructor of FIG. 57 may split the connectivity information into one or more connectivity patches based on point split information generated when the 3D patch generator split the input point into one or more 3D vertex patches.

The connectivity encoder of FIG. 57 may encode the connectivity information on a patch-by-patch basis.

The vertex index mapping information generator of FIG. 57 may generate information that maps a vertex index of the connectivity information to a corresponding reconstructed vertex index.

FIG. 67 illustrates a reception device/method according to embodiments.

Referring to FIG. 67, the reception device according to the embodiments may include a vertex occupancy map decoder, an auxiliary information decoder, a geometry image decoder, a color image decoder, a connectivity decoder, a vertex geometry information/color information reconstructor, a vertex index mapper, a vertex sorter, an object geometry information inverse transformer, and/or a mesh frame constructor.

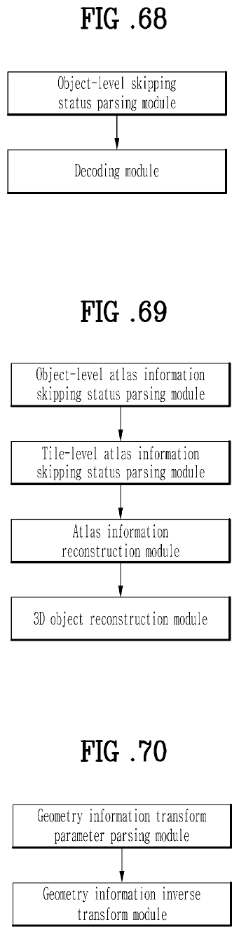

FIG. 68 illustrates elements or operations of the vertex occupancy map decoder, vertex color image decoder, or vertex geometry image decoder of FIG. 67.

Referring to FIG. 67, the reception device/method according to the embodiments may reconstruct vertex geometry information and vertex color information from respective bitstreams. Based on the reconstructed geometry information and color information, vertex occupancy map, and received atlas information, 3D objects may be reconstructed, and the one or more reconstructed objects included in the current frame may configured in a single reconstructed mesh frame. The principles of execution of the operations are described in more detail below.

The vertex occupancy map decoder, the geometry image decoder, and the color image decoder according to the embodiments may decode a vertex occupancy map, a geometry image, and a color image, respectively. The operations may be performed as illustrated in FIG. 68.

In FIG. 68, the object-level skipping status parsing module may parse whether to perform general decoding of the vertex occupancy map, geometry image, and color image (obj_geometry_image_skip_flag, obj_color_image_skip_flag, obj_occupancy_skip_flag) in the Object_header of the current object in the current mesh frame to be decoded. When the flags are TRUE, reference decoding may be performed in a subsequent operation. When the flags are FALSE, general decoding may be performed.

The decoding module of FIG. 68 may reconstruct the vertex occupancy map, the geometry image, or the color image through the reference decoding or general decoding.

When Obj_geometry_image_skip_flag indicates TRUE, the reference decoding may be performed based on the geometry image of the corresponding object in the reference frame to reconstruct the geometry image of the current object. By parsing the reference frame index (ref_frame_idx), the geometry of the corresponding object in the frame with that index may be used as the reconstructed geometry image of the current object. When obj_geometry_image_skip_flag indicates FALSE, the geometry image may be reconstructed by performing the general decoding including prediction, inverse transformation, dequantization, and entropy decoding.

When obj_color_image_skip_flag indicates TRUE, the reference decoding may be performed based on the color image of the corresponding object in the reference frame to reconstruct the color image of the current object. By parsing the reference frame index (ref_frame_idx), the color image of the corresponding object in the frame with that index may be used as the reconstructed color image of the current object. When Obj_color_image_skip_flag indicates FALSE, the color image may be reconstructed by performing the general decoding including prediction, inverse transformation, dequantization, and entropy decoding.

When obj_occupancy_skip_flag indicates TRUE, the reference decoding may be performed based on the vertex occupancy map of the corresponding object in the reference frame to reconstruct the vertex occupancy map of the current object. By parsing the reference frame index (ref_frame_idx), the vertex occupancy map of the corresponding object in the frame with the index may be used as the reconstructed vertex occupancy map of the current object. When obj_occupancy_skip_flag indicates FALSE, the vertex occupancy map may be reconstructed by performing the general decoding including prediction, inverse transformation, dequantization, and entropy decoding.

FIG. 69 illustrates elements or operations of the vertex geometry information/color information reconstructor of FIG. 67.

The vertex geometry/color information reconstructor according to the embodiments may include an object-level atlas information skipping status parsing module, a tile-level atlas information skipping status parsing module, an atlas information reconstruction module, and/or a 3D object reconstruction module. The modules may operate in the order shown in FIG. 69. The order may change and some modules or operations may be omitted.

The vertex geometry/color information reconstructor of FIG. 67 may reconstruct a 3D object based on the reconstructed geometry image, color image, and vertex occupancy map of the current object. In addition, the 3D object may be reconstructed based on the received atlas information.

The object-level atlas information skipping status parsing module of FIG. 69 may parse whether to perform the general decoding of the atlas information about the current object (obj_atlas_skip_flag) in Object_header. When the flag indicates TRUE, the tile-level atlas information skipping status parsing module of FIG. 69 may be omitted, and the atlas information reconstruction module of FIG. 69 may reconstruct the atlas information about the current object through the reference decoding. When the flag indicates FALSE, the tile-level atlas information skipping status parsing module of FIG. 69 may be operated, and the atlas information reconstruction module may perform the reference decoding or general decoding on a tile-by-tile basis according to the tile-level skipping status. A tile according to an embodiment may be a unit of parallel decoding in decoding the vertex occupancy map, vertex color image, and vertex geometry image. The tiles may be rectangles generated by splitting an image along the width and height directions. There may be multiple 2D patches in a tile, and the region of a 2D patch may be contained in a single tile.

The tile-level atlas information skipping status parsing module of FIG. 69 may parse whether to perform the general decoding of the atlas information about the current object on a tile-by-tile basis (tile_atlas_skip_flag) in atlas_tile_data_unit. When the flag indicates TRUE, the atlas information reconstruction module may reconstruct the atlas information about the current tile through the reference decoding. When the flag indicates FALSE, the atlas information reconstruction module may reconstruct the atlas information about the current tile through the general decoding.

FIG. 70 illustrates elements or operations of the object geometry information inverse transformer of FIG. 67.

The object geometry information inverse transformer according to the embodiments may include a geometry information transform parameter parsing module and/or a geometry information inverse transform module. The modules may be operated in the order of FIG. 70. The order of the operations may be changed or some elements may be omitted.

FIG. 71 illustrates the result of geometry information inverse transformation according to embodiments.

The object geometry information inverse transformer of FIG. 67 may perform an inverse transformation on the reconstructed geometry information about an object. The operation may be performed as shown in FIG. 70.

The geometry information transform parameter parsing module of FIG. 70 may parse a geometry information transform parameter when geometry transformation is performed on the current object. The information transform status (obj_geometric_transform_flag) may be parsed in Object_header. When the flag indicates TRUE, the transform parameter (obj_geometric_transform_parameter) may be parsed. The transform parameter syntax may be in the form of a vector. Alternatively, it may be in the form of an index, and the parameter vector may be derived by referencing a table based on the index.

The geometry information inverse transform module of FIG. 70 may perform an inverse transformation on the reconstructed geometry information about the object based on the parsed geometry transform parameter. The result of the inverse transformation may be shown in FIG. 71.

FIG. 72 illustrates elements or operations of the object mesh frame constructor of FIG. 67.

The mesh frame constructor according to the embodiments may include an object position parser and/or an object geometry translation transformer. The mesh frame constructor may operate in the order of FIG. 70. The order of operations may be changed or some elements may be omitted.

FIG. 73 illustrates execution of the mesh frame constructor for a POC t mesh frame according to embodiments.

The mesh frame constructor of FIG. 67 may configure one or more reconstructed objects included in the current frame into a single reconstructed mesh frame. The operation may be performed as shown in FIG. 72.

For the reconstructed one or more objects included in the current frame, the in-mesh frame object position parser of FIG. 72 may parse the position of each object in the reconstructed mesh frame. The position may be in the form of an offset along each of the X, Y, and Z axes per object. The object index (idx_object) may be parsed in Object_header of the current object, and the X, Y, and Z axis offsets (X_global_offset, Y_global_offset, Z_global_offset) of objects with the same index may be parsed from the frame-by-frame object information (Frame_object).

The object geometry translation transformer of FIG. 72 may add X_global_offset, Y_global_offset, and Z_global_offset to the X, Y, and Z axis values of all vertices in the currently reconstructed object, respectively.

The result of execution of the mesh frame constructor for the POC t mesh frame may be shown in FIG. 73.

Referring to FIG. 73, for the objects assigned indexes of 1 to 7, the mesh frame constructor may parse the position information about each object and construct a mesh frame by arranging each object according to the position information. Thus, the objects in FIG. 73 may be arranged according to the position information after the mesh frame is constructed to form one mesh frame.

The auxiliary information decoder of FIG. 67 may decode a projection plane index determined per patch, and/or a 2D bounding box position (u0,v0,u1,v1) of the patch, and/or a 3D reconstruction position (x0,y0,z0) based on the bounding box of the patch, and/or a patch index map in M×N units in the W×H image space.

The connectivity decoder of FIG. 67 may receive a patch-by-patch connectivity information bitstream as input and decode the connectivity information on a patch-by-patch basis, or may receive a frame-by-frame connectivity information bitstream as input and decode the connectivity information on a frame-by-frame basis.

The vertex index mapper of FIG. 67 may map the vertex index of the reconstructed connectivity information to an index of the corresponding vertex data.

The vertex sorter of FIG. 67 may change the order of the reconstructed vertex data by referencing the vertex indexes of the reconstructed connectivity information.

The vertex geometry information/color information reconstructor of FIG. 67 may reconstruct 3D vertex-level geometry information and color information based on the reconstructed auxiliary information, the reconstructed vertex geometry image, and the reconstructed vertex color image.

The transmission device/method according to the embodiments may transmit the following parameters to deliver object information on a frame-by-frame basis.

FIG. 74 shows the syntax of Frame_object( ) according to embodiments.

Frame_object( ) according to the embodiments may be included in the bitstream of FIG. 50.

The transmission device/method according to the embodiments may transmit Frame_object( ) for delivering object information on a frame-by-frame basis and the syntax of Object_header( ) related to information about the current object. Additionally, tile_atlas_skip_flag may be added to the syntax for tile-by-tile atlas transmission (atlas_tile_data_unit) to transmit information about whether to skip the tile-by-tile atlas transmission.
num_object indicates the number of objects in the current frame.
idx_object indicates the index of the object.
X_global_offset indicates the X-axis coordinate of the bounding box vertex of the object in the frame.
Y_global_offset indicates the Y-axis coordinate of the bounding box vertex of the object in the frame.
Z_global_offset indicates the Z-axis coordinate of the bounding box vertex of the object in the frame.

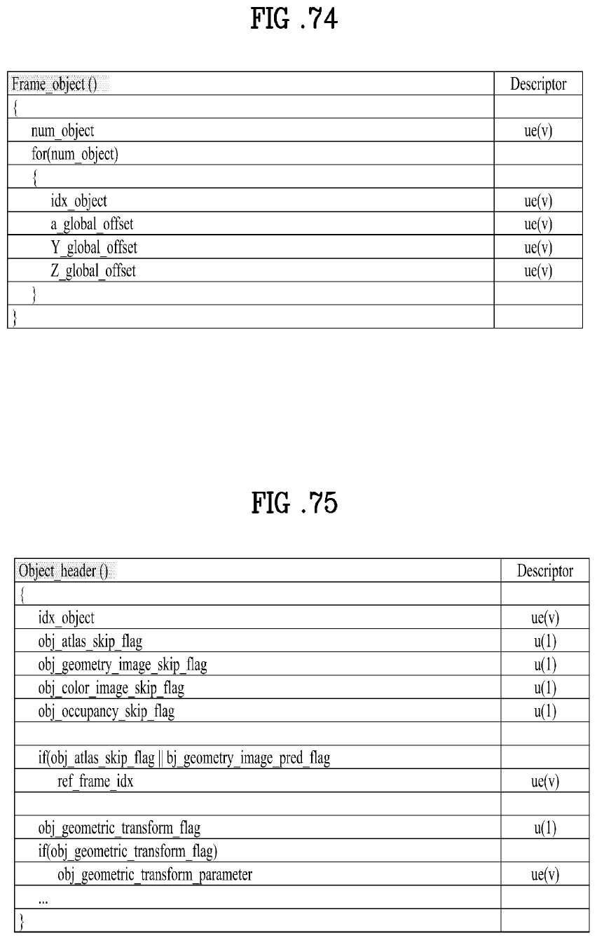

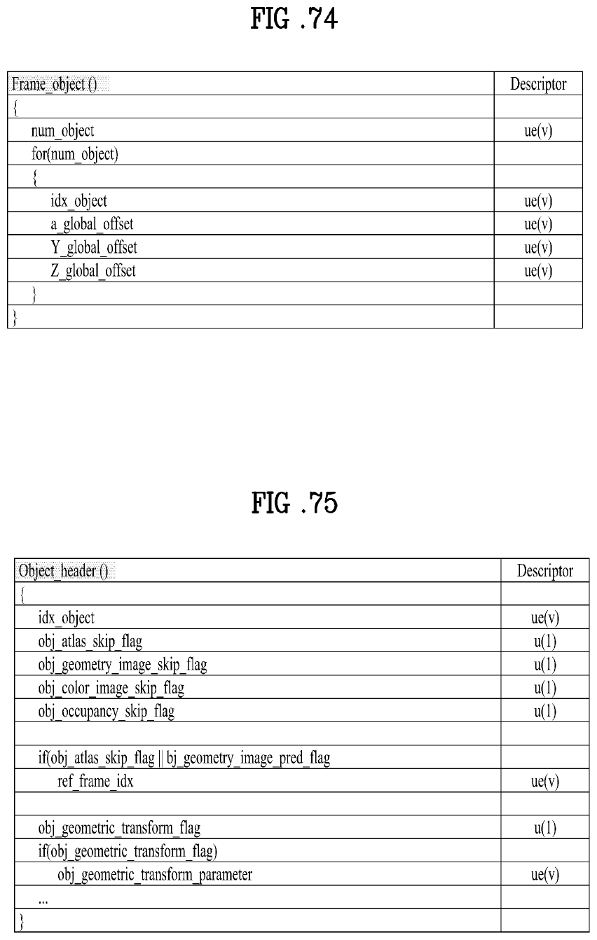

FIG. 75 shows the syntax of Object_header( ) according to embodiments.
Object_header( ) according to the embodiments may be included in the bitstream of FIG. 50.
idx_object indicates the index of the current object.
obj_atlas_skip_flag may indicate whether to skip atlas information for the current object.
obj_geometry_image_skip_flag may indicate whether to skip a geometry image for the current object.
obj_color_image_skip_flag may indicate whether to skip a color image for the current object.
obj_occupancy_skip_flag may indicate whether to skip a geometry occupancy map for the current object.
ref_frame_idx may indicate the index of a reference frame that may be referenced to generate the information that is skipped and not transmitted.
obj_geometric_transform_flag may indicate whether to perform global geometry transformation on the current object.
obj_geometric_transform parameter may indicate a global geometry transform parameter (vector or index) of the current object.

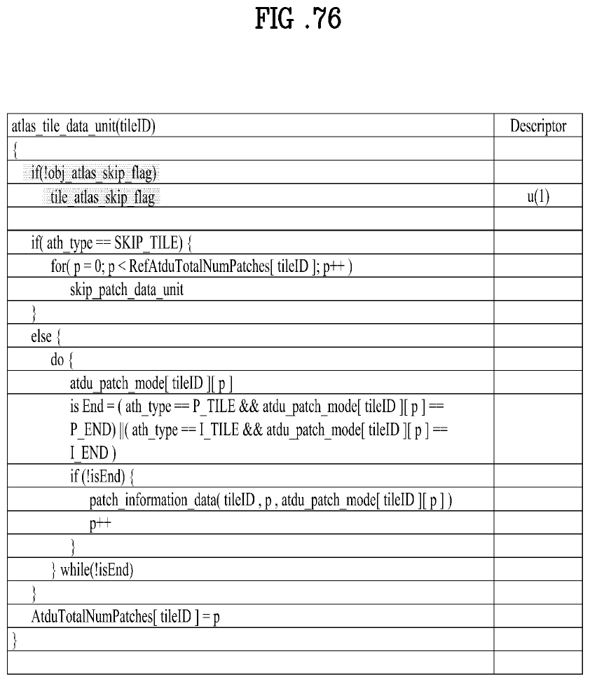

FIG. 76 shows the syntax of Atlas_tile_data_unit according to embodiments.
Atlas_tile_data_unit according to the embodiments may be included in the bitstream of FIG. 50.
tile_atlas_skip_flag may indicate whether to skip the atlas transmission on a tile-by-tile basis.

FIG. 77 illustrates a transmission device/method according to embodiments.

The operations at the transmitting side for an inter-frame prediction method and data transmission in an object-level coding structure using V-Mesh compression technique may be performed as illustrated in FIG. 77.

The transmission device/method according to the embodiments receives input per mesh frame group and split a mesh frame in the mesh frame group into objects. The mesh frame object splitting module of the mesh frame splitter may perform object splitting on a frame-by-frame basis or may perform the object splitting with reference to another frame in the frame group. The same object in each frame may be assigned the same index. Object information to be transmitted may be transmitted on a frame-by-frame basis by the Frame_object syntax. Frame_object may include the number of objects in the frame (num_object), an index of each object (idx_object), and position information about each object in the frame (X_global_offset, Y_global_offset, Z_global_offset).

In embodiments, the object geometry information transformer may perform geometry transformation on one or more objects having the same index in the mesh frame group based on a common axis. A new axis for each object may be derived, a transform parameter for transforming the new axis may be derived, and information about whether to perform the transformation (obj_geometric_transform_flag) and the derived parameter (obj_geometric_transform_parameter) may be transmitted in Object_header( ).

Thereafter, the mesh data of one or more objects with the same index in a mesh frame group is received as input, and the geometry information about the input objects is compared on a mesh frame group basis to divide an area with a large change in geometry information and an area with a small change in geometry information. Considering the optimal plane onto which the vertices in each area are to be projected, vertices to be projected onto the same plane may be grouped and split into basic units called 3D patches.

The patch packer specifies a packing position in a 2D frame for each 3D patch generated by the 3D patch generator. For efficient video compression, the 3D patch generator may pack, at the same positions in the 2D frame, 3D patches in the area without change. For the 3D patches in the area with a change, it may perform packing at the optimal position for each object in each mesh frame.

When there is no area with a change, the 3D patch generator will transmit atlas information only for the first encoded mesh frame in the mesh frame group. For the remaining mesh frames, the atlas information about the first mesh frame may be referenced without transmission any atlas information. In this case, obj_atlas_skip_flag in the Object_header may be sent with a value of TRUE.

When there is an area with a change, the 3D patch generator reference the atlas of the corresponding patches in the first mesh frame for the 3D patches in the area without any change as described above. For the patches contained in the area where there is a change, atlas information may be transmitted on a per patch basis.

The vertex occupancy map generator, the vertex color image generator, and the vertex geometry image generator according to the embodiments may generate a vertex occupancy map, a color image, and a geometry image by packing an object into a 2D frame, respectively.

The vertex occupancy map encoder, the vertex color image encoder, and the vertex geometry encoder according to the embodiments may encode the vertex occupancy map, the color image, and the geometry image of one or more objects generated in the current mesh frame, respectively. Each encoder may determine whether to reference an image of the same object in a previously encoded mesh frame (obj_geometry_image_skip_flag, obj_occupancy_skip_flag, obj_color_image_skip_flag) with a value of TRUE or FALSE without encoding the geometry, color image, or vertex occupancy map of the object currently to be encoded. When the previously encoded image is referenced, the index of the reference mesh frame (ref_frame_idx) may be transmitted. Depending on whether to reference a previously encoded mesh frame image (TRUE, FALSE of skip flag) for each object, encoding is performed through the video codec.

The connectivity information may be encoded by a separate encoder and may be transmitted to the multiplexer along with the compression results of the existing vertex occupancy map image, vertex geometry image, and vertex color image so as to be transmitted as a single bitstream through the transmitter.

FIG. 78 illustrates a reception device/method according to embodiments.

After file/segment decapsulation, the received mesh bitstream is demultiplexed into a compressed vertex occupancy map bitstream, an auxiliary information bitstream, a geometry information bitstream, a color information bitstream, and a connectivity information bitstream, and then a decoding operation is performed thereon. The vertex occupancy map, geometry image, and color image decoders may parse obj_occupancy_skip_flag, obj_geometry_image_skip_flag, and obj_color_image_skip_flag in Object_header of the current mesh frame to be decoded to determine whether to perform general decoding. When the flag indicates TRUE, reference decoding may be performed. When the flag indicates FALSE, general decoding may be performed.

The reference decoding may be performed based on the geometry image, color image, vertex occupancy map of the corresponding object in the reference frame to reconstruct the geometry image, color image, and vertex occupancy map of the current object. Then, by parsing the reference frame index (ref_frame_idx), the geometry image, color image, and vertex occupancy map of the object with the index in the reference frame may be used as the reconstructed geometry image, color image, and vertex occupancy map of the current object.

In the general decoding, prediction, inverse transformation, dequantization, entropy decoding, and the like may be performed to reconstruct the geometry image, color image, vertex occupancy map.

The vertex geometry/vertex color information reconstructor may reconstruct a 3D object based on the reconstructed geometry image, color image, and vertex occupancy map. The 3D object may be reconstructed by back-projecting occupied pixels in the geometry and color images into 3D space based on the atlas information and vertex occupancy map.

In the reconstruction operation, whether to perform the general decoding of the atlas information about the current object (obj_atlas_skip_flag) may be parsed in Object_header. When the flag indicates TRUE, the tile-level atlas information skipping status parsing module may be omitted, and the atlas information reconstruction module may reconstruct the atlas information about the current object through the reference decoding. When the flag indicates FALSE, the tile-level atlas information skipping status parsing module may be operated, and the atlas information reconstruction module may perform the reference decoding or general decoding on a tile-by-tile basis according to the tile-level skipping status.

The tile-level atlas information skipping status parsing module may parse whether to perform the general decoding of the atlas information about the current object on a tile-by-tile basis (tile_atlas_skip_flag) in atlas_tile_data_unit. When the flag indicates TRUE, the atlas information reconstruction module may reconstruct the atlas information about the current tile through the reference decoding. When the flag indicates FALSE, the atlas information reconstruction module may reconstruct the atlas information about the current tile through the general decoding. When the atlas information reconstruction module performs the reference decoding, ref_frame_idx may be parsed and the atlas information about the corresponding tile may be used as the reconstructed atlas information about the current tile. In the case where the general decoding is performed, all information contained in the atlas information may be parsed.

The order of the vertex data in the reconstructed geometry and color information may be changed by referencing the vertex indexes in the reconstructed connectivity information. After the vertex sorting is performed, the object geometry information inverse transformer may perform an inverse transformation on the geometry information about the reconstructed object. When geometry transformation is performed on the current object, the geometry transform parameter parsing module of the geometry information inverse transformer may parse the geometry transform parameter. The information transform status (obj_geometric_transform_flag) may be parsed in Object_header. When the flag indicates TRUE, the transform parameter (obj_geometric_transform_parameter) may be parsed. The transform parameter may be in the form of a vector. Alternatively, it may be in the form of an index, and the parameter vector may be derived by referencing a table according to the index. The inverse transformation may be performed on the geometry information about the reconstructed object based on the parsed geometry transform parameter.

The mesh frame constructor according to the embodiments may configure one or more reconstructed objects contained in the current frame in the reconstructed mesh frame by parting idx_object in Object_header. Additionally, the X, Y, and Z axis offsets (X_global_offset, Y_global_offset, Z_global_offset) of objects with the same index may be parsed from the frame-by-frame object information, and summed for all vertices in the reconstructed object to derive the position of each object in the mesh frame. The final mesh data may be reconstructed by constructing each object in the mesh frame through the process as described above.

In the conventional mesh compression structure, only a mesh frame consisting of a single object is considered as an input to the encoder, and the encoding is performed by packing the input mesh frame into a single 2D frame. Even when a mesh frame containing multiple objects and covering a large space is input to the encoder, it is still packed into a single 2D frame and encoding is performed. With the conventional mesh compression structure as described above, it is difficult to adjust quality or perform transmission on a per local region or object basis. In order to overcome the limitations of the conventional structure, the present disclosure proposes a structure in which encoding/decoding is performed by constructing 2D frames on an object-by-object basis, and proposes a referencing technique that may predict mesh components such as atlas information, geometry information, and color information from the reconstructed frame on an object-by-object or patch-by-patch basis to improve encoding efficiency. With the method proposed in the present disclosure, content containing various types of objects in one frame may be encoded independently on an object-by-object basis to provide a function to perform parallel processing, subjective image quality control, selective transmission, and the like on an object-by-object basis may be provided. Furthermore, the mesh video may be further effectively compressed for objects that have large inter-frame duplication in the mesh video.

FIG. 79 illustrates a transmission device/method according to embodiments.

The transmission device/method according to the embodiments may correspond to the encoder or transmission device/method of FIG. 1, FIG. 4, FIG. 15, FIG. 18, FIG. 20, FIG. 21, FIG. 23, FIG. 55, FIG. 57, FIG. 77, and/or FIG. 79, or may correspond to a combination of some components thereof. The transmission device/method according to the embodiments may include a memory, a processor configured to execute instructions stored in the memory.

Referring to FIG. 79, the transmission device/method according to the embodiments includes encoding point cloud data (S7900) and transmitting a bitstream containing the point cloud data (S7901).

Here, operation S7900 of encoding the point cloud data includes splitting a mesh frame based on an object. FIGS. 57 to 59 illustrate splitting a mesh frame by the transmission device/method according to the embodiments based on the object.

The transmission device/method according to the embodiments may assign an index to the object when splitting the mesh frame based on the object. In this case, identical objects in the frames belonging to a mesh frame group may be assigned the same index. For example, referring to FIG. 59, a car object is assigned an index of 1 for multiple mesh frames.

The operation of encoding the point cloud data may further include transforming geometry information about the object. The operation of transforming the geometry information about the object will be described with reference to FIGS. 60 and 61. The geometry information transform parameter deriving module of FIG. 60 may derive a parameter for transforming the geometry information, and the geometry information transformation module may transform the geometry information about the object based on the derived parameter.

The operation of encoding the point cloud data may further include generating 3D patches based on the object and packing the 3D patches. The 3D patch generator in FIG. 57 generates the 3D patches, and the patch packer in FIG. 57 packs the 3D patches. Generating and packing the 3D patches according to the embodiments will be described with reference to FIGS. 62 to 64.

The operation of encoding the point cloud data according to the embodiments includes simplifying mesh data. The operation of encoding the point cloud data further includes reconstructing the mesh data simplified in the simplifying operation. The operation of simplifying the mesh data may be performed by the mesh simplifier of FIG. 23. The operation of reconstructing the mesh data may be performed by the mesh reconstructor of FIG. 23. The mesh reconstructor of FIG. 23 may reconstruct low-resolution simplified mesh data.

The operation of encoding the point cloud data may further include generating mesh split information for the simplified mesh data reconstructed in the operation of reconstructing the mesh data. The operation of generating the mesh split information may be performed by the mesh split information deriver of FIG. 23. The mesh split information deriver of FIG. 23 may split the simplified mesh data to derive information about the splitting method that causes the smallest difference from the original mesh. The mesh split information according to the embodiments may derive information such as whether to split the mesh (split_mesh_flag), the submesh type (submesh_type_idx), and the submesh split type (submesh_split_type_idx). Furthermore, information related to the mesh splitting method, such as the number of vertices added when splitting the submesh (split_num) and the split depth (split_depth), may be derived.

A transmission device according to embodiments includes an encoder configured to encode point cloud data and a transmitter configured to transmit a bitstream containing the point cloud data. It may further include the components disclosed in the figures described above.

The components of the encoder or transmission device of FIG. 1, FIG. 4, FIG. 15, FIG. 18, FIG. 20, FIG. 21, FIG. 23, FIG. 55, FIG. 57, FIG. 77, and/or FIG. 79 may be a unit, module, or assembly for performing a corresponding function. Alternatively, they may include a memory configured to store instructions for performing the corresponding function and a processor configured to execute the instructions. Each component may be a combination of software and/or hardware.

FIG. 80 illustrates a reception device/method according to embodiments.

The reception device/method according to the embodiments may correspond to the decoder or reception device/method of FIG. 1, FIG. 16, FIG. 17, FIG. 19, FIG. 20, FIG. 22, FIG. 26, FIG. 56, FIG. 67, FIG. 78, and/or FIG. 80, or may correspond to a combination of some components thereof. The reception device/method according to the embodiments may include a memory, a processor configured to execute instructions stored in the memory.

The reception device/method according to the embodiments may correspond to the reverse process to the operations of the transmission device/method.

Referring to FIG. 80, the reception device/method according to the embodiments includes operation S8000 of receiving a bitstream containing point cloud data and operation S8001 of decoding the point cloud data.

Here, operation S8001 of decoding the point cloud data includes reconstructing a 3D object and constructing a mesh frame based on the object. Methods of reconstructing the object and constructing the mesh frame according to the embodiments will be described with reference to FIGS. 67 and 73. The vertex occupancy map/color information reconstructor of FIG. 67 may reconstruct a 3D object based on the reconstructed geometry image, color image, and vertex occupancy map of the 3D object. Further, the mesh frame constructor of FIG. 67 may construct a mesh frame based on the reconstructed object. Details related to the construction of the mesh frame according to the embodiments will be described with reference to FIG. 72. The mesh frame constructor may include an object position parser and an object geometry translation transformer. The object position parser may parse X, Y, and Z axis offset information about the object, and the object geometry translation transformer may sum the parsed offset information to the X, Y, and Z axis values of all vertices in the reconstructed object. Thus, the reconstructed object may be arranged at an appropriate position within the mesh frame.

The operation of decoding the point cloud data further includes inversely transforming the geometry information about the object. The operation of inversely transforming the geometry information of the object is performed by the object geometry information inverse transformer of FIG. 67. Specifically, the geometry information transform parameter parsing module of FIG. 70 may parse a transform parameter, and the geometry information inverse transformer of FIG. 70 may inversely transform the geometry information based on the parsed transform parameter.

In operation S8000 of receiving a bitstream containing point cloud data according to the embodiments, the bitstream contains transform parameter information about the object and offset information about the X-axis, Y-axis, and Z-axis for the object. The transform parameter information about the object may be parsed and used for inverse transform of the geometry information about the object, and the offset information about the object may be used to construct a mesh frame.

Further, the operation of decoding the point cloud data includes reconstructing simplified mesh data and decoding mesh split information. The mesh reconstructor of FIG. 23 reconstructs the mesh data, and the mesh split information decoder of FIG. 23 decodes the mesh split information.

The operation of decoding the point cloud data further includes splitting the reconstructed mesh data based on the mesh split information. The mesh splitter of FIG. 23 splits the low-resolution mesh data reconstructed by the mesh reconstructor based on the decoded mesh split information.

The bitstream according to the embodiments may contain information about whether to split the mesh and a splitting method. The information about whether to split the mesh and a splitting method may be utilized by the mesh splitter of FIG. 23.

A reception device according to the embodiments includes a receiver configured to receive a bitstream containing point cloud data and a decoder configured to decode the point cloud data. It may further include any of the components disclosed in the figures described above.

The reception device/method according to the embodiments may correspond to the decoder or reception device/method of FIG. 1, FIG. 16, FIG. 17, FIG. 19, FIG. 20, FIG. 22, FIG. 26, FIG. 56, FIG. 67, FIG. 78, and/or FIG. 80, or may correspond to a combination of some components thereof. The reception device/method according to the embodiments may include a memory, a processor configured to execute instructions stored in the memory.

The components of the decoder or reception device of FIG. 1, FIG. 16, FIG. 17, FIG. 19, FIG. 20, FIG. 22, FIG. 26, FIG. 56, FIG. 67, FIG. 78, and/or FIG. 80 may be a unit, module, or assembly for performing a corresponding function. Alternatively, they may include a memory configured to store instructions for performing the corresponding function and a processor configured to execute the instructions. Each component may be a combination of software and/or hardware.

According to the embodiments, the transmission/reception device/method may transmit or receive mesh data scalably. In other words, the transmission/reception device/method according to the embodiments may transmit and receive the mesh data with image quality adapted to user requirements, taking into account the performance of the reception device or network conditions. In other words, low-resolution mesh data may be transmitted and received to improve communication efficiency in situations where high-resolution image quality is not required, and high-resolution image quality may be restored for parts for which high resolution is required.

Further, the transmission/reception device/method according to the embodiments may apply various mesh splitting methods to the mesh data. Thus, the method that most closely reconstructs the original mesh data may be used to minimize lost data.

Furthermore, the transmission/reception device/method according to the embodiments may increase data processing efficiency by separately processing objects in mesh frames belonging to a mesh frame group. By assigning the same index to the same object within the group and distinguishing between an area of the object that undergoes changes from frame to frame and an area of the object that does not undergo changes, the objects may be packed efficiently in 2D packing. In addition, as frames are constructed on an object-by-object basis and prediction is performed by referencing atlas information, geometry information, attribute information, and the like on a per object or patch basis, prediction accuracy may be improved. For multiple objects contained in a single frame, encoding may be performed independently on an object-by-object basis, parallel processing, image quality control, selective transmission, and the like may be enabled. Also, objects with large duplication may be effectively compressed.

The embodiments have been described in terms of a method and/or a device. The description of the method and the description of the device may complement each other.

Although embodiments have been described with reference to each of the accompanying drawings for simplicity, it is possible to design new embodiments by merging the embodiments illustrated in the accompanying drawings. If a recording medium readable by a computer, in which programs for executing the embodiments mentioned in the foregoing description are recorded, is designed by those skilled in the art, it may also fall within the scope of the appended claims and their equivalents. The devices and methods may not be limited by the configurations and methods of the embodiments described above. The embodiments described above may be configured by being selectively combined with one another entirely or in part to enable various modifications. Although preferred embodiments have been described with reference to the drawings, those skilled in the art will appreciate that various modifications and variations may be made in the embodiments without departing from the spirit or scope of the disclosure described in the appended claims. Such modifications are not to be understood individually from the technical idea or perspective of the embodiments.

Various elements of the devices of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the device according to the embodiments may include one or more processors capable of executing one or more programs. The one or more programs may perform any one or more of the operations/methods according to the embodiments or include instructions for performing the same. Executable instructions for performing the method/operations of the device according to the embodiments may be stored in a non-transitory CRM or other computer program products configured to be executed by one or more processors, or may be stored in a transitory CRM or other computer program products configured to be executed by one or more processors. In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion.

In this document, the term “/” and “,” should be interpreted as indicating “and/or.” For instance, the expression “A/B” may mean “A and/or B.” Further, “A, B” may mean “A and/or B.” Further, “A/B/C” may mean “at least one of A, B, and/or C.” “A, B, C” may also mean “at least one of A, B, and/or C.” Further, in the document, the term “or” should be interpreted as “and/or.” For instance, the expression “A or B” may mean 1) only A, 2) only B, and/or 3) both A and B. In other words, the term “or” in this document should be interpreted as “additionally or alternatively.”

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signal unless context clearly dictates otherwise.

The terminology used to describe the embodiments is used for the purpose of describing particular embodiments only and is not intended to be limiting of the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components. As used herein, conditional expressions such as “if” and “when” are not limited to an optional case and are intended to be interpreted, when a specific condition is satisfied, to perform the related operation or interpret the related definition according to the specific condition.

Operations according to the embodiments described in this specification may be performed by a transmission/reception device including a memory and/or a processor according to embodiments. The memory may store programs for processing/controlling the operations according to the embodiments, and the processor may control various operations described in this specification. The processor may be referred to as a controller or the like. In embodiments, operations may be performed by firmware, software, and/or a combination thereof. The firmware, software, and/or a combination thereof may be stored in the processor or the memory.

### MODE FOR DISCLOSURE

As described above, related details have been described in the best mode for carrying out the embodiments.

### INDUSTRIAL APPLICABILITY

As described above, the embodiments are fully or partially applicable to a point cloud data transmission/reception device and system.

Those skilled in the art may change or modify the embodiments in various ways within the scope of the embodiments.

Embodiments may include variations/modifications within the scope of the claims and their equivalents.

1. A method of transmitting point cloud data, the method comprising:
encoding point cloud data; and
transmitting a bitstream containing the point cloud data.

2. The method of claim 1, wherein the encoding of the point cloud data comprises:
splitting a mesh frame based on an object.

3. The method of claim 2, wherein the splitting comprises:
assigning an index to the split object.

4. The method of claim 3, wherein the encoding of the point cloud data further comprises:
transforming geometry information about the object.

5. The method of claim 4, wherein the encoding of the point cloud data further comprises:
generating 3D patches based on the object; and
packing the 3D patches.

6. The method of claim 1, wherein the encoding of the point cloud data further comprises:
simplifying mesh data.

7. The method of claim 6, wherein the encoding of the point cloud data further comprises:
reconstructing the mesh data simplified in the simplifying.

8. The method of claim 7, wherein the encoding of the point cloud data further comprises:
generating mesh split information for the mesh data reconstructed in the reconstructing.

9. A device for transmitting point cloud data, comprising:
an encoder configured to encode point cloud data; and
a transmitter configured to transmit a bitstream containing the point cloud data.

10. A method of receiving point cloud data, the method comprising:
receiving a bitstream containing point cloud data; and
decoding the point cloud data.

11. The method of claim 10, wherein the decoding of the point cloud data comprises:
reconstructing a 3D object; and
constructing a mesh frame based on the object.

12. The method of claim 11, wherein the decoding of the point cloud data further comprises:
inversely transforming geometry information about the object.

13. The method of claim 12, wherein the bitstream contains transform parameter information about the object and offset information about an X-axis, a Y-axis, and a Z-axis for the object.

14. The method of claim 10, wherein the decoding of the point cloud data comprises:
reconstructing simplified mesh data; and
decoding mesh split information.

15. The method of claim 14, wherein the decoding of the point cloud data further comprises:
splitting the reconstructed mesh data based on the mesh split information.

16. The method of claim 15, wherein the bitstream contains information about whether to split a mesh and a method of splitting the mesh.

17. A device for receiving point cloud data, comprising:
a receiver configured to receive a bitstream containing point cloud data; and
a decoder configured to decode the point cloud data.
